(19) United States
(12) Patent Application Publication
(10) Pub. No.: US 2016/0094326 A1
(43) Pub. Date: Mar. 31, 2016

(54) METHOD AND APPARATUS FOR TRANSMITTING CHANNEL STATE INFORMATION REFERENCE SIGNAL

(71) Applicant: Electronics and Telecommunications Research Institute, Daejeon (KR)

(72) Inventors: Sung-Hyun MOON, Daejeon (KR); Wooram SHIN, Daejeon (KR); Cheulsoon KIM, Daejeon (KR); Young Jo KO, Daejeon (KR)

(21) Appl. No.: 14/864,298

(22) Filed: Sep. 24, 2015

(30) Foreign Application Priority Data
Sep. 26, 2014 (KR) 10-2014-0129602
Oct. 7, 2014 (KR) 10-2014-0135332
Oct. 21, 2014 (KR) 10-2014-0142891
Nov. 3, 2014 (KR) 10-2014-0151572
Feb. 2, 2015 (KR) 10-2015-0016245
Apr. 29, 2015 (KR) 10-2015-0060866
May 28, 2015 (KR) 10-2015-0075214
Aug. 13, 2015 (KR) 10-2015-0114943

(51) Int. Cl. H04L 5/00; H04W 72/04

(52) U.S. Cl. CPC H04L 5/0053; H04W 72/042; H04L 5/0007

(57) ABSTRACT

A base station includes a plurality of first resource elements (REs) corresponding to at least two of a second orthogonal frequency division multiplexing (OFDM) symbol, a third OFDM symbol, and a fourth OFDM symbol of a first time slot, in a first CSI-RS resource pool configured in a first subframe including the first time slot and a second time slot subsequent to the first time slot. Furthermore, the base station transmits a CSI-RS at least one of REs included in the first CSI-RS resource pool.

### CROSS-REFERENCE TO RELATED APPLICATION

This application claims priority to and the benefit of Korean Patent Application No. 10-2014-0129602, 10-2014-0135332, 10-2014-0142891, 10-2014-0151572, 10-2015-0016245, 10-2015-0060866, 10-2015-0075214, and 10-2015-0114943 filed in the Korean Intellectual Property Office on Sep. 26, 2014, Oct. 7, 2014, Oct. 21, 2014, Nov. 3, 2014, Feb. 2, 2015, Apr. 29, 2015, May 28, 2015, and Aug. 13, 2015, the entire contents of which are incorporated herein by reference.

### BACKGROUND OF THE INVENTION

(a) Field of the Invention

The present invention relates to a method and apparatus for transmitting a channel state information reference signal in a wireless communication system.

(b) Description of the Related Art

A multiple-input multiple-output (MIMO) method in a wireless communication system is a transmission/reception method using a plurality of transmission antennas and a plurality of reception antennas. A plurality of radio channel paths are generated between transmission and reception antennas in a MIMO system. A transmission/reception stage can increase a data transmission capacity or can improve transfer quality by separating or merging the plurality of radio channel paths. A MIMO scheme includes a spatial multiplexing scheme and a spatial diversity scheme. A downlink MIMO scheme introduced in a long term evolution (LTE) system includes a transmit diversity method, a cyclic delay diversity (CDC) method, a beamforming method, and a spatial multiplexing method. Furthermore, a multi-user MIMO (MU-MIMO) scheme for simultaneously transmitting data to a plurality of terminals in the same resources is supported.

An antenna port in the LTE standard is a logical antenna unit implemented by the weighted sum of one or a plurality of physical antenna elements, and is chiefly defined in a transmission stage. An antenna port is also a basic unit in which a reference signal (RS) is transmitted. Accordingly, a terminal estimates a channel with respect to each antenna port rather than a physical antenna element, and performs a channel state information (CSI) measurement and report based on the estimated channel. Different antenna port numbers are assigned to a cell-specific RS (CSR), a user equipment-specific RS (URS), and a CSI-RS, that is, LTE downlink reference signals. An object of the URS is to decode a physical downlink shared channel (PDSCH) by a terminal, and the URS is also called a demodulation RS (DMRS). Antenna port numbers for a CRS may be 0 to 3, antenna port numbers for a URS may be 7 to 14, and antenna port numbers for a CSI-RS may be 15 to 22. Mapping between antenna ports and a physical antenna element(s) is called antenna virtualization. A terminal is basically unable to be aware of which virtualization has been applied to each antenna port.

A CSI-RS is a downlink RS transmitted by a base station so that a terminal may obtain a CSI, and has been introduced in LTE Release 10. In existing Release 8/9 systems, a CRS has been used in order to obtain the CSI of a terminal. In the Release 10 system, simultaneous transmission according to a maximum of 8 downlink layers has been introduced, and thus a new RS for estimating a channel having lower density than an existing CRS has been required to be introduced. A CSI-RS may be set to have an interval of 6 resource elements (RE) or 12 REs in a frequency axis and to have a cycle of 5, 10, 20, 40, or 80 ms in a time axis. CSI-RS configuration information is transmitted through user equipment-specific RRC signaling. The number of CSI-RS antenna ports which may be set for a terminal is 1, 2, 4, or 8. A total number of REs occupied by CSI-RS transmission for the number of CSI-RS antenna ports 1, 2, 4, or 8 within a single physical resource block (PRB) pair is 2, 2, 4, or 8. That is, if the number of CSI-RS antenna ports is 1, a total number of REs occupied by CSI-RS transmission is 2; if the number of CSI-RS antenna ports is 2, a total number of REs occupied by CSI-RS transmission is 2; if the number of CSI-RS antenna ports is 4, a total number of REs occupied by CSI-RS transmission is 4; and if the number of CSI-RS antenna ports is 8, a total number of REs occupied by CSI-RS transmission is 8.

### SUMMARY OF THE INVENTION

The present invention has been made in an effort to provide a method and apparatus for configuring, by a base station, a plurality of RS antenna ports in a terminal in order to estimate a channel in a MIMO wireless communication system and providing an RS for estimating a channel.

Furthermore, the present invention provides a method and apparatus for extending a CSI-RS resource configuration for a terminal if the number of CSI-RS antenna ports is greater than 8 (e.g., 12, 16, 24, 32, or 64).

Furthermore, the present invention provides a method and apparatus for additionally defining a CSI-RS RE set if the number of CSI-RS antenna ports is 1, 2, 4, or 8.

In accordance with an exemplary embodiment of the present invention, a method of transmitting a channel state information reference signal (CSI-RS) by a base station is provided. The method of transmitting the CSI-RS includes including a plurality of first resource elements (REs) corresponding to at least two of a second orthogonal frequency division multiplexing (OFDM) symbol, a third OFDM symbol, and a fourth OFDM symbol of a first time slot in a first CSI-RS resource pool configured in a first subframe including the first time slot and a second time slot subsequent to the first time slot, and transmitting the CSI-RS using at least one of REs included in the first CSI-RS resource pool.

The method of transmitting a CSI-RS may further include: setting information about an OFDM symbol which belongs to the OFDM symbols of the first time slot and at which the transmission of a physical downlink shared channel (PDSCH) is started in a first parameter for a first set to which the first subframe belongs; setting information about an OFDM symbol which belongs to the OFDM symbols of a third time slot of the third time slot and a fourth time slot subsequent to the third time slot included in a second subframe and at which the transmission of a PDSCH is started in a second parameter for a second set to which the second subframe belongs; and transmitting the first parameter and the second parameter to a terminal.

The first subframe may be configured so that the CSI-RS is transmitted through at least one of the first REs.

The method of transmitting the CSI-RS may further include transmitting a bitmap of 19 bits for configuring the first REs as resources for a zero power (ZP) CSI-RS to a terminal.

Including the first REs in the first CSI-RS resource pool may include including 24 first REs corresponding to the third OFDM symbol and fourth OFDM symbol of the first time slot in the first CSI-RS resource pool.

Transmitting the CSI-RS may include mapping CSI-RS antenna ports greater of than 8 to the REs included in the first CSI-RS resource pool.

Mapping the CSI-RS antenna ports may include mapping 16 CSI-RS antenna ports to 16 REs of 24 REs which correspond to the third OFDM symbol and the fourth OFDM symbol of the second time slot and which are included in the first CSI-RS resource pool, and multiplexing the 16 CSI-RS antenna ports using frequency division multiplexing (FDM) and code division multiplexing (CDM).

Mapping the CSI-RS antenna ports may include mapping 16 CSI-RS antenna ports to 16 REs of the 24 first REs and multiplexing the 16 CSI-RS antenna ports using FDM and CDM.

Mapping the CSI-RS antenna ports may include mapping 16 CSI-RS antenna ports to 8 REs which correspond to a sixth OFDM symbol and a seventh OFDM symbol of the first time slot and which are included in the first CSI-RS resource pool and 8 REs which correspond to a sixth OFDM symbol and a seventh OFDM symbol of the second time slot and which are included in the first CSI-RS resource pool and multiplexing the 16 CSI-RS antenna ports using time division multiplexing (TDM) and CDM.

Mapping the CSI-RS antenna ports may include mapping 8 CSI-RS antenna ports of the 16 CSI-RS antenna ports to 8 REs of 24 REs which correspond to the third OFDM symbol and the fourth OFDM symbol of the second time slot and which are included in the first CSI-RS resource pool, mapping the remaining 8 CSI-RS antenna ports of the 16 CSI-RS antenna ports to 8 REs of the 24 first REs, and multiplexing the 16 CSI-RS antenna ports using TDM and CDM.

Mapping the CSI-RS antenna ports may include mapping 32 CSI-RS antenna ports to 8 REs which correspond to the sixth OFDM symbol and the seventh OFDM symbol of the first time slot and which are included in the first CSI-RS resource pool, 8 REs which correspond to the sixth OFDM symbol and the seventh OFDM symbol of the second time slot and which are included in the first CSI-RS resource pool, 8 REs of 24 REs which correspond to the third OFDM symbol and the fourth OFDM symbol of the second time slot and which are included in the first CSI-RS resource pool, and 8 REs of the 24 first REs, and multiplexing the 32 CSI-RS antenna ports using FDM, TDM, and CDM.

Mapping the CSI-RS antenna ports may include mapping 32 CSI-RS antenna ports to 16 REs of 24 REs which correspond to the third OFDM symbol and the fourth OFDM symbol of the second time slot and which are included in the first CSI-RS resource pool and 16 REs of the 24 first Res, and multiplexing the 32 CSI-RS antenna ports using FDM, TDM, and CDM.

Furthermore, in accordance with another exemplary embodiment of the present invention, a method of transmitting a channel state information reference signal (CSI-RS) by a base station is provided. The method of transmitting the CSI-RS includes setting the number of CSI-RS antenna ports for transmitting the CSI-RS to a value greater than 8, mapping the CSI-RS antenna ports to resource elements (RE) included in the CSI-RS resource pool of a subframe, and multiplexing the CSI-RS antenna ports using frequency division multiplexing (FDM) and code division multiplexing (CDM).

The subframe may include a first time slot and a second time slot subsequent to the first time slot.

Setting the number of CSI-RS antenna ports may include setting the number of CSI-RS antenna ports to one of 12, 16, 20, and 24.

Mapping the CSI-RS antenna ports may include mapping the set number of CSI-RS antenna ports to REs which belong to 24 first REs corresponding to the third orthogonal frequency division multiplexing (OFDM) symbol and the fourth OFDM symbol of the second time slot and included in the CSI-RS resource pool and which are equal to the number of CSI-RS antenna ports.

Mapping the set number of CSI-RS antenna ports may include mapping the 16 CSI-RS antenna ports to two REs which belong to the 24 first REs and which correspond to the twelfth subcarrier of the subframe, two REs which belong to the 24 first REs and which correspond to the eleventh subcarrier of the subframe, two REs which belong to the 24 first REs and which correspond to the tenth subcarrier of the subframe, two REs which belong to the 24 first REs and which correspond to the ninth subcarrier of the subframe, two REs which belong to the 24 first REs and which correspond to the sixth subcarrier of the subframe, two REs which belong to the 24 first REs and which correspond to the fifth subcarrier of the subframe, two REs which belong to the 24 first REs and which correspond to the fourth subcarrier of the subframe, and two REs which belong to the 24 first REs and which correspond to the third subcarrier of the subframe when the number of CSI-RS antenna ports is 16.

Mapping the set number of CSI-RS antenna ports may include mapping the 16 CSI-RS antenna ports to two REs which belong to the 24 first REs and which correspond to the twelfth subcarrier of the subframe, two REs which belong to the 24 first REs and which correspond to the eleventh subcarrier of the subframe, two REs which belong to the 24 first REs and which correspond to an eighth subcarrier of the subframe, two REs which belong to the 24 first REs and which correspond to the seventh subcarrier of the subframe, two REs which belong to the 24 first REs and which correspond to the sixth subcarrier of the subframe, two REs which belong to the 24 first REs and which correspond to the fifth subcarrier of the subframe, two REs which belong to the 24 first REs and which correspond to the second subcarrier of the subframe, and two REs which belong to the 24 first REs and which correspond to the first subcarrier of the subframe when the number of CSI-RS antenna ports is 16.

Furthermore, in accordance with yet another exemplary embodiment of the present invention, a method of transmitting a channel state information reference signal (CSI-RS) by a base station is provided. The method of transmitting the CSI-RS may include setting the number of first CSI-RS antenna ports for transmitting the CSI-RS to a value greater than 8, mapping the CSI-RS antenna ports to resource elements (RE) included in the CSI-RS resource pool of a subframe, and multiplexing the first CSI-RS antenna ports using time division multiplexing (TDM) and code division multiplexing (CDM).

The subframe may include a first time slot and a second time slot subsequent to the first time slot.

The method of transmitting the CSI-RS may further include configuring a first energy per resource element (EPRE) for a demodulation reference signal (DMRS) in an orthogonal frequency division multiplexing (OFDM) symbol which belongs to the OFDM symbols of the subframe and at which the CSI-RS is transmitted, configuring a second EPRE for a DMRS in an OFDM symbol which belongs to the OFDM symbols of the subframe and at which the CSI-RS is not transmitted, and transmitting a ratio of the first EPRE and the second EPRE to a terminal.

Setting the number of first CSI-RS antenna ports may include setting the number of first CSI-RS antenna ports to 16.

Mapping the first CSI-RS antenna ports may include mapping 8 antenna ports of the 16 first CSI-RS antenna ports to 8 REs of 24 REs which correspond to the third OFDM symbol and the fourth OFDM symbol of the second time slot and which are included in the CSI-RS resource pool, and mapping the remaining 8 antenna ports of the 16 first CSI-RS antenna ports to 8 REs which correspond to the sixth OFDM symbol and the seventh OFDM symbol of the second time slot and which are included in the CSI-RS resource pool.

Setting the number of first CSI-RS antenna ports may include setting the number of first CSI-RS antenna ports to 16.

Mapping the first CSI-RS antenna ports may include mapping 8 antenna ports of the 16 first CSI-RS antenna ports to 8 REs which correspond to the sixth OFDM symbol and the seventh OFDM symbol of the first time slot and which are included in the CSI-RS resource pool, and mapping the remaining 8 antenna ports of the 16 first CSI-RS antenna ports to 8 REs of 24 REs which correspond to the third OFDM symbol and the fourth OFDM symbol of the second time slot and which are included in the CSI-RS resource pool.

The method of transmitting a CSI-RS may further include setting the number of second CSI-RS antenna ports for transmitting the CSI-RS to a value equal to the number of first CSI-RS antenna ports, mapping the second CSI-RS antenna ports to the REs included in the CSI-RS resource pool, and multiplexing the second CSI-RS antenna ports using frequency division multiplexing (FDM) and CDM.

Multiplexing the first CSI-RS antenna ports may include multiplexing some of the first CSI-RS antenna ports using TDM and CDM, and multiplexing the remainder of the first CSI-RS antenna ports using frequency division multiplexing (FDM) and CDM.

### BRIEF DESCRIPTION OF THE DRAWINGS

FIG. 1 is a diagram showing the mapping of a CSI-RS RE set if the number of CSI-RS ports is 2.

FIG. 2 is a diagram showing the mapping of a CSI-RS RE set if the number of CSI-RS ports is 4.

FIG. 3 is a diagram showing the mapping of a CSI-RS RE set if the number of CSI-RS ports is 8.

FIG. 4 is a diagram showing the conceptual diagram of three-dimensional beamforming using a two-dimensional active antenna array.

FIGS. 5A and 5B are diagrams showing an embodiment of a resource configuration for 12, 16, 20, or 24 CSI-RS antenna ports according to Method M110.

FIG. 6 is a diagram showing another embodiment of a resource configuration for 16 CSI-RS antenna ports according to Method M110.

FIG. 7 is a diagram showing yet another embodiment of a resource configuration for 16 CSI-RS antenna ports according to Method M110.

FIG. 8 is a diagram showing an embodiment of a resource configuration for 16 CSI-RS antenna ports according to Method M111.

FIG. 9 is a diagram showing an embodiment of a resource configuration for 32 CSI-RS antenna ports according to Method M111.

FIG. 10 is a diagram showing an embodiment of a resource configuration for 16 CSI-RS antenna ports according to Method M120.

FIG. 11 is a diagram showing another embodiment of a resource configuration for 16 CSI-RS antenna ports according to Method M120.

FIG. 12 is a diagram showing an embodiment of a resource configuration for 16 CSI-RS antenna ports according to Method M130.

FIG. 13 is a diagram showing an embodiment of a resource configuration for 32 CSI-RS antenna ports according to Method M130.

FIG. 14 is a diagram showing another embodiment of a resource configuration for 16 CSI-RS antenna ports according to Method M130.

FIG. 15 is a diagram showing another embodiment of a resource configuration for 32 CSI-RS antenna ports according to Method M130.

FIG. 16 is a diagram showing yet another embodiment of a resource configuration for 16 CSI-RS antenna ports according to Method M130.

FIG. 17 is a diagram showing further yet another embodiment of a resource configuration for 16 CSI-RS antenna ports according to Method M130.

FIG. 18 is a diagram showing still yet another embodiment of a resource configuration for 16 CSI-RS antenna ports according to Method M130.

FIG. 19 is a diagram showing still yet another embodiment of a resource configuration for 32 CSI-RS antenna ports according to Method M130.

FIG. 20 is a diagram showing yet another embodiment of a resource configuration for 16 CSI-RS antenna ports according to Method M130.

FIG. 21 is a diagram showing yet another embodiment of a resource configuration for 32 CSI-RS antenna ports according to Method M130.

FIGS. 22A and 22B are diagrams showing exemplary embodiments in which length-4 OCC has been applied to REs.

FIG. 23 is a diagram showing an embodiment of a resource configuration for 16 CSI-RS antenna ports according to Method M141.

FIG. 24 is a diagram showing another embodiment of a resource configuration for 16 CSI-RS antenna ports according to Method M141.

FIG. 25 is a diagram showing an embodiment of a resource configuration for 16 CSI-RS antenna ports according to Method M142.

FIG. 26 is a diagram showing an embodiment of a resource configuration for 16 CSI-RS antenna ports according to Method M143.

FIG. 27 is a diagram showing an embodiment of a resource configuration for 16 CSI-RS antenna ports according to Method M144.

FIG. 28 is a diagram showing an embodiment of a resource configuration for 32 CSI-RS antenna ports according to Method M144.

FIG. 29 is a diagram showing an embodiment of a resource configuration for 16 CSI-RS antenna ports according to Method M145.

FIG. 30 is a diagram showing an embodiment of a resource configuration for 16 CSI-RS antenna ports according to Method M146.

FIG. 31 is a diagram showing an embodiment of a resource configuration for 16 CSI-RS antenna ports according to Method M147.

FIG. 32 is a diagram showing an embodiment of a resource configuration for 32 CSI-RS antenna ports according to Method M147.

FIG. 33 is a diagram showing an embodiment of a resource configuration for 16 CSI-RS antenna ports according to Method M148.

FIG. 34 is a diagram showing an embodiment of a resource configuration for 32 CSI-RS antenna ports according to Method M148.

FIG. 35 is a diagram showing an extended CSI-RS resource pool according to Method M210.

FIGS. 36A and 36B are diagrams showing an embodiment of a resource configuration for 12, 16, 20, or 24 CSI-RS antenna ports according to Method M211.

FIG. 37 is a diagram showing an embodiment of a resource configuration for 16 CSI-RS antenna ports according to Method M212.

FIG. 38 is a diagram showing another embodiment of a resource configuration for 16 CSI-RS antenna ports according to Method M212.

FIG. 39 is a diagram showing an embodiment of a resource configuration for 32 CSI-RS antenna ports according to Method M213.

FIG. 40 is a diagram showing another embodiment of a resource configuration for 32 CSI-RS antenna ports according to Method M213.

FIG. 41 is a diagram showing an embodiment of a resource configuration for 64 CSI-RS antenna ports according to Method M213.

FIG. 42 is a diagram showing another embodiment of a resource configuration for 64 CSI-RS antenna ports according to Method M213.

FIG. 43 is a diagram showing an embodiment of a resource configuration for 2 CSI-RS antenna ports according to Method M210.

FIG. 44 is a diagram showing an embodiment of a resource configuration for 4 CSI-RS antenna ports according to Method M210.

FIG. 45 is a diagram showing an embodiment of a resource configuration for 8 CSI-RS antenna ports according to Method M210.

FIG. 46 is a diagram showing an embodiment of a resource configuration for 16 CSI-RS antenna ports according to Method M214.

FIG. 47 is a diagram showing another embodiment of a resource configuration for 16 CSI-RS antenna ports according to Method M214.

FIG. 48 is a diagram showing yet another embodiment of a resource configuration for 16 CSI-RS antenna ports according to Method M214.

FIG. 49 is a diagram showing yet another embodiment of a resource configuration for 16 CSI-RS antenna ports according to Method M214.

FIG. 50 is a diagram showing yet another embodiment of a resource configuration for 16 CSI-RS antenna ports according to Method M214.

FIG. 51 is a diagram showing an embodiment of a resource configuration for 32 CSI-RS antenna ports according to Method M214.

FIG. 52 is a diagram showing a CSI-RS resource pool extended by Method M220.

FIG. 53 is a diagram showing a CSI-RS resource pool extended by Method M240.

FIG. 54 is a diagram showing an embodiment of a resource configuration for 8 CSI-RS antenna ports according to Method M310.

FIG. 55 is a diagram showing an exemplary embodiment of a two-dimensional rectangular array configuration for 16 CSI-RS antenna ports.

FIG. 56 is a diagram showing an exemplary embodiment of a two-dimensional cross array configuration for 16 CSI-RS antenna ports.

FIGS. 57A and 57B are diagrams showing an embodiment of a resource configuration for 12, 16, 20, or 24 CSI-RS antenna ports according to Method M510.

FIG. 58 is a diagram showing another embodiment of a resource configuration for 16 CSI-RS antenna ports according to Method M510.

FIG. 59 is a diagram showing a CSI-RS resource pool extended by Method M521.

FIG. 60 is a diagram showing a CSI-RS resource pool extended by Method M522.

FIG. 61 is a diagram showing a CSI-RS resource pool extended by Method M523.

FIG. 62 is a diagram showing an embodiment of a resource configuration for 16 CSI-RS antenna ports if an extended cyclic prefix (CP) is configured.

FIG. 63 is a diagram showing another embodiment of a resource configuration for 16 CSI-RS antenna ports if an extended CP is set.

FIG. 64 is a diagram showing another embodiment of a resource configuration for 32 CSI-RS antenna ports if an extended CP is set.

FIG. 65 is a diagram showing yet another embodiment of a resource configuration for 16 CSI-RS antenna ports if an extended CP is set.

FIG. 66 is a diagram showing further yet another embodiment of a resource configuration for 16 CSI-RS antenna ports if an extended CP is set.

FIG. 67 is a diagram showing still another embodiment of a resource configuration for 16 CSI-RS antenna ports if an extended CP is set.

FIG. 68 is a diagram showing an extended CSI-RS resource pool if an extended CP is set.

FIG. 69 is a diagram showing the configuration of a base station in accordance with an exemplary embodiment of the present invention.

FIG. 70 is a diagram showing the configuration of a terminal in accordance with an exemplary embodiment of the present invention.

FIG. 71 is a diagram showing a computer system in accordance with an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification, a terminal may refer to a mobile terminal (MT), a mobile station (MS), an advanced mobile station (AMS), a high reliability mobile station (HR-MS), a subscriber station (SS), a portable subscriber station (PSS), an access terminal (AT), or user equipment (UE), and may include some or all of the functions of the MS, MT, AMS, HR-MS, SS, PSS, AT, and UE.

Furthermore, a base station (BS) may refer to an advanced base station (ABS), a high reliability base station (HR-BS), a nodeB, an evolved node B (eNodeB), an access point (AP), a radio access station (RAS), a base transceiver station (BTS), a mobile multihop relay (MMR)-BS, a relay station functioning as a base station, a high reliability relay station functioning as a base station, a small base station, and a macro base station, and may include some or all of the functions of the ABS, HR-BS, nodeB, eNodeB, AP, RAS, BTS, and MMR-BS, relay station, high reliability relay station, small base station, and macro base station.

1. Mapping of CSI-RS RE if the Number of CSI-RS Antenna Ports is 1, 2, 4 or 8

The mapping of an RE in which a CSI-RS is transmitted complies with a pattern configured by each antenna port number and may be configured in a configured CSI-RS resource pool. A CSI-RS resource configuration (hereinafter referred to as a “CSI-RS configuration”) has been defined for each normal cyclic prefix (CP) and extended CP. Furthermore, a CSI-RS configuration is divided into a CSI-RS configuration which may be configured in both frequency division duplex (FDD) and time division duplex (TDD), and a CSI-RS configuration which may be configured only in TDD. For example, a CSI-RS configuration in the case of a normal CP complies with Table 1 below.

TABLE 1

| | CSI- | Number of CSI reference signals configured | | | | | |
|---|---|---|---|---|---|---|---|
| | RS | 1 or 2 | | 4 | | 8 | |
| | config- | | nₛ | | nₛ | | nₛ |
| | uration | (k′,l′) | mod 2 | (k′,l′) | mod 2 | (k′,l′) | mod 2 |
| Frame | 0 | 9 and 5 | 0 | 9 and 5 | 0 | 9 and 5 | 0 |
| structure | 1 | 11,2 | 1 | 11,2 | 1 | 11,2 | 1 |
| type 1 | 2 | 9 and 2 | 2 | 9 and 2 | 2 | 9 and 2 | 1 |
| and 2 | 3 | 7 and 2 | 1 | 7 and 2 | 1 | 7 and 2 | 1 |
| | 4 | 9 and 5 | 1 | 9 and 5 | 1 | 9 and 5 | 1 |
| | 5 | 8 and 5 | 0 | 8 and 5 | 0 | | |
| | 6 | 10,2 | 1 | 10,2 | 1 | | |
| | 7 | 8 and 2 | 1 | 8 and 2 | 1 | | |
| | 8 | 6 and 2 | 1 | 6 and 2 | 1 | | |
| | 9 | 8 and 5 | 1 | 8 and 5 | 1 | | |
| | 10 | 3 and 5 | 0 | | | | |
| | 11 | 2 and 5 | 0 | | | | |
| | 12 | 5 and 2 | 1 | | | | |
| | 13 | 4 and 2 | 1 | | | | |
| | 14 | 3 and 2 | 1 | | | | |
| | 15 | 2 and 2 | 1 | | | | |
| | 16 | 1 and 2 | 1 | | | | |
| | 17 | 0 and 2 | 1 | | | | |
| | 18 | 3 and 5 | 1 | | | | |
| | 19 | 2 and 5 | 1 | | | | |
| Frame | 20 | 11,1 | 1 | 11,1 | 1 | 11,1 | 1 |
| structure | 21 | 9 and 1 | 1 | 9 and 1 | 1 | 9 and 1 | 1 |
| type 2 | 22 | 7 and 1 | 1 | 7 and 1 | 1 | 7 and 1 | 1 |
| only | 23 | 10,1 | 1 | 10,1 | 1 | | |
| | 24 | 8 and 1 | 1 | 8 and 1 | 1 | | |
| | 25 | 6 and 1 | 1 | 6 and 1 | 1 | | |
| | 26 | 5 and 1 | 1 | | | | |
| | 27 | 4 and 1 | 1 | | | | |
| | 28 | 3 and 1 | 1 | | | | |
| | 29 | 2 and 1 | 1 | | | | |
| | 30 | 1 and 1 | 1 | | | | |
| | 31 | 0 and 1 | 1 | | | | |

In Table 1, CSI-RS configuration Nos. 0-19 may be applied to FDD and TDD in common, and CSI-RS configuration Nos. 20-31 may be only applied to TDD. In the case of TDD, there is a possibility that the DMRS of the antenna port No. 5 may be transmitted for a terminal configured as transmission mode (TM) 7. Accordingly, in order to avoid resource overlap with the antenna port No. 5 DMRS, CSI-RS configuration Nos. 20-31 have been additionally defined. In Table 1, an index pair (k′, l′) indicated by each CSI-RS configuration means an RE that is the reference point of a CSI-RS RE set, and it has been previously defined in a standard regarding that how a CSI-RS RE set is determined based on (k′, l′) within a single PRB pair.

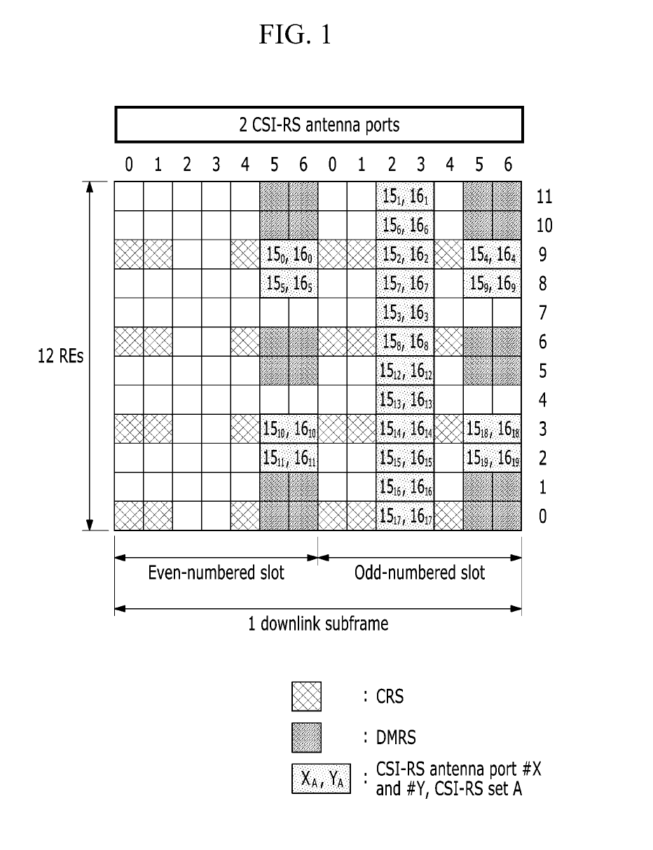

FIGS. 1 to 3 illustrate the mapping of RE sets from a CSI-RS configuration No. 0 to a maximum CSI-RS configuration No. 19 if a normal CP is applied and the number of CSI-RS antenna ports is 2, 4, or 8. In this specification, a “CSI-RS set A” indicated in the drawings means a CSI-RS configuration No. A. X, Y denotes CSI-RS antenna port number. X_{A}, Y_{A}denotes CSI-RS antenna port Nos. X and Y in the CSI-RS configuration No. A.

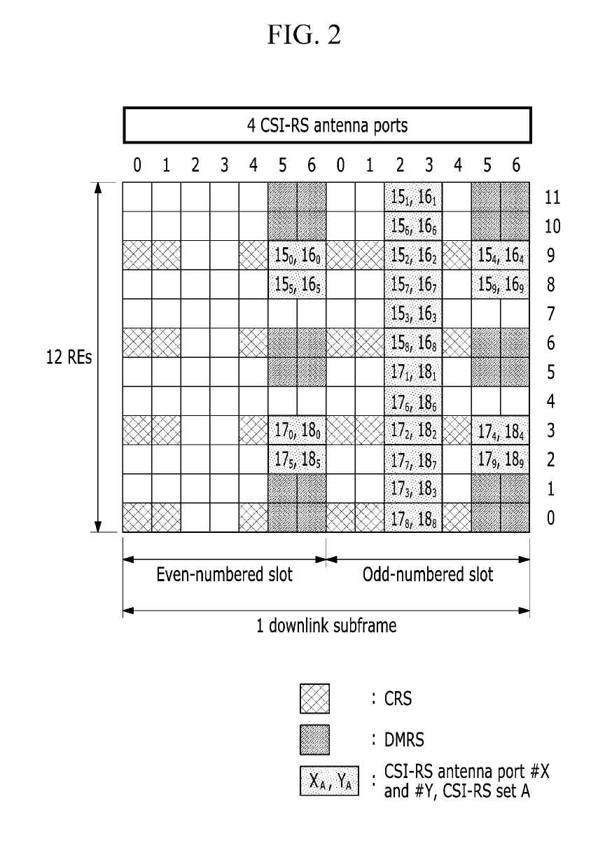

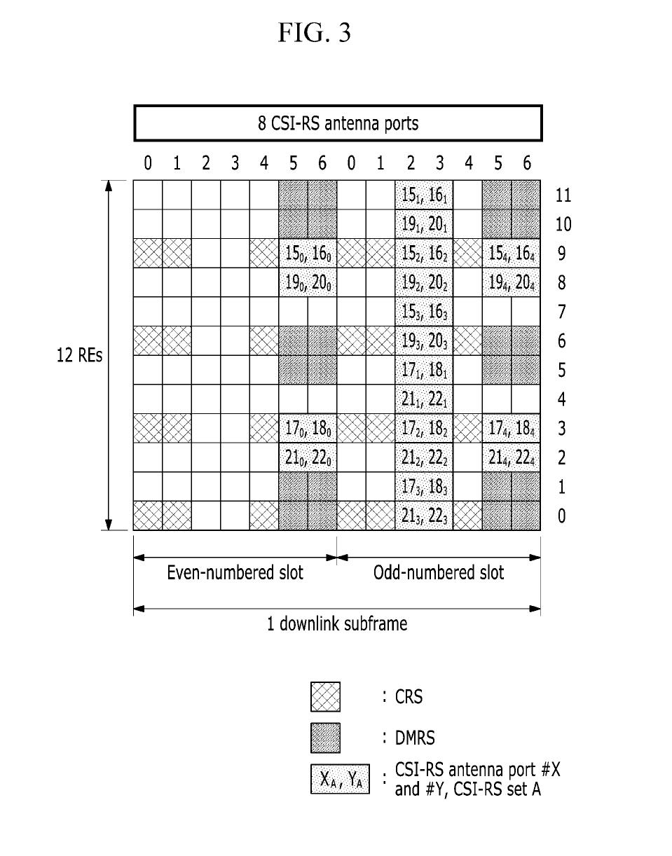

FIG. 1 is a diagram showing the mapping of a CSI-RS RE set if the number of CSI-RS ports is 2, FIG. 2 is a diagram showing the mapping of a CSI-RS RE set if the number of CSI-RS ports is 4, and FIG. 3 is a diagram showing the mapping of a CSI-RS RE set if the number of CSI-RS ports is 8. A single downlink subframe shown in FIGS. 1 to 3 includes two time slots. Specifically, if a normal CP is set, a single subframe includes an even-numbered time slot (hereinafter referred to as a “first time slot”) and an odd-numbered time slot (hereinafter referred to as a “second time slot”) subsequent to an even-numbered time slot. The first time slot or the second time slot includes 7 orthogonal frequency division multiplexing (OFDM) symbols No. 0-No. 6 in a time axis and 12 subcarriers No. 0-No. 11 in a frequency axis. That is, 84=7×12 REs are present in the first time slot or the second time slot. A single subframe corresponds to a single PRB pair. Some of 84 REs may be configured as REs for CRS transmission, some of the 84 REs may be configured as REs for DMRS transmission, and some of the 84 REs may be configured as REs for CSI-RS transmission. For example, in FIG. 1, the CSI-RS antenna port Nos. 15 and 16 of a CSI-RS configuration No. 0 are mapped (or configured in) to two REs that correspond to the sixth OFDM symbol (i.e., the OFDM symbol No. 5) and seventh OFDM symbol (i.e., the OFDM symbol No. 6) of a first time slot and that correspond to a tenth subcarrier (i.e., a subcarrier No. 9). That is, two CSI-RS antenna ports (Nos. 15 and 16) for each of the CSI-RS configuration Nos. 0-19 are mapped to two REs. Hereinafter, an RE that corresponds to a subcarrier No. i and an OFDM symbol No. j is called an RE (i, j).

For another example, in FIG. 2, the CSI-RS antenna port Nos. 15 and 16 of a CSI-RS configuration No. 1 are mapped to the RE (11, 2) and RE (11, 3) of a second time slot. The CSI-RS antenna port Nos. 17 and 18 of a CSI-RS configuration No. 1 are mapped to the RE (5, 2) and RE (5, 3) of the second time slot. That is, the four CSI-RS antenna ports Nos. 15 to 18 of each of CSI-RS configuration Nos. 0-9 are mapped to 4 REs.

For yet another example, in FIG. 3, the CSI-RS antenna port Nos. 15 and 16 of a CSI-RS configuration No. 0 are mapped to the RE (9, 5) and RE (9, 6) of a first time slot; the CSI-RS antenna port Nos. 17 and 18 of the CSI-RS configuration No. 0 are mapped to the RE (3, 5) and RE (3, 6) of the first time slot; the CSI-RS antenna port Nos. 19 and 20 for the CSI-RS configuration No. 0 are mapped to the RE (8, 5) and RE (8, 6) of the first time slot; and the CSI-RS antenna port Nos. 21 and 22 for the CSI-RS configuration No. 0 are mapped to the RE (2, 5) and RE (2, 6) of the first time slot. That is, 8 CSI-RS antenna port Nos. 15 to 22 for each of the CSI-RS configuration Nos. 0-4 are mapped to 8 REs.

Code division multiplexing (CDM) is applied to CSI-RS antenna ports (e.g., CSI-RS antenna port Nos. 15 and 16) transmitted through the same RE as an inter-antenna port multiplexing method. For example, in FIG. 1, the CSI-RS antenna port Nos. 15 and 16 are transmitted (i.e., CSI-RSs are transmitted) through the RE (9, 5) of the first time slot, and the CSI-RS antenna port Nos. 15 and 16 are transmitted through the RE (9, 6) of the first time slot. In this case, in order to differentiate the CSI-RS antenna port Nos. 15 and 16 transmitted through the same RE, CDM is applied between the CSI-RS antenna port Nos. 15 and 16.

Frequency division multiplexing (FDM) is applied between CSI-RS antenna ports (e.g., the CSI-RS antenna port Nos. 15 and 17) transmitted through different REs as an inter-antenna port multiplexing method. For example, in FIG. 2, the CSI-RS antenna port No. 15 is transmitted through the RE (9, 5) and RE (9, 6) of the first time slot, and the CSI-RS antenna port No. 17 is transmitted through the RE (3, 5) and RE (3, 6) of the first time slot. In this case, in order to differentiate the CSI-RS antenna port Nos. 15 and 17 transmitted through different REs, FDM is applied between the CSI-RS antenna port Nos. 15 and 17.

2. Method of Extending CSI-RS Configuration and Method of Defining Added CSI-RS RE Set

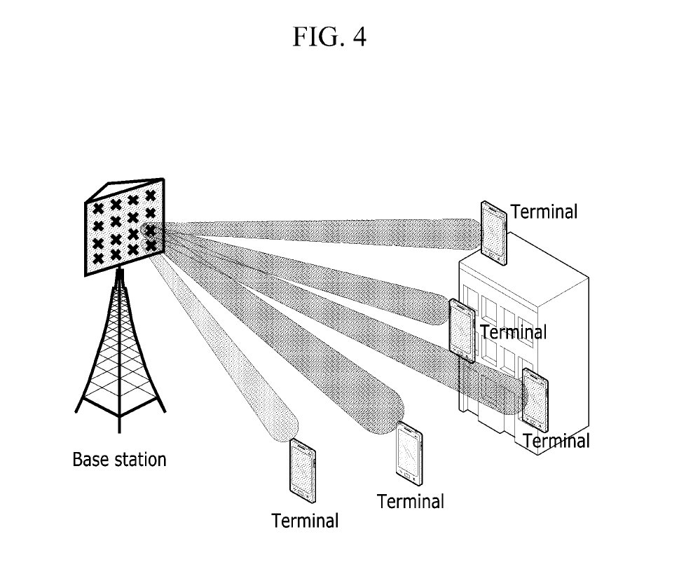

FIG. 4 is a schematic view showing three-dimensional beamforming of a full dimension (FD)-MIMO system using a two-dimensional active antenna array.

In an FD-MIMO (or three-dimensional MIMO) system, in order for a base station to perform three-dimensional beamforming, a terminal needs to perform measurements and a report on a CSI in a vertical axis in addition to a CSI in an existing horizontal axis. However, since a maximum number of CSI-RS antenna ports which may be configured in a single terminal is 8 in an existing LTE standard, the terminal may not estimate the entire channel space using only the maximum number of 8 CSI-RS ports if the size of a two-dimensional antenna array is large. Furthermore, since the number of radio frequency (RF) chains is increased in an FD-MIMO system, there may be a problem in that transmission efficiency is deteriorated if an existing CSI-RS pattern is identically applied.

Hereinafter, a method of extending a CSI-RS configuration for a terminal to a case where the number of antenna ports is 16, 32, or 64 is chiefly described. Furthermore, in some methods, a method of extending a CSI-RS configuration to a case where the number of antenna ports is 12 or 24 is described. Furthermore, in some methods, a method of additionally defining a CSI-RS RE set for a case where the number of CSI-RS antenna ports is 1, 2, 4, or 8 is described. Methods to be described below belong to one or a plurality of the following 4 cases.
If a CP is a normal CP, a CSI-RS configuration applicable to both FDD and TDD
If a CP is a normal CP, a CSI-RS configuration applicable to only TDD
If a CP is an extended CP, a CSI-RS configuration applicable to both FDD and TDD
If a CP is an extended CP, a CSI-RS configuration applicable to only TDD

Methods in accordance with exemplary embodiments of the present invention may have different advantages according to an antenna virtualization method. In this case, antenna virtualization means mapping between an antenna port and a physical antenna element(s). In a digital signal processing-based communication system, antenna virtualization may include antenna port virtualization and transceiver unit (TXRU) virtualization. In this case, the TXRU means the unit of an RF device capable of independently controlling the phase and amplitude of an input signal, and it is commonly called an RF chain. Antenna port virtualization means mapping between an antenna port and a TXRU(s), and TXRU virtualization means mapping between a TXRU and a physical antenna element(s). A terminal is basically unable to be aware of virtualization applied to each antenna port. Assuming that the entire transmission power of a base station is 1 for convenience sake, maximum output power of the power amplifier of each transmitter unit (TXU) may be implemented by 1/M (in this case, M=the number of base stations).

If a CSI-RS antenna port is configured in a two-dimensional manner, CSI-RS antenna port virtualization may be divided into horizontal axis virtualization and vertical axis virtualization. In horizontal axis CSI-RS antenna port virtualization, in general, one-to-one mapping may be applied, that is, mapping may be applied in such a manner that each CSI-RS antenna port is connected to a single TXU. In contrast, in vertical axis CSI-RS antenna port virtualization, one-to-one mapping may be applied, and mapping may be applied in a full connection form in which each CSI-RS antenna port is connected to all the TXUs in a vertical axis. In this specification, unless specially described, it is assumed that one-to-one mapping is applied to vertical axis virtualization of a CSI-RS antenna port.

In this specification, CSI-RS antenna port numbers are sequentially numbered from No. 15 because they have been defined as Nos. 15-22 in a current LTE standard, but this is only for an index for differentiating a plurality of CSI-RS antenna ports and does not have a special meaning. That is, CSI-RS antenna port Nos. may be defined as any numbers in addition to the rule.

A terminal performs channel estimation on each port with respect to CSI-RS antenna ports configured using a method of configuring CSI-RS resources in accordance with an exemplary embodiment of the present invention described in this specification. A terminal may use channel information about each CSI-RS antenna port, obtained through channel estimation, to perform at least CSI measurement and report.

2.1. CSI-RS Configuration Applicable to Both FDD and TDD if a Normal CP is Set

First, a method of extending CSI-RS configuration Nos. 0-19 which is applied to an FDD frame structure and a TDD frame structure in common if a normal CP is set is described below. In this case, as illustrated in FIGS. 1 to 3, a total number of REs which may be configured as CSI-RS transmission resources within a single PRB pair is 40. A set of REs which may be configured as CSI-RS transmission resources within a single PRB pair is hereinafter called a CSI-RS resource pool. A CSI-RS configuration method used without changing a CSI-RS resource pool in an existing standard (hereinafter referred to as “Method M100”) is first described, and a method of extending the CSI-RS resource pool (hereinafter referred to as “Method M200”) is subsequently described.

In Method M100, a method of extending a CSI-RS pattern in a frequency axis using FDM (hereinafter referred to as “Method M110”) is described.

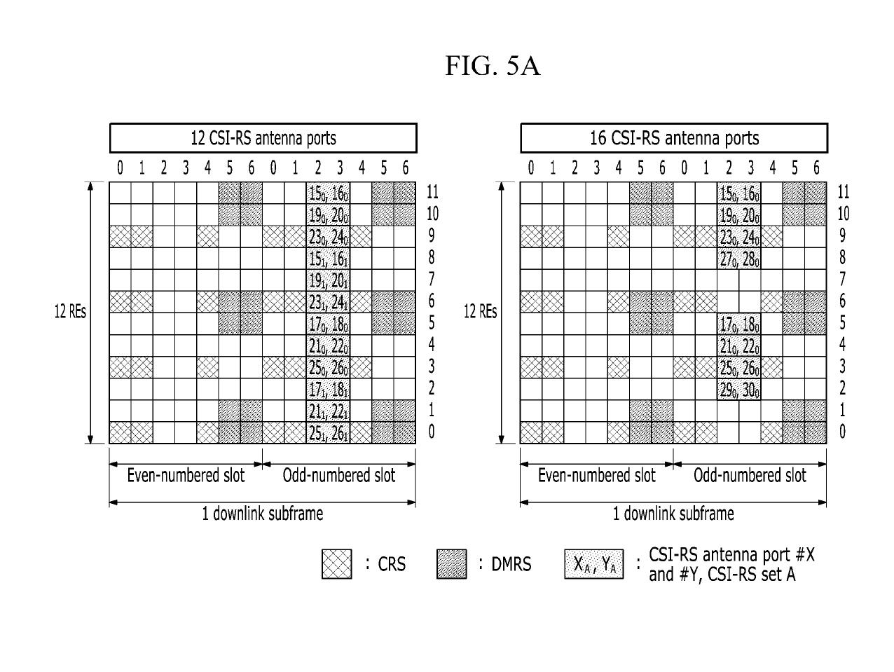

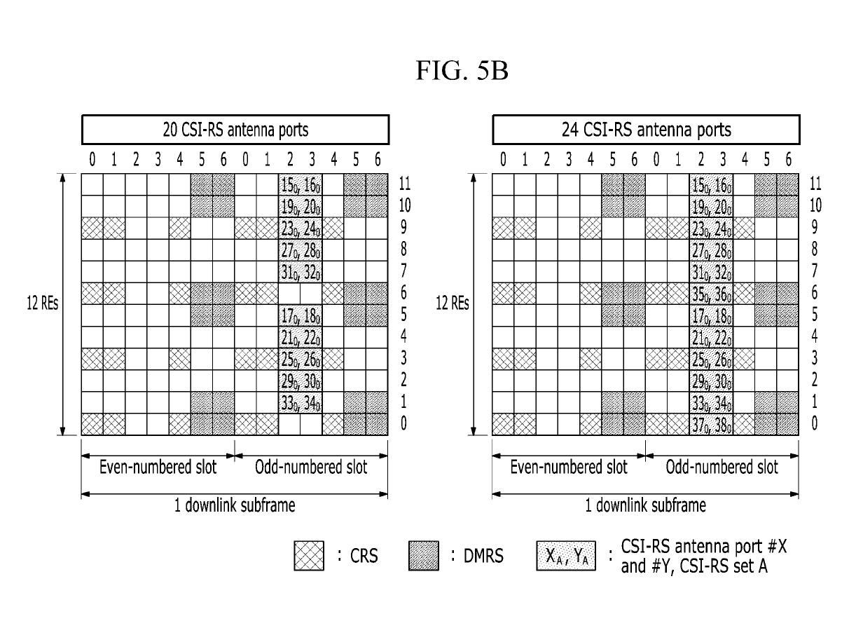

Method M110 is a method of extending a CSI-RS RE set in the frequency axis on the same OFDM symbol, but orthogonal cover code (OCC) having a length of 2 is identically applied as in an existing method. FIGS. 5A, 5B, 6, and 7 are exemplary embodiments of Method M110.

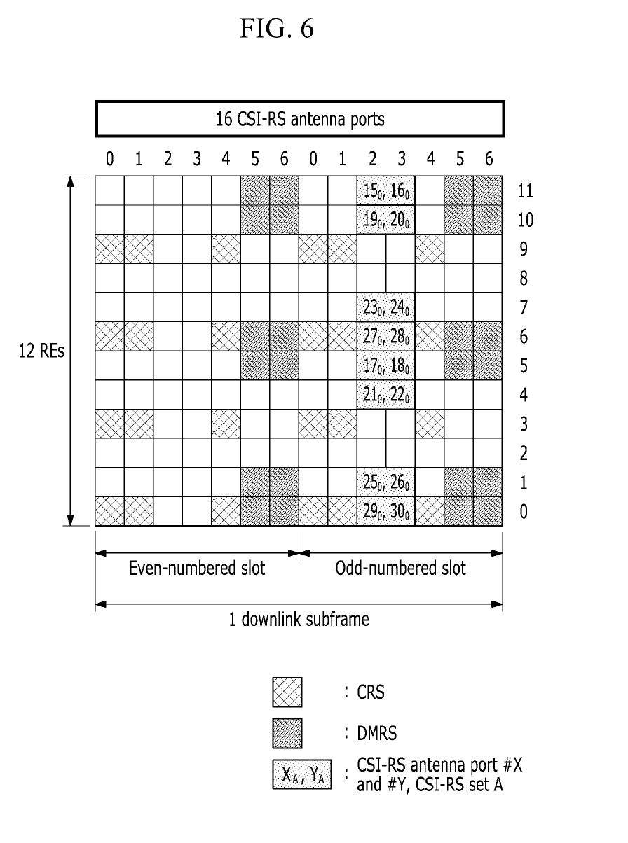

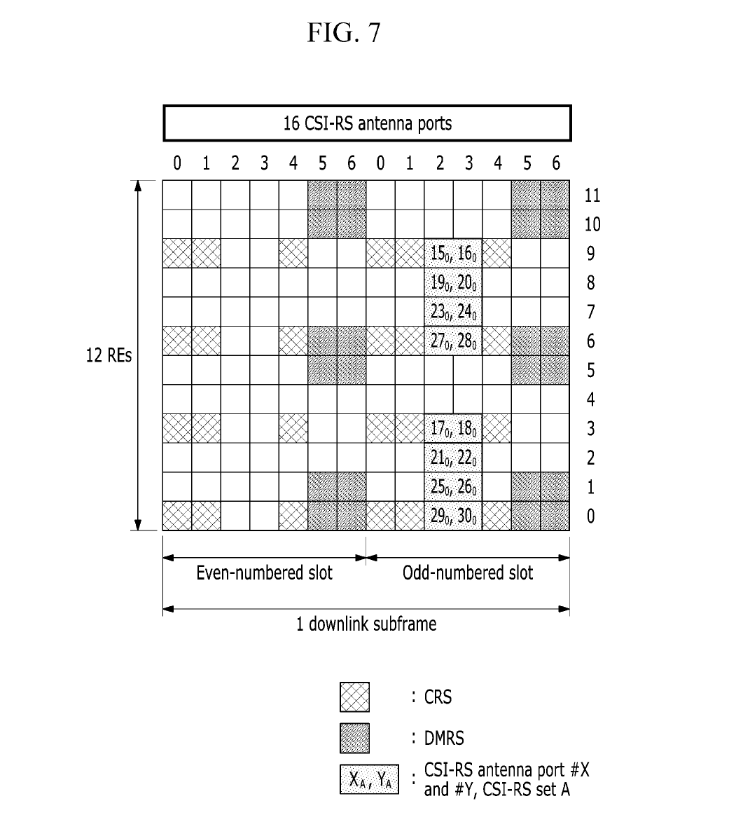

FIG. 5A is a diagram showing an exemplary embodiment of a CSI-RS configuration for 12 or 16 CSI-RS antenna ports according to Method M110, and 5B is a diagram showing an exemplary embodiment of a CSI-RS configuration for 20 or 24 CSI-RS antenna ports according to Method M110. FIG. 6 is a diagram showing another embodiment of a resource configuration for 16 CSI-RS antenna ports according to Method M110. FIG. 7 is a diagram showing yet another embodiment of a resource configuration for 16 CSI-RS antenna ports according to Method M110.

In the CSI-RS configuration methods illustrated in FIGS. 5A and 5B, whenever the number of antenna ports is increased every four antenna ports, a rule in which an RE set is extended in the frequency axis is the same. In all the exemplary embodiments of FIGS. 5A, 5B, 6, and 7, a nested structure with an existing CSI-RS antenna port pattern has been applied by taking coexistence with an existing terminal into consideration. That is, a newly defined CSI-RS antenna port pattern partially includes an existing 1, 2, 4, or 8 CSI-RS antenna port pattern. In other words, a CSI-RS antenna port pattern newly defined for a CSI-RS configuration No. A partially includes an existing CSI-RS antenna port pattern for a CSI-RS configuration No. B (No. B may be the same as or different from No. A) and includes an additional RE, thereby establishing a nested structure. For example, a CSI-RS antenna port pattern (i.e., 12, 16, 20, or 24 CSI-RS antenna ports) for a CSI-RS configuration No. 0 illustrated in FIGS. 5A and 5B includes an existing CSI-RS antenna port pattern (i.e., 8 CSI-RS antenna ports) for a CSI-RS configuration No. 1. That is, if a CSI-RS antenna port pattern for the CSI-RS configuration No. A partially includes a CSI-RS antenna port pattern for the CSI-RS configuration No. B, although the CSI-RS configuration Nos. A and B have different CSI-RS configuration numbers, a nested structure is established between the CSI-RS antenna port pattern for the CSI-RS configuration No. A and the CSI-RS antenna port pattern for the CSI-RS configuration No. B.

Likewise, a nested structure is also partially established between the patterns of 12 or 24 CSI-RS antenna ports illustrated in FIGS. 5A and 5B. Method M110 has a drawback in that 32 or 64 CSI-RS antenna port patterns are unable to be defined within a single subframe, and a drawback in that only one of 16 CSI-RS antenna ports (Nos. 15 to 30) for a corresponding CSI-RS RE set (e.g., the CSI-RS configuration No. 0) may be defined if the number of CSI-RS antenna ports is 16, 20, or 24 as illustrated in FIGS. 5A to 7. In the methods of FIGS. 5A and 5B, if the number of CSI-RS antenna ports is 12, two CSI-RS RE sets (e.g., 12 CSI-RS antenna ports (Nos. 15 to 26) for the CSI-RS configuration No. 0 and 12 CSI-RS antenna ports (Nos. 15 to 26) for the CSI-RS configuration No. 1) may be defined within a single subframe.

If 12, 16, 20, or 24 CSI-RS antenna ports are configured according to Method M110, assuming that one-to-one mapping is applied to antenna port virtualization, there is an advantage in that full transmission power can be applied to each antenna port. Accordingly, a terminal can obtain the same CSI-RS channel estimation performance as that of a case where existing 1, 2, 4, or 8 CSI-RS antenna ports have been configured. If one-to-one mapping is applied to antenna port virtualization in Method M110 and full transmission power is applied to each CSI-RS antenna port, however, CSI-RS power boost is increased compared to an existing method. In this case, the CSI-RS power boost means that transmission power of RE in which a CSI-RS is transmitted by each TXU becomes greater than transmission power of an RE in which a DMRS or PDSCH is transmitted. CSI-RS power boost exceeding a limit may cause performance degradation attributable to RF impairments. If 16 CSI-RS antenna ports are configured according to Method M110, CSI-RS power boost of 9 dB may be required. To this end, a method of increasing a maximum setting value of a ratio (defined as Pc in the LTE standard) of a CSI-RS EPRE to 18 dB to a PDSCH energy per resource element (EPRE), that is, a parameter set in a terminal by a base station, may be taken into consideration. Alternatively, in methods to be described below, a method of increasing a maximum setting value of Pc to 21 dB if CSI-RS power boost of 12 dB is required may be taken into consideration.

In an exemplary embodiment on the right side of FIG. 5A and exemplary embodiments of FIGS. 5B to 7, the index (or number) of a CSI-RS configuration has been illustrated as being No. 0, but the index of a CSI-RS configuration does not need to be No. 0. For example, a method of setting the index of a CSI-RS configuration as No. 1 in the exemplary embodiment on the right side of FIG. 5A and the exemplary embodiment of FIG. 5B and setting the index of a CSI-RS configuration as No. 2 in the exemplary embodiment of FIG. 7 so that the index of a CSI-RS configuration is the same as that of an RE set for the existing 1, 2, 4, or 8 CSI-RS antenna port may be taken into consideration.

A method of extending a CSI-RS pattern in the frequency axis using a plurality of PRB pairs that are contiguous in the frequency axis and using FDM (hereinafter referred to as “Method M111”) is described below.

Method M111 has a principle similar to that of Method M110, but is different from Method M110 in that an existing CSI-RS resource pool is not used without a change, but a CSI-RS resource pool is extended using a plurality of PRB pairs.

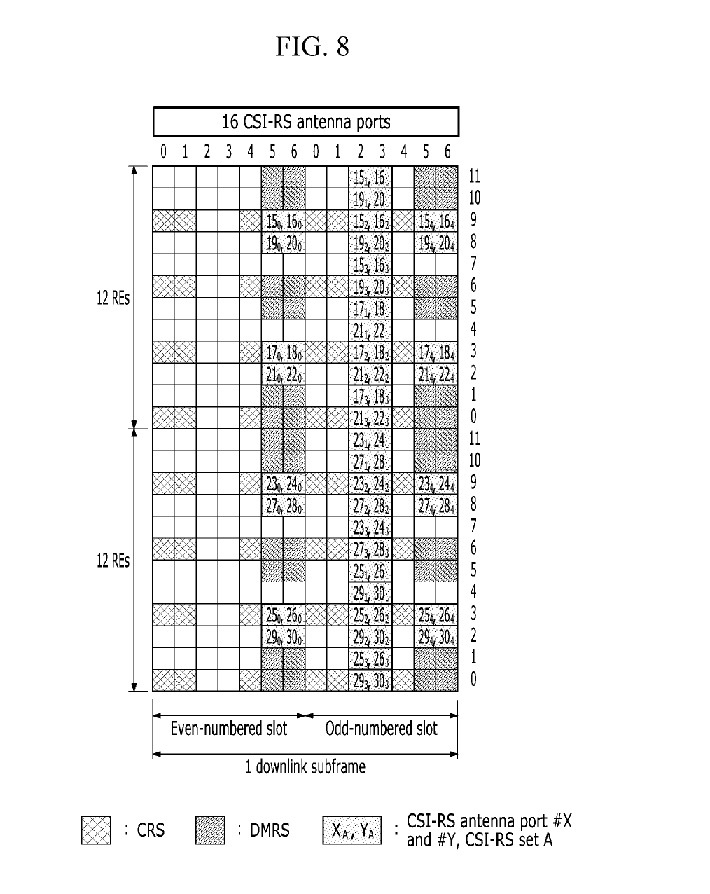

FIG. 8 is a diagram showing an embodiment of a resource configuration for 16 CSI-RS antenna ports according to Method M111. Specifically, FIG. 8 is a diagram showing an example in which the size of a CSI-RS resource pool has been doubled by binding two PRB pairs into one. That is, a total number of REs which may be configured as CSI-RS transmission resources is 80 (=40×2). In Method M110, only one pattern of 16 CSI-RS antenna ports may be defined within a single subframe. In contrast, in Method M111, if two PRB pairs are combined as illustrated in FIG. 8, a maximum number of 5 patterns of 16 CSI-RS antenna ports may be defined. That is, in Method M111, 16 CSI-RS antenna ports (Nos. 15 to 30) for a CSI-RS configuration No. 0, 16 CSI-RS antenna ports (Nos. 15 to 30) for a CSI-RS configuration No. 1, 16 CSI-RS antenna ports (Nos. 15 to 30) for a CSI-RS configuration No. 2, 16 CSI-RS antenna ports (Nos. 15 to 30) for a CSI-RS configuration No. 3, and 16 CSI-RS antenna ports (Nos. 15 to 30) for a CSI-RS configuration No. 4 may be configured. However, Method M111 has a problem in that channel estimation performance may be degraded because the number of REs allocated to each CSI-RS antenna port is reduced by half in the frequency axis.

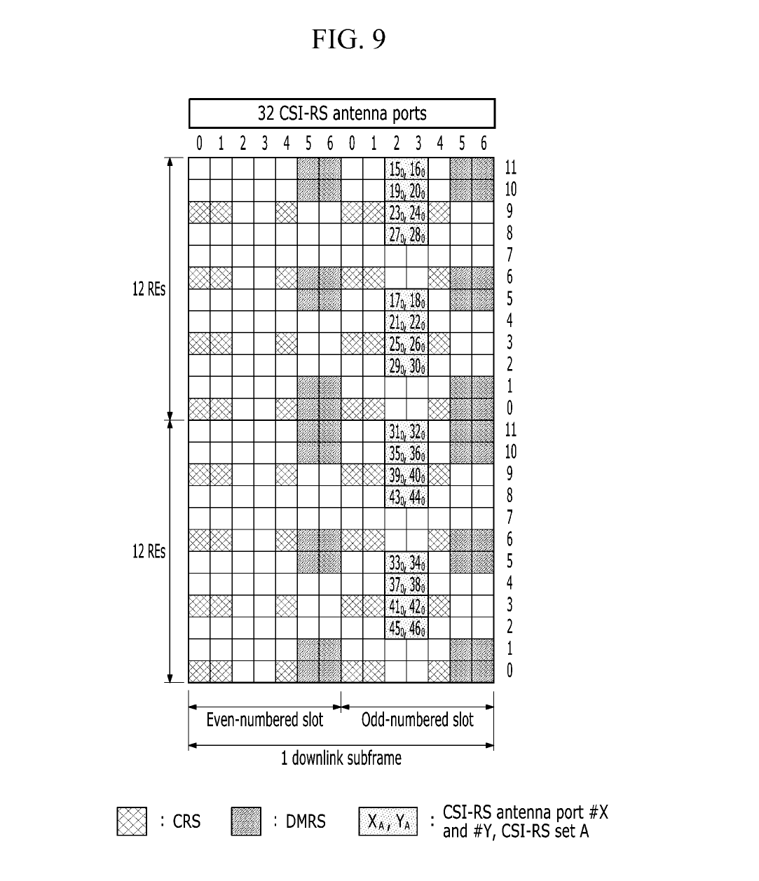

FIG. 9 is a diagram showing an embodiment of a resource configuration for 32 CSI-RS antenna ports according to Method M111. Specifically, FIG. 9 shows an example in which a CSI-RS configuration for 32 CSI-RS antenna ports has been defined by combining two PRB pairs. FIG. 9 illustrates that a CSI-RS RE set within a single PRB pair has been configured in the same manner as the exemplary embodiment on the right side of FIG. 5B. The exemplary embodiment of FIG. 9 has the same characteristics and advantages as the exemplary embodiment of FIG. 8. However, the number of CSI-RS antenna ports is 32 in the exemplary embodiment of FIG. 9, which has been increased by four times compared to the existing number of CSI-RS antenna ports of 8. Accordingly, CSI-RS power boost increased by four times compared to the existing number of CSI-RS antenna ports of 8 may be required. In this case, a method of increasing a maximum setting value of Pc to 21 dB may be taken into consideration.

In Method M100, a method of increasing a CSI-RS pattern using time division multiplexing (TDM) in a time axis (hereinafter referred to as “M120”) is described below.

Method M120 is a method of differentiating an existing antenna port and a newly defined antenna port using different time resources. Method M120 is a multiplexing method between CSI-RS antenna ports, and it uses TDM.

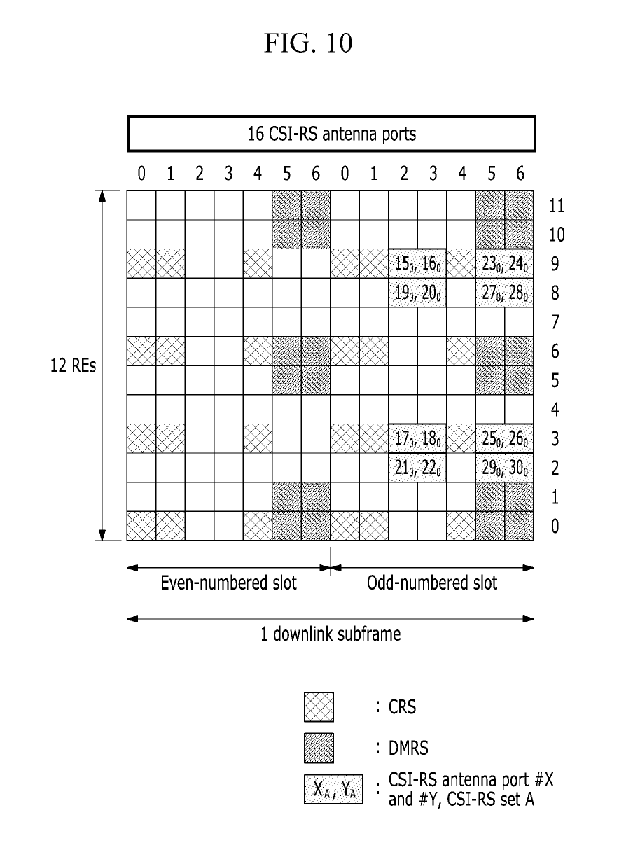

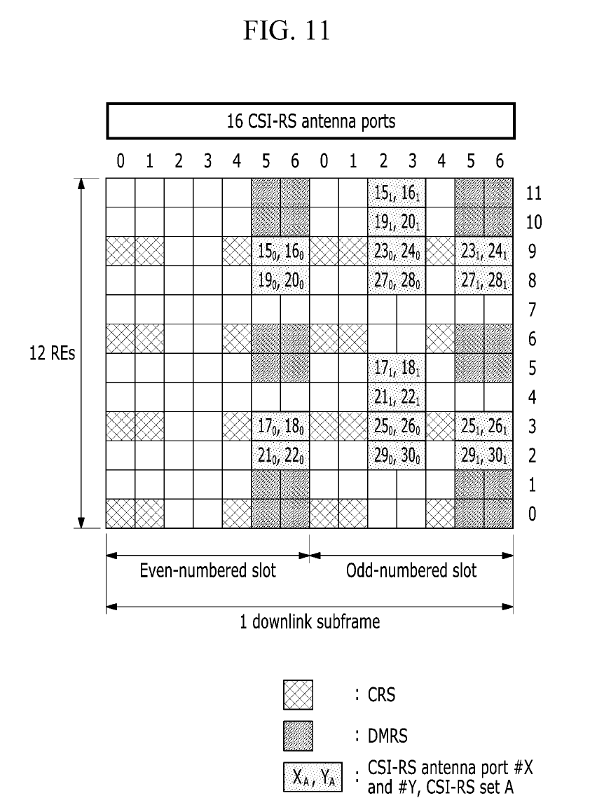

FIG. 10 is a diagram showing an embodiment of a resource configuration for 16 CSI-RS antenna ports according to Method M120. FIG. 11 is a diagram showing another embodiment of a resource configuration for 16 CSI-RS antenna ports according to Method M120.

As illustrated in FIG. 11, in Method M120, unlike in Method M110, if the number of CSI-RS antenna ports is 16, two CSI-RS RE sets may be defined within a single subframe. For example, in Method M120, 16 CSI-RS antenna ports Nos. 15-30 for a CSI-RS configuration No. 0 and 16 CSI-RS antenna ports Nos. 15-30 for a CSI-RS configuration No. 1 may be defined within a single subframe.

Furthermore, in the exemplary embodiment illustrated in FIG. 11, the 16 patterns of CSI-RS antenna ports for the CSI-RS configuration Nos. 0 and 1 partially include the existing pattern of CSI-RS antenna ports (1, 2, 4, or 8) for CSI-RS configuration Nos. 0 and 1. A nested structure is established between the CSI-RS antenna port pattern illustrated in FIG. 10 and the existing CSI-RS antenna port pattern (1, 2, 4, or 8 CSI-RS antenna ports).

Furthermore, in the exemplary embodiment illustrated in FIG. 10, a time axis interval between an RE set of CSI-RS antenna port Nos. 15-22 and an RE set of CSI-RS antenna port Nos. 23-30 is one OFDM symbol, and the two RE sets have the same frequency axis location. As described above, the exemplary embodiment illustrated in FIG. 10 has an advantage in that the CSI measurement accuracy of a terminal can be increased by minimizing a difference between points of time at which CSI-RS antenna ports are transmitted.

In contrast, in Method M120, full transmission power for each antenna port may not be guaranteed if one-to-one mapping is applied to CSI-RS antenna port virtualization. Specifically, an example in which transmission power is equally distributed to all TXUs may be taken into consideration because a CSI-RS antenna port is virtualized with a TXU in a one-to-one mapping form, but beamforming or precoding having constant modulus amplitude is applied to a DMRS or PDSCH transmitted in the same OFDM symbol as an OFDM symbol in which a corresponding CSI-RS is transmitted. In this case, in accordance with Method M120, remaining power is generated in a TXU to which a CSI-RS antenna port is not mapped because transmission power of an RE occupied by a CSI-RS antenna port cannot be equally distributed to each power amplifier of a TXU. In this case, in order for a TXU to which a CSI-RS antenna port has been mapped to not apply damage to transmission power of a DMRS and PDSCH, transmission power of a corresponding CSI-RS antenna port is reduced. As illustrated in FIG. 10 or 11, if the number of CSI-RS antenna ports is extended by two times compared to the existing number 8 of CSI-RS antenna ports according to the TDM method, CSI-RS transmission power is reduced by half. This may cause the degradation of channel estimation performance because it reduces CSI-RS reception power of a terminal by half. If the number of CSI-RS antenna ports is extended by four times (32 CSI-RS antenna ports) compared to the existing number 8 of CSI-RS antenna ports according to the TDM method, CSI-RS transmission power is reduced to ¼ on the assumption of the same antenna port virtualization.

As a method for solving a problem in that CSI-RS transmission power is reduced in Method M120, a method of applying beamforming or precoding not having constant modulus amplitude to the DMRS and PDSCH of an OFDM symbol in which a CSI-RS is transmitted may be taken into consideration. However, such a method is problematic in that DMRS channel estimation performance or PDSCH demodulation performance may be degraded because different beamforming or precoding may be applied to OFDM symbols within a single subframe. A method of unequally allocating PDSCH transmission power of an OFDM symbol in which a CSI-RS is transmitted and an OFDM symbol in which a CSI-RS is not transmitted within a single subframe may be taken into consideration as another method.

A method (hereinafter referred to as “Method M121”) of signaling to a terminal, by a base station, a ratio of the EPRE of the DMRS or PDSCH of an OFDM symbol in which a CSI-RS is transmitted (hereinafter referred to as a “first EPRE”) and the EPRE of the DMRS or PDSCH of an OFDM symbol in which a CSI-RS is not transmitted (hereinafter referred to as a “second EPRE”) is described below.

For convenience of description, a ratio of EPREs in which the first EPRE is taken as a denominator and the second EPRE is taken as a numerator in Method M121 is called P_D. The value P_D may be sufficient when the value is smaller than 1 if it has an object to increase CSI-RS transmission power. For example, in the exemplary embodiments of FIGS. 10 and 11, the value P_D may be set to ½. If the value P_D is ½, it means that DMRS or PDSCH transmission power of an OFDM symbol in which a CSI-RS is transmitted is reduced by half. A base station may increase CSI-RS transmission power twice using the value P_D. Method M121 has an advantage in that it can compensate for a loss in terms of CSI-RS transmission power, but may be disadvantageous in terms of the entire transmission power utilization because it increases the remaining power of a TXU to which a CSI-RS antenna port is not mapped.

A method in which a CSI-RS pattern according to Method M110 and a CSI-RS pattern according to Method M120 coexist within a single subframe (hereinafter referred to as “Method M130”) is described below.

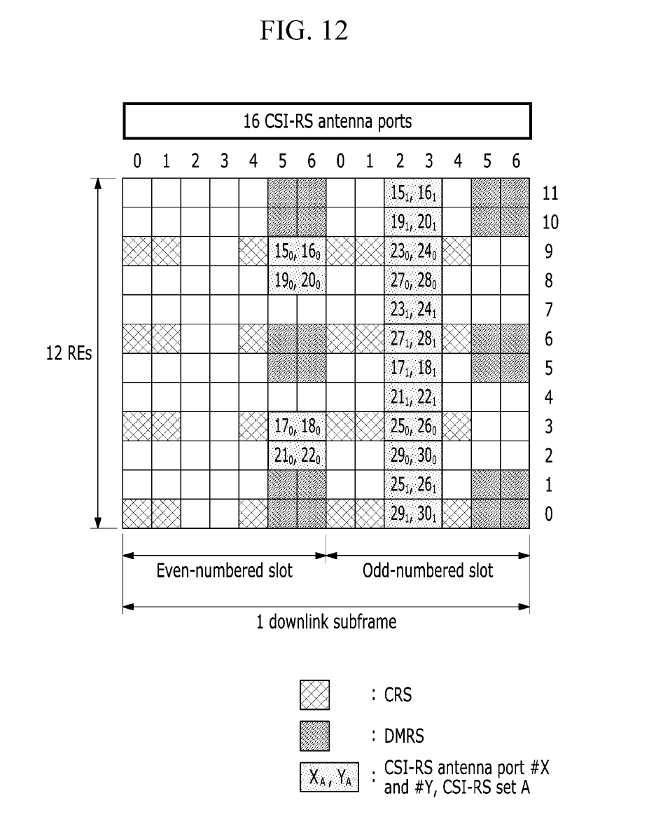

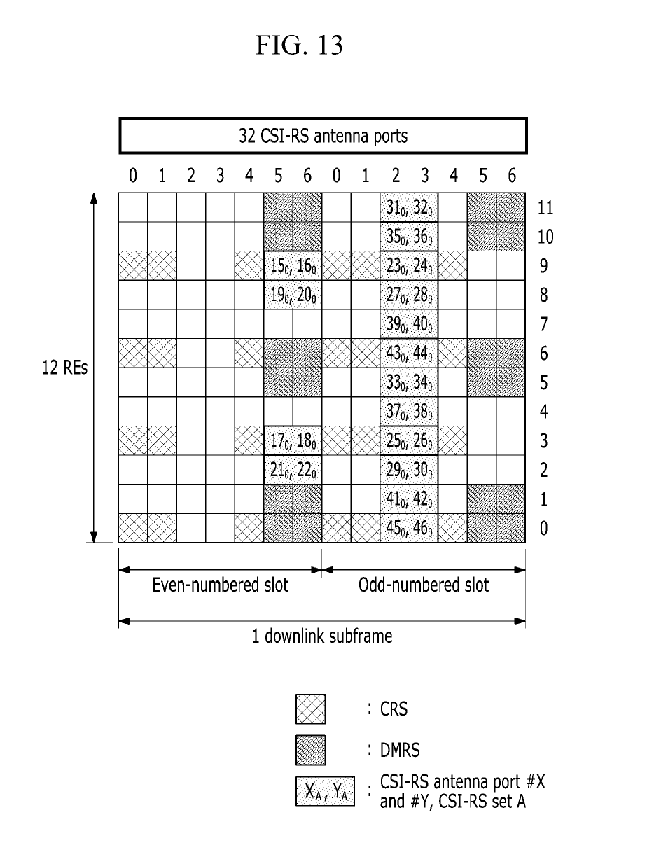

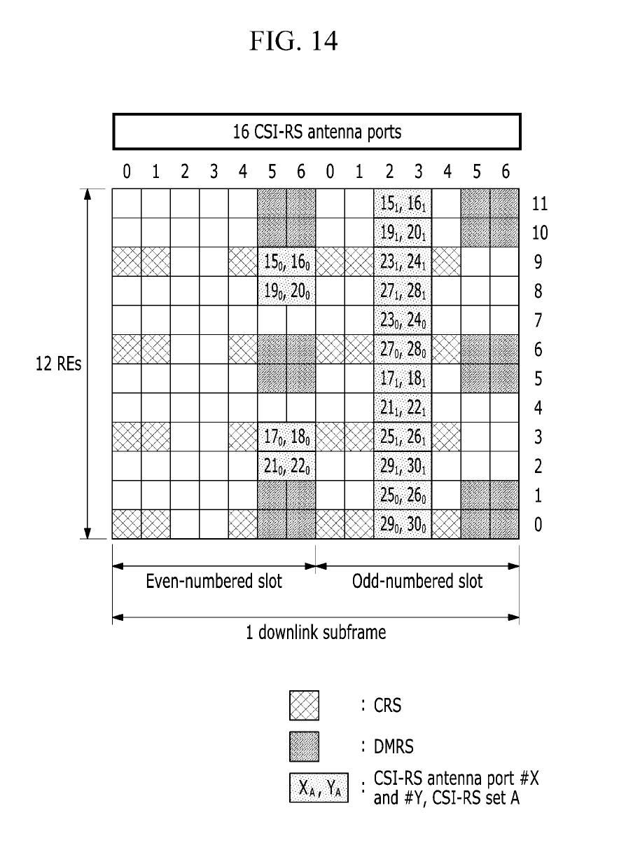

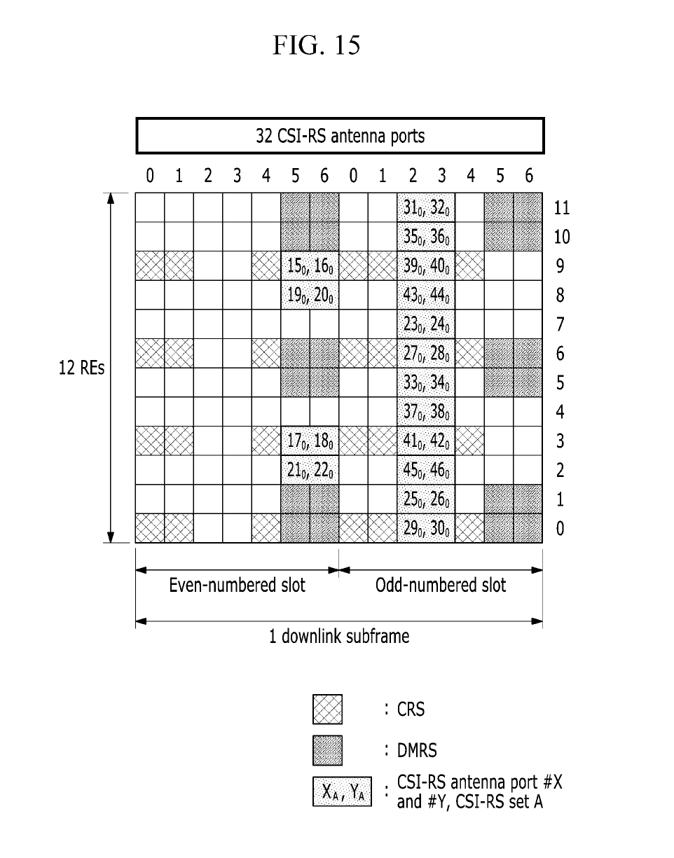

FIGS. 12 to 15 are exemplary embodiments of Method M130. FIG. 12 is a diagram showing an embodiment of a resource configuration for 16 CSI-RS antenna ports according to Method M130. FIG. 13 is a diagram showing an embodiment of a resource configuration for 32 CSI-RS antenna ports according to Method M130. FIG. 14 is a diagram showing another embodiment of a resource configuration for 16 CSI-RS antenna ports according to Method M130. FIG. 15 is a diagram showing another embodiment of a resource configuration for 32 CSI-RS antenna ports according to Method M130.

A characteristic of the exemplary embodiments according to Method M130 is that a nested structure is established between CSI-RS patterns for a different number of antenna ports with respect to the same CSI-RS configuration. For example, a pattern (CSI-RS antenna port Nos. 15-46) for a CSI-RS configuration No. 0 illustrated in FIG. 13 partially includes a pattern (CSI-RS antenna port Nos. 15-30) for a CSI-RS configuration No. 0 illustrated in FIG. 12. The pattern for the CSI-RS configuration No. 0 illustrated in FIG. 12 partially includes an existing pattern (1, 2, 4, or 8 CSI-RS antenna ports) for the CSI-RS configuration No. 0. Accordingly, for the CSI-RS configuration of Table 1 extended up to 16 and 32 CSI-RS antenna ports, extended parts are illustrated in Table 2 below.

TABLE 2
An exemplary embodiment of a CSI-RS configuration
extended according to Method M130

| | | Number of CSI reference signals | | | |
|---|---|---|---|---|---|
| | | configured | | | |
| | CSI-RS | 16 | | 32 | |
| | configuration | (k′, l′) | nₛ mod 2 | (k′, l′) | nₛ mod 2 |
| Frame structure | 0 | 9 and 5 | 0 | 9 and 5 | 0 |
| types 1 and 2 | 1 | 11, 2 | 1 | | |

In accordance with the characteristic, if a base station tries to change the number of CSI-RS antenna ports configured in a terminal, an unnecessary change of a CSI-RS configuration index may be omitted. The exemplary embodiments illustrated in FIGS. 12 to 15 are only some of various exemplary embodiments to which the principle of Method M130 may be applied.

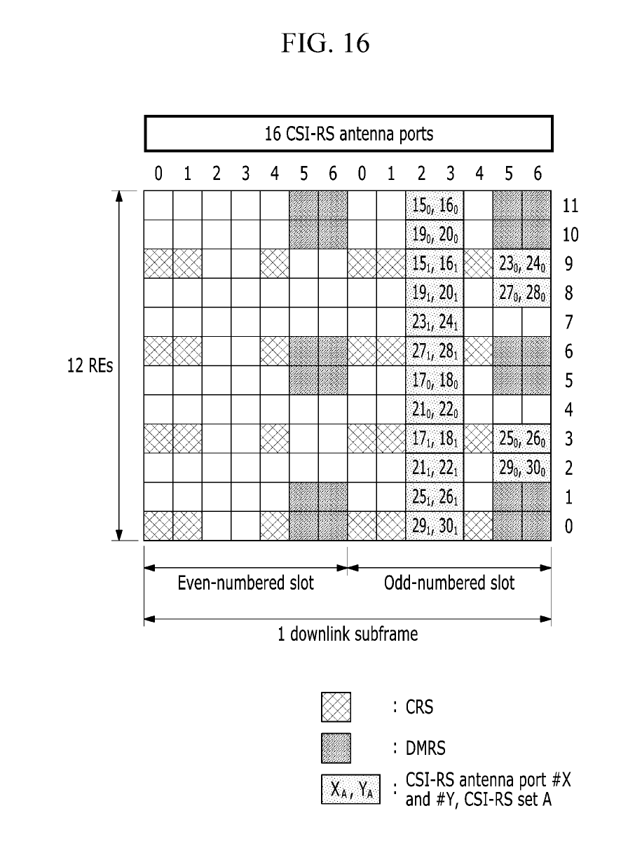

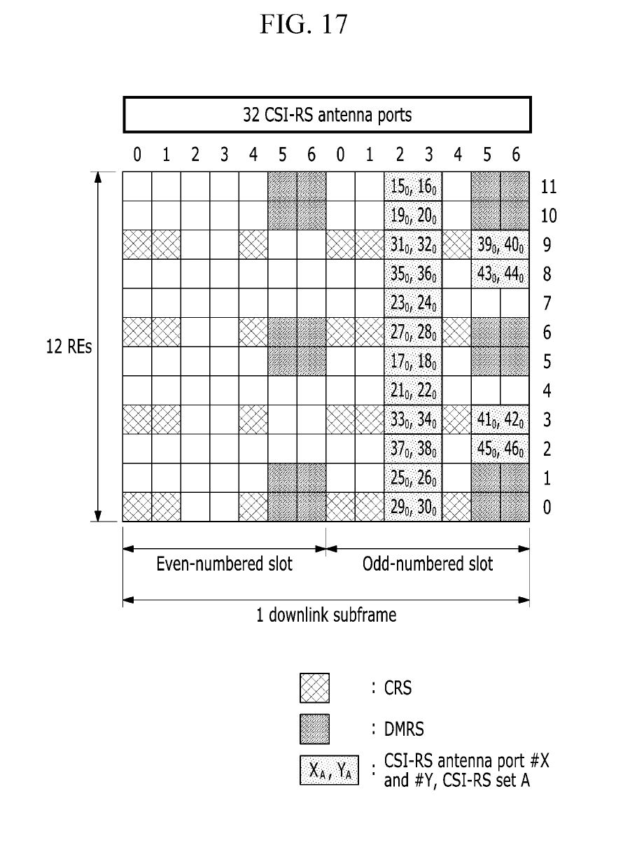

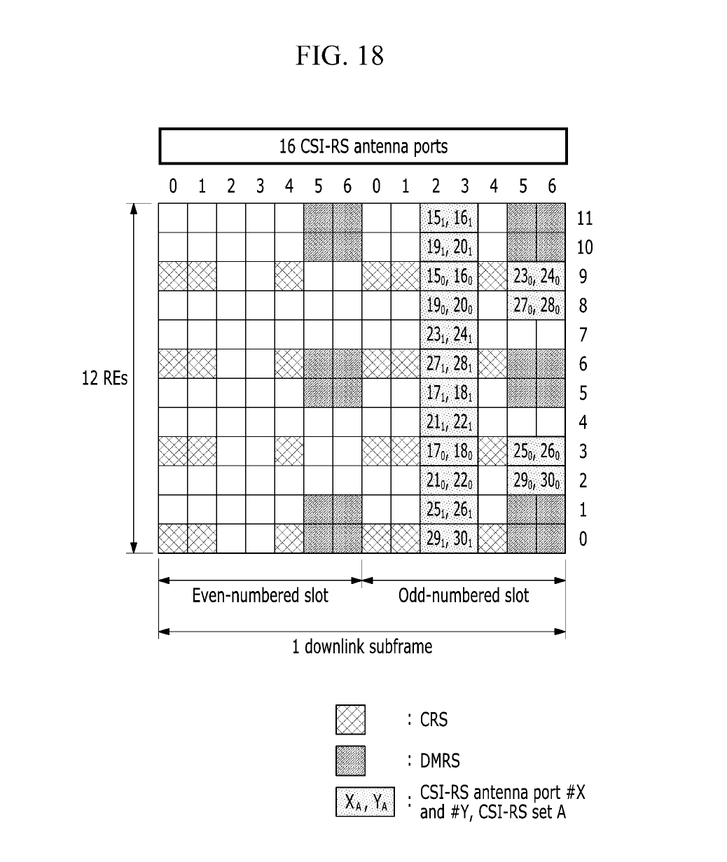

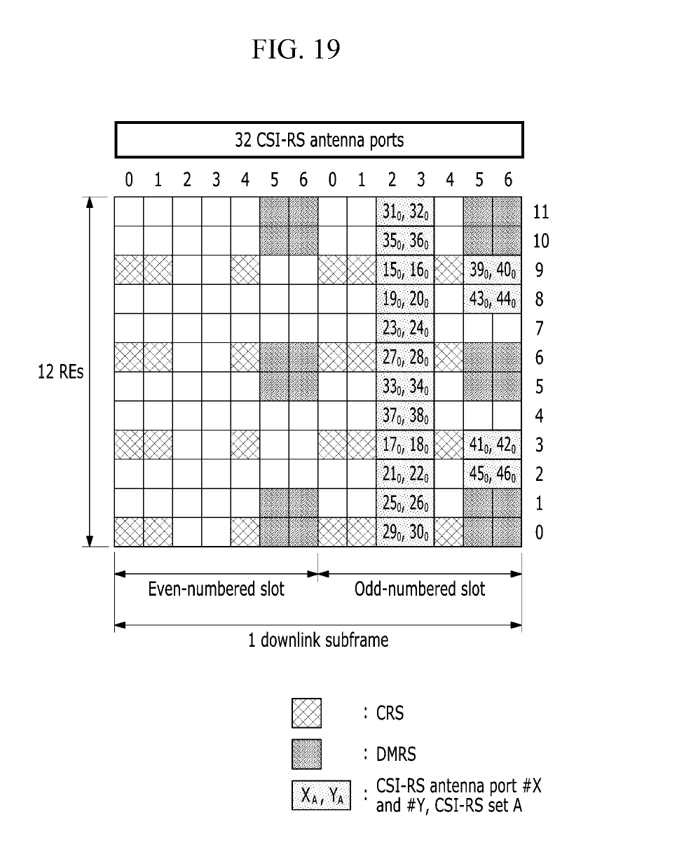

A method of designing an RE set so that a difference between points of time at which CSI-RS antenna ports are transmitted is minimized may be applied to Method M130. FIGS. 16 to 19 are exemplary embodiments of such a method. FIG. 16 is a diagram showing yet another embodiment of a resource configuration for 16 CSI-RS antenna ports according to Method M130. FIG. 17 is a diagram showing yet another embodiment of a resource configuration for 32 CSI-RS antenna ports according to Method M130. FIG. 18 is a diagram showing still yet another embodiment of a resource configuration for 16 CSI-RS antenna ports according to Method M130. FIG. 19 is a diagram showing still yet another embodiment of a resource configuration for 32 CSI-RS antenna ports according to Method M130.

In the exemplary embodiments illustrated in FIGS. 16 to 19, a maximum interval between REs forming a single CSI-RS pattern in a time axis is 4 OFDM symbols. In this case, CSI measurement accuracy of a terminal can be improved that much because the maximum interval is smaller by 1 than that of the exemplary embodiments illustrated in FIGS. 12 to 15. In contrast, the exemplary embodiments illustrated in FIGS. 16 to 19 do not have a nested structure within the same CSI-RS configuration index, that is, the characteristic of the exemplary embodiments illustrated in FIGS. 12 to 15. In particular, in the exemplary embodiment illustrated in FIG. 18, an additional characteristic is that the TDM-based CSI-RS pattern illustrated in FIG. 10 is included.

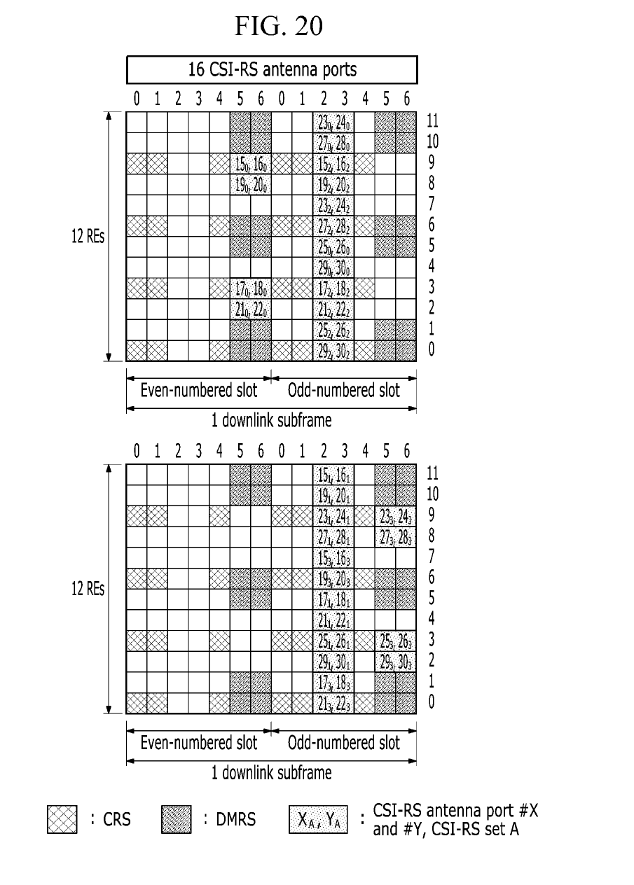

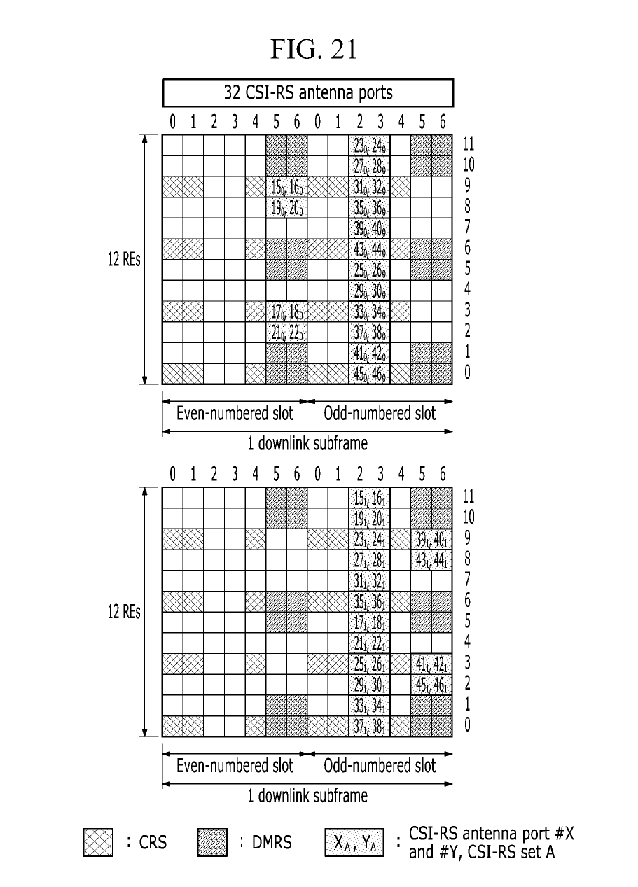

In accordance with the exemplary embodiments of FIGS. 12 to 19, the number of CSI-RS configurations or CSI-RS RE sets which may be configured in a single subframe is 2 if the number of CSI-RS antenna ports is 16 and 1 if the number of CSI-RS antenna ports is 32. A method of allowing a resource overlap between CSI-RS RE sets and also configuring a larger number of CSI-RS configurations or CSI-RS RE sets within a single subframe may be applied to Method M130. FIGS. 20 and 21 are exemplary embodiments of such a method. FIG. 20 is a diagram showing yet another embodiment of a resource configuration for 16 CSI-RS antenna ports according to Method M130. Specifically, FIG. 20 illustrates that 4 different CSI-RS configuration Nos. 0-3 have been defined if the number of CSI-RS antenna ports is 16. For example, CSI-RS antenna port Nos. 23 and 24 for a CSI-RS configuration No. 0 and CSI-RS antenna port Nos. 15 and 16 for a CSI-RS configuration No. 1 may be mapped to the RE (11, 2) and RE (11, 3) of a second time slot.

FIG. 21 is a diagram showing yet another embodiment of a resource configuration for 32 CSI-RS antenna ports according to Method M130. Specifically, FIG. 21 illustrates that two different CSI-RS configuration Nos. 0 and 1 have been defined if the number of CSI-RS antenna ports is 32. For example, CSI-RS antenna port Nos. 27 and 28 for a CSI-RS configuration No. 0 and CSI-RS antenna port Nos. 19 and 20 for a CSI-RS configuration No. 1 may be mapped to the RE (10, 2) and RE (10, 3) of a second time slot.

CDM using OCC having a length of 2 is applied to the methods described so far for each CSI-RS antenna port part sharing the same RE. A method of extending a CSI-RS pattern using CDM based on OCC having a longer length is described below.

A method of extending a CSI-RS pattern using CDM (hereinafter referred to as “Method M140”) is described.

Method M140 is a method of multiplexing antenna ports using OCC having a longer length than an existing length-2 Walsh code while using an existing CSI-RS resource pool in the same manner. In this case, a method of extending a CSI-RS pattern includes a method of extending a CSI-RS pattern in a time axis and a method of extending a CSI-RS pattern in a frequency axis. In Method M140, a case where the length of OCC is 4 may be basically taken into consideration. If CSI-RS power boost according to the application of FDM is problematic, OCC having a length of 8 may be taken into consideration.

Length-4 Walsh code ([1 1 1 1], [1 −1 1 −1], [1 1 −1 −1], [1 −1 −1 1]) may be taken into consideration as length-4 OCC. Furthermore, length-8 Walsh code ([1 1 1 1 1 1 1 1], [1−1 1 −1 1 −1 1 −1], [1 1 −1 −1 1 1 −1 −1], [1 −1 −1 1 1 −1 −1 1], [1 1 1 1 −1 −1 −1 −1], [1 −1 1 −1 −1 1 −1 1], [1 1 −1 −1 −1 −1 1 1], [1 −1 −1 1 −1 1 1 −1]) may be taken into consideration as length-8 OCC. In accordance with Method M140, although one-to-one mapping is used as antenna port virtualization, the CSI-RS transmission power reduction problem of Method M110 or the CSI-RS power boost problem of Method M120 is not generated. In contrast, if channel responses between REs to which OCC has been applied are different, orthogonality between codes may not be guaranteed. Accordingly, channel estimation performance of a terminal may be degraded.

A method of extending a CSI-RS pattern in a frequency axis using length-4 Walsh code (hereinafter referred to as “Method M141”) is described below.

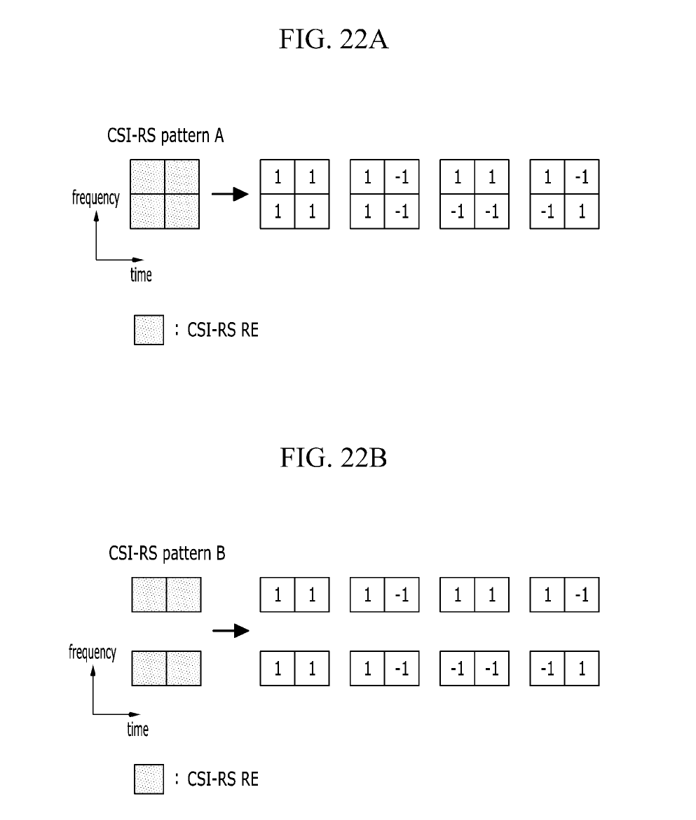

FIGS. 22A and 22B are diagrams showing exemplary embodiments in which length-4 OCC has been applied to REs.

Method M141 is a method of applying the length-4 Walsh code to CSI-RS REs disposed in a quadrangle form in a time-frequency axis as illustrated in FIGS. 22A and 22B. In this case, all 4 REs to which OCC has been applied are contiguous (FIG. 22A) or are placed at relatively close locations (FIG. 22B), thereby being capable of minimizing the degradation of channel estimation performance compared to the existing length-2 OCC.

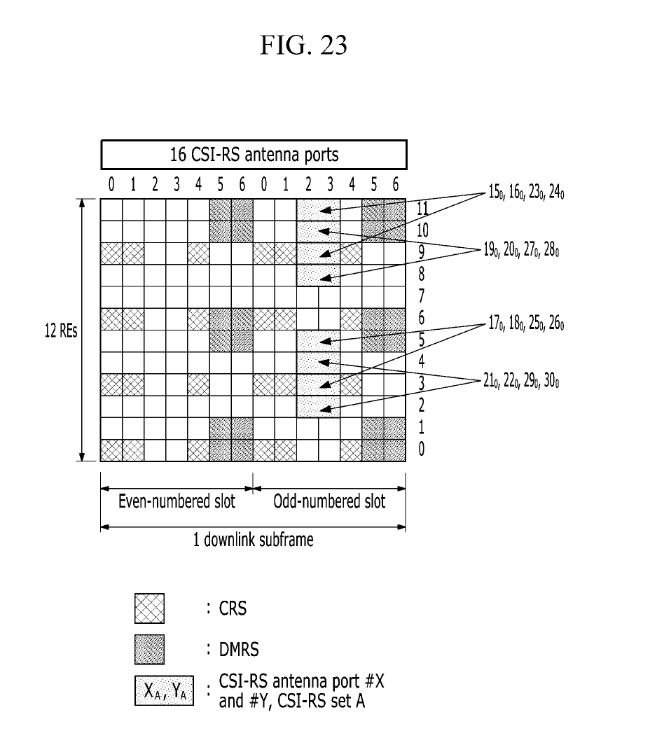

FIG. 23 is a diagram showing an embodiment of a resource configuration for 16 CSI-RS antenna ports according to Method M141. For example, CSI-RS antenna port Nos. 15, 16 and 23, 24 for a CSI-RS configuration No. 0 are mapped to the RE (11, 2), RE (11, 3), RE (9, 2), and RE (9, 3) of a second time slot. That is, the CSI-RS antenna port Nos. 15, 16 and 23, 24 for the CSI-RS configuration No. 0 share four REs. CDM using length-4 OCC is applied to the CSI-RS antenna port Nos. 15, 16 and 23, 24 for the CSI-RS configuration No. 0.

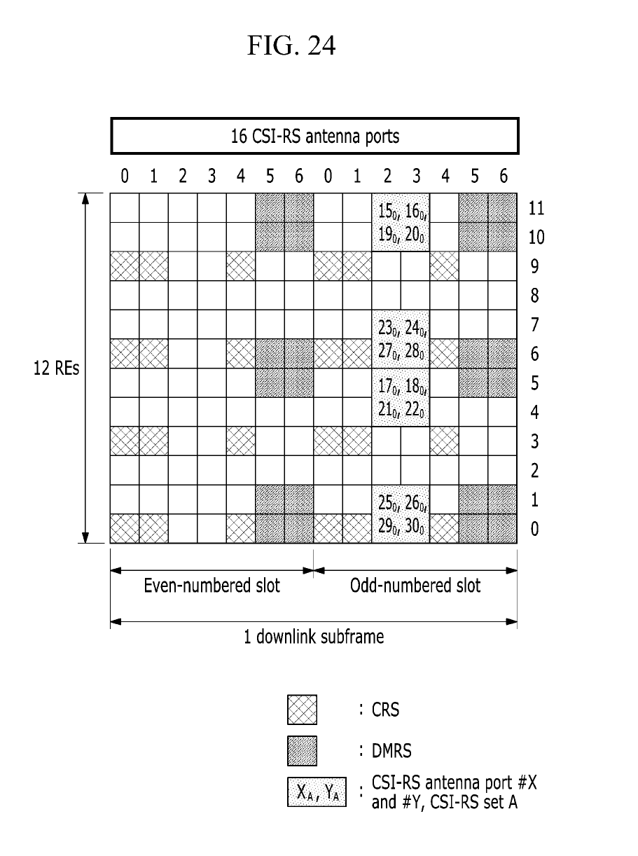

FIG. 24 is a diagram showing another embodiment of a resource configuration for 16 CSI-RS antenna ports according to Method M141. For example, CSI-RS antenna port Nos. 15, 16 and 19, 20 for the CSI-RS configuration No. 0 are mapped to the RE (10, 2), RE (10, 3), RE (11, 2), and RE (11, 3) of the second time slot. That is, the CSI-RS antenna port Nos. 15, 16 and 19, 20 for the CSI-RS configuration No. 0 share 4 REs. CDM using length-4 OCC is applied to the CSI-RS antenna port Nos. 15, 16 and 19, 20 for the CSI-RS configuration No. 0.

A method of extending a CSI-RS pattern in a time axis using the length-4 Walsh code (hereinafter referred to as “Method M142”) is described below.

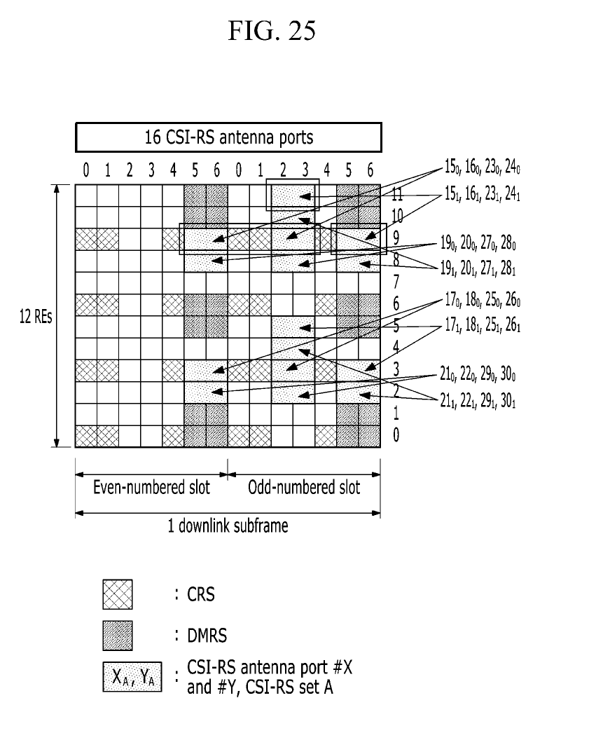

Method M142 is a method of extending existing time-axis length-2 CDM by twice in a time axis. FIG. 25 is an exemplary embodiment of Method M142. Specifically, FIG. 25 is a diagram showing an exemplary embodiment of a CSI-RS configuration for 16 CSI-RS antenna ports according to Method M142. For example, CSI-RS antenna port Nos. 15, 16 and 23, 24 for a CSI-RS configuration No. 0 are mapped to the RE (9, 5) and RE (9, 6) of a first time slot and the RE (9, 2) and RE (9, 3) of a second time slot. That is, the CSI-RS antenna port Nos. 15, 16 and 23, 24 for the CSI-RS configuration No. 0 share 4 REs. CDM using length-4 OCC is applied to the CSI-RS antenna port Nos. 15, 16 and 23, 24 for the CSI-RS configuration No. 0. For another example, the CSI-RS antenna port Nos. 15, 16 and 23, 24 for the CSI-RS configuration No. 1 are mapped to the RE (11, 2), RE (11, 3), RE (9, 5), and RE (9, 6) of the second time slot. That is, the CSI-RS antenna port Nos. 15, 16 and 23, 24 for the CSI-RS configuration No. 1 share 4 REs, and CDM using length-4 OCC is applied to the CSI-RS antenna port Nos. 15, 16 and 23, 24 for the CSI-RS configuration No. 1.

A method of extending a CSI-RS pattern in a time axis using TDM and replacing some of existing FDM with CDM using the length-4 Walsh code (hereinafter referred to as “Method M143”) is described below.

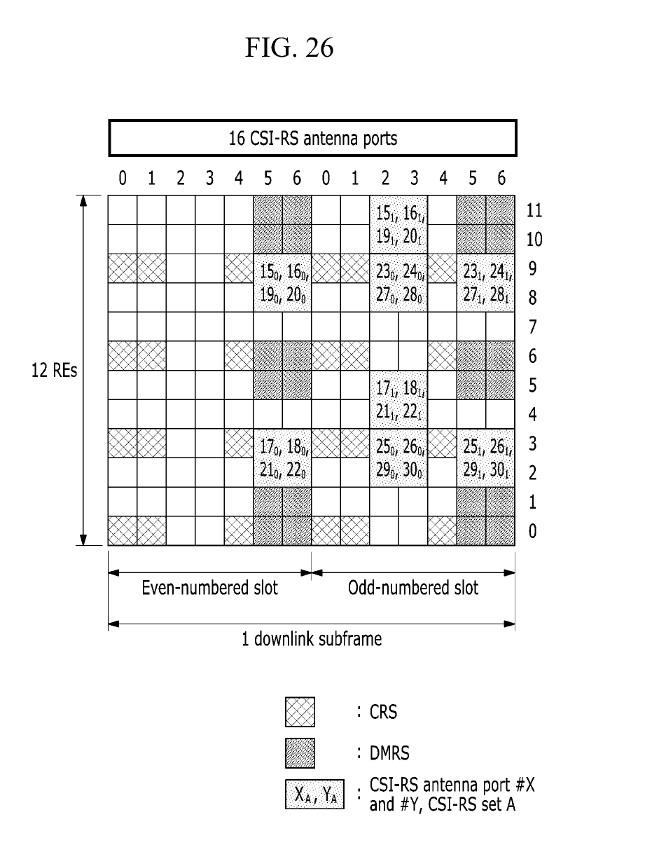

Method M143 is a method of extending a CSI-RS pattern in a time axis according to Method M120 and simultaneously applying length-4 CDM in a time and frequency axis according to Method M143. In accordance with Method M143, CDM is newly applied to some CSI-RS antenna ports differentiated by FDM. FIG. 26 is an exemplary embodiment of Method M143. Specifically, FIG. 26 is a diagram showing an exemplary embodiment of a CSI-RS configuration for 16 CSI-RS antenna ports according to Method M143. For example, in an existing CSI-RS pattern (e.g., the exemplary embodiment of FIG. 3) for 8 CSI-RS antenna ports, FDM has been applied between CSI-RS antenna port Nos. 15 and 16 and CSI-RS antenna port Nos. 19 and 20. In contrast, in the exemplary embodiment of FIG. 26, CDM is applied to multiplexing between the CSI-RS antenna port Nos. 15, 16 and 19, 20.

In the exemplary embodiments illustrated in FIGS. 23 to 26, OCC applied to each CSI-RS antenna port is listed in Table 3 and Table 4 below. Specifically, the exemplary embodiments of FIGS. 23 and 25 comply with Table 3, and the exemplary embodiments of FIGS. 24 and 26 comply with Table 4.

TABLE 3
Exemplary embodiment of mapping between
length-4 OCC and CSI-RS antenna port

| OCC | CSI-RS antenna port |
|---|---|
| [1 1 1 1] | {15, 17, 19, 21} |
| [1 −1 1 −1] | {16, 18, 20, 22} |
| [1 1 −1 −1] | {23, 25, 27, 29} |
| [1 −1 −1 1] | {24, 26, 28, 30} |

TABLE 4
Another exemplary embodiment of mapping between
length-4 OCC and CSI-RS antenna port

| OCC | CSI-RS antenna port |
|---|---|
| [1 1 1 1] | {15, 17, 23, 25} |
| [1 −1 1 −1] | {16, 18, 24, 26} |
| [1 1 −1 −1] | {19, 21, 27, 29} |
| [1 −1 −1 1] | {20, 22, 28, 30} |

A method in which a CSI-RS pattern according to Method M141 and a CSI-RS pattern according to Method M143 coexist in a single subframe (hereinafter referred to as “Method M144”) is described below.

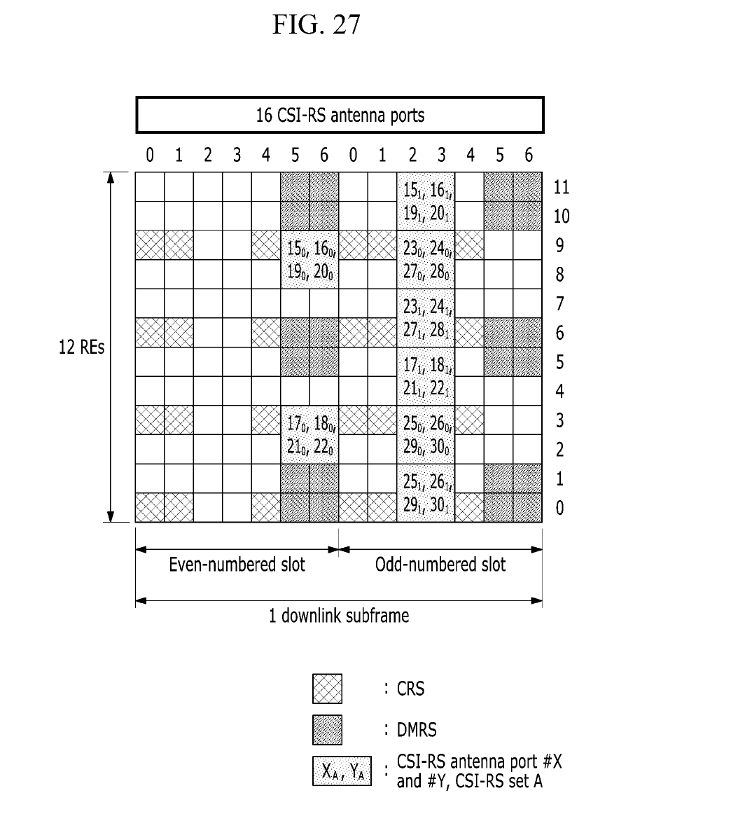

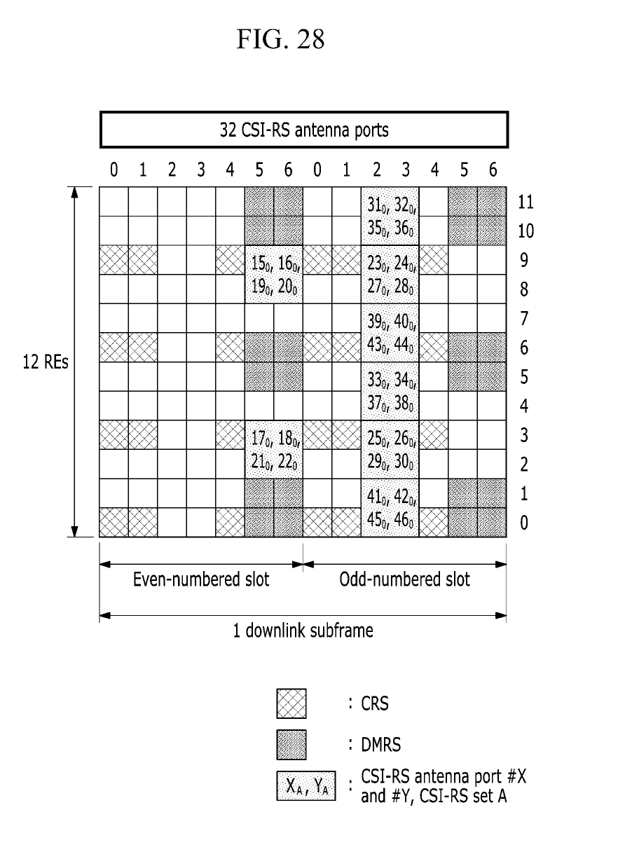

FIGS. 27 and 28 are exemplary embodiments of Method M144. Specifically, FIG. 27 is a diagram showing an exemplary embodiment of a CSI-RS configuration for 16 CSI-RS antenna ports according to Method M144, and FIG. 28 is a diagram showing an exemplary embodiment of a CSI-RS configuration for 32 CSI-RS antenna ports according to Method M144.

FIG. 27 illustrates an example in which a CSI-RS pattern according to Method M143 has been applied to a CSI-RS configuration No. 0 and a CSI-RS pattern according to Method M141 has been applied to a CSI-RS configuration No. 1.

FIG. 28 illustrates an example in which a CSI-RS pattern in which all of TDM, FDM, and CDM have been combined has been applied to a CSI-RS configuration No. 0. For example, CDM is applied between CSI-RS antenna port Nos. 15, 16 and 19, 20, TDM is applied between CSI-RS antenna port Nos. 15, 16 and 19, 20 and CSI-RS antenna port Nos. 23, 24 and 27, 28, and FDM is applied between CSI-RS antenna port Nos. 31, 32 and 35, 36 and CSI-RS antenna port Nos. 23, 24 and 27, 28.

In the exemplary embodiment illustrated in FIGS. 27 and 28, OCC applied to each CSI-RS antenna port is listed in Table 5 below.

TABLE 5
Yet another exemplary embodiment of mapping
between length-4 OCC and CSI-RS antenna port

| OCC | CSI-RS antenna port |
|---|---|
| [1 1 1 1] | {15, 17, 23, 25, 31, 33, 39, 41} |
| [1 −1 1 −1] | {16, 18, 24, 26, 32, 34, 40, 42} |
| [1 1 −1 −1] | {19, 21, 27, 29, 35, 37, 43, 45} |
| [1 −1 −1 1] | {20, 22, 28, 30, 36, 38, 44, 46} |

If some of CSI-RS resources configured by Method M140 and detailed methods Methods M141-M144 of Method M140 are to be shared by legacy terminals, CSI-RS reception performance of the legacy terminals may be influenced because the legacy terminals do not have the ability to differentiate the length-4 Walsh code. For example, it is assumed that a base station has configured the CSI-RS pattern illustrated in FIG. 23 in a new terminal according to Method M141 and configured 8 CSI-RS antenna ports and a CSI-RS configuration No. 1 in a legacy terminal. In this case, the legacy terminal expects that it will receive CSI-RS antenna port Nos. 15 and 16 in the RE (11, 2) and RE (11, 3) of a second time slot, but actually receives the CSI-RS antenna port Nos. 15 and 16 to which CSI-RS antenna port Nos. 15, 16 and 23, 24 have been added. As a result, the legacy terminal is unable to distinguish the CSI-RS antenna port Nos. 15 and 16 from the received 4 CSI-RS antenna ports. The legacy terminal receives a channel response added to the CSI-RS antenna port Nos. 15 and 23 instead of the channel response of the CSI-RS antenna port No. 15 corresponding to Walsh code[1 1], and receives a channel response added to the CSI-RS antenna port Nos. 16 and 24 instead of the channel response of the CSI-RS antenna port No. 16 corresponding to Walsh code[1 −1]. Likewise, as in the CSI-RS antenna port Nos. 19 and 20, the legacy terminal receives the channel response sum of the CSI-RS antenna port No. 19 and the CSI-RS antenna port No. 27 in the place of the CSI-RS antenna port No. 19, and receives the channel response sum of the CSI-RS antenna port No. 20 and the CSI-RS antenna No. 28 in the place of the CSI-RS antenna port No. 20. That is, the legacy terminal measures a valid channel response to which the two CSI-RS antenna port pairs have been added and reports the measurement to the base station. In this case, the base station is aware that CSI reported by the legacy terminal is about a valid channel response and thus may perform scheduling by taking into consideration the fact. As a result, in accordance with Method M140 or the detailed methods of Methods M140, although a nested structure is fully satisfied as in Method M110 and Method M130, the base station may transmit a CSI-RS using common resources for the new terminal and the legacy terminal.

A method of extending a CSI-RS pattern in a frequency axis using the length-8 Walsh code (hereinafter referred to as “Method 145”) is described below.

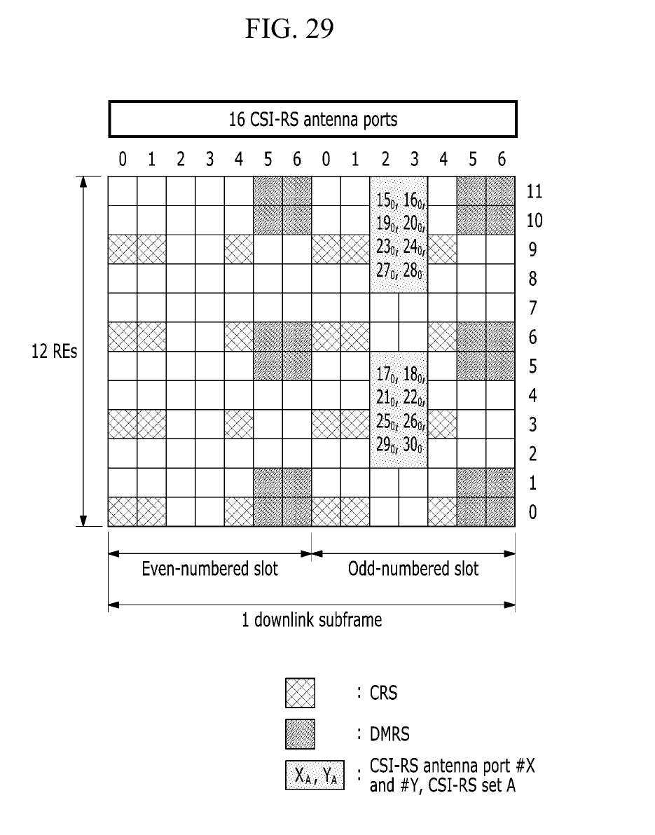

FIG. 29 is a diagram showing an embodiment of a resource configuration for 16 CSI-RS antenna ports according to Method M145. For example, CSI-RS antenna port Nos. 15, 16, 19, 20, 23, 24, 27, and 28 for a CSI-RS configuration No. 0 are mapped to the RE (11, 2), RE (11, 3), RE (10, 2), RE (10, 3), RE (9, 2), RE (9, 3), RE (8, 2), and RE (8, 3) of a second time slot. That is, the CSI-RS antenna port Nos. 15, 16, 19, 20, 23, 24, 27, and 28 for the CSI-RS configuration No. 0 share 8 REs, and CDM using length-8 OCC is applied to the CSI-RS antenna port Nos. 15, 16, 19, 20, 23, 24, 27, and 28 for the CSI-RS configuration No. 0.

In the exemplary embodiment illustrated in FIG. 29, a maximum interval between REs to which the length-8 Walsh code is applied in a frequency axis is two OFDM symbols. In the case of an existing CSI-RS pattern for 8 CSI-RS antenna ports, 4 different CSI-RS antenna ports are multiplexed through FDM. In contrast, in the exemplary embodiment of FIG. 29, 2 different CSI-RS antenna ports are multiplexed through FDM, and the remaining CSI-RS antenna ports are multiplexed through CDM. Accordingly, a maximum of 3 dB of CSI-RS power boost may be required.

A method of extending a CSI-RS pattern using the length-8 Walsh code in a time axis and frequency axis (hereinafter referred to as “Method M146”) is described below.

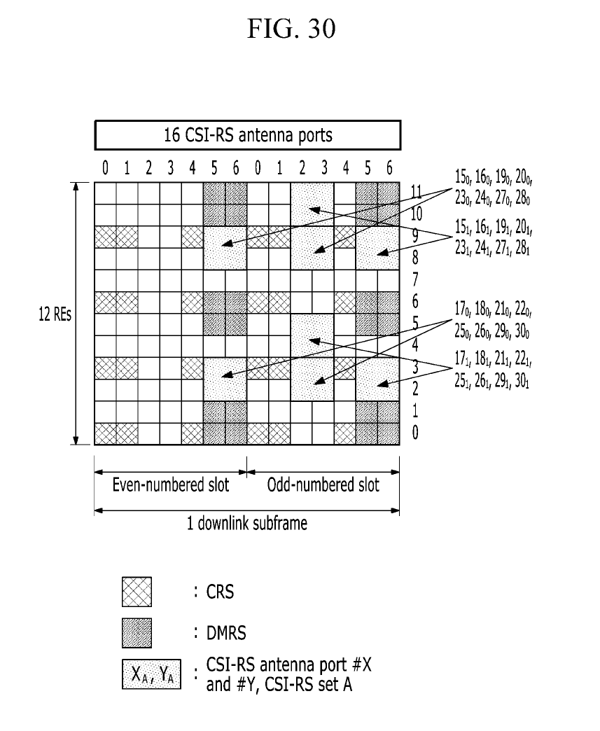

FIG. 30 is a diagram showing an embodiment of a resource configuration for 16 CSI-RS antenna ports according to Method M146.

Method M146 is a method of extending existing length-2 CDM in a time axis and frequency axis every two times and applying length-8 CDM to 8 REs. For example, CSI-RS antenna port Nos. 15, 16, 19, 20, 23, 24, 27, and 28 for a CSI-RS configuration No. 0 are mapped to the RE (9, 5), RE (9, 6), RE (8, 5), and RE (8, 6) of a first time slot and the RE (9, 2), RE (9, 3), RE (8, 2), and RE (8, 3) of a second time slot. That is, the CSI-RS antenna port Nos. 15, 16, 19, 20, 23, 24, 27, and 28 for the CSI-RS configuration No. 0 share 8 REs, and length-8 CDM is applied to the CSI-RS antenna port Nos. 15, 16, 19, 20, 23, 24, 27, and 28 for the CSI-RS configuration No. 0.

In accordance with the exemplary embodiment illustrated in FIG. 30, as in the exemplary embodiment illustrated in FIG. 29, maximum CSI-RS power boost is reduced from existing 6 dB to 3 dB.

In the exemplary embodiments of FIGS. 29 and 30, OCC applied to each CSI-RS antenna port complies with Table 6 below.

TABLE 6
Exemplary embodiment of mapping between
length-8 OCC and CSI-RS antenna ports

| OCC | CSI-RS antenna port |
|---|---|
| [1 1 1 1 1 1 1 1] | {15, 17} |
| [1 −1 1 −1 1 −1 1 −1] | {16, 18} |
| [1 1 −1 −1 1 1 −1 −1] | {19, 21} |
| [1 −1 −1 1 1 −1 −1 1] | {20, 22} |
| [1 1 1 1 −1 −1 −1 −1] | {23, 25} |
| [1 −1 1 −1 −1 1 −1 1] | {24, 26} |
| [1 1 −1 −1 −1 −1 1 1] | {27, 29} |
| [1 −1 −1 1 −1 1 1 −1] | {28, 30} |

A method of extending a CSI-RS pattern using TDM or FDM and replacing existing FDM with CDM using the length-8 Walsh code (hereinafter referred to as “Method M147”) is described below.

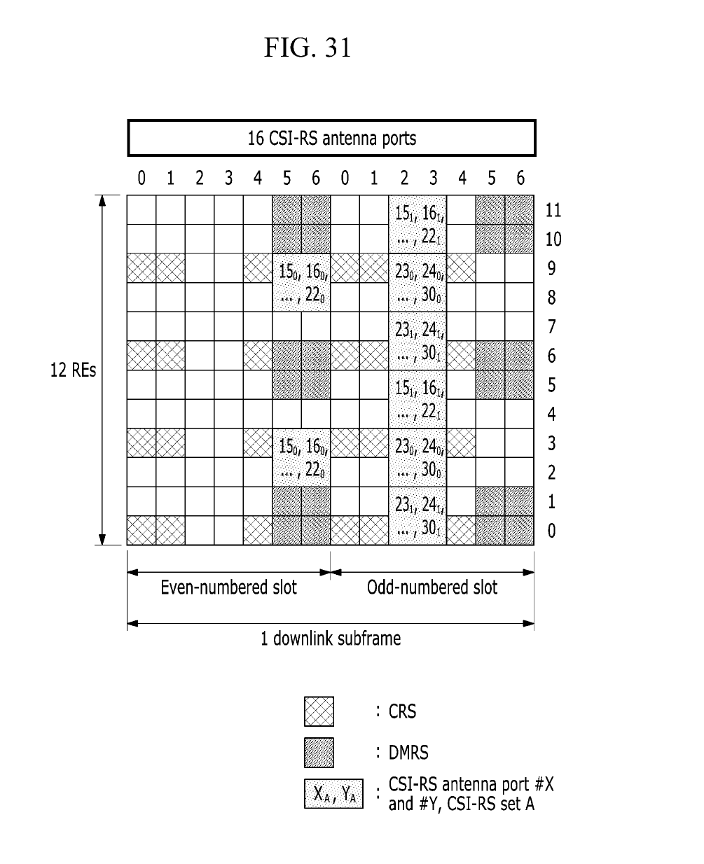

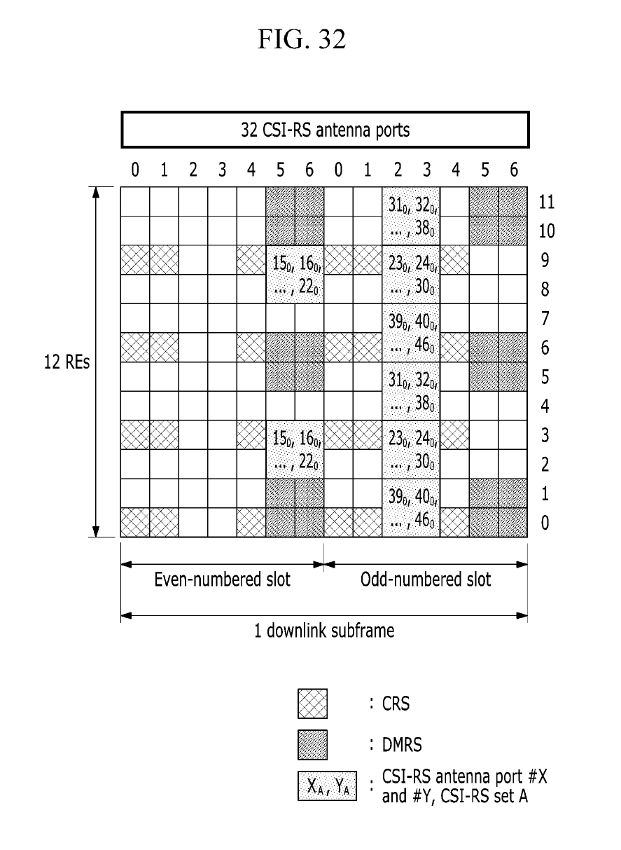

Method M147 is a method of extending a CSI-RS pattern in a frequency axis or time axis according to Method M110 or Method M120, and also applying length-8 CDM in the time axis and frequency axis according to Method M145. FIGS. 31 and 32 are exemplary embodiments of Method M147.

FIG. 31 is a diagram showing an embodiment of a resource configuration for 16 CSI-RS antenna ports according to Method M147. For example, CSI-RS antenna port Nos. 15-22 of 16 CSI-RS antenna ports for a CSI-RS configuration No. 0 are mapped to the RE (9, 5), RE (9, 6), RE (8, 5), RE (8, 6), RE (3, 5), RE (3, 6), RE (2, 5), and RE (2, 6) of a first time slot. That is, the CSI-RS antenna port Nos. 15-22 for the CSI-RS configuration No. 0 share 8 REs, and length-8 CDM is applied to the CSI-RS antenna port Nos. 15-22 for the CSI-RS configuration No. 0.

FIG. 32 is a diagram showing an embodiment of a resource configuration for 32 CSI-RS antenna ports according to Method M147. For example, CSI-RS antenna port Nos. 15-22 of 32 CSI-RS antenna ports for a CSI-RS configuration No. 0 are mapped to the RE (9, 5), RE (9, 6), RE (8, 5), RE (8, 6), RE (3, 5), RE (3, 6), RE (2, 5), and RE (2, 6) of a first time slot. That is, the CSI-RS antenna port Nos. 15-22 for the CSI-RS configuration No. 0 share 8 REs, and length-8 CDM is applied to the CSI-RS antenna port Nos. 15-22 for the CSI-RS configuration No. 0.

In the exemplary embodiments of FIGS. 31 and 32, OCC applied to each CSI-RS antenna port may comply with Table 7 below.

TABLE 7
Another exemplary embodiment of mapping between
length-8 OCC and CSI-RS antenna ports

| OCC | CSI-RS antenna port |
|---|---|
| [1 1 1 1 1 1 1 1] | {15, 23, 31, 39} |
| [1 −1 1 −1 1 −1 1 −1] | {16, 24, 32, 40} |
| [1 1 −1 −1 1 1 −1 −1] | {19, 27, 35, 43} |
| [1 −1 −1 1 1 −1 −1 1] | {20, 28, 36, 44} |
| [1 1 1 1 −1 −1 −1 −1] | {17, 25, 33, 41} |
| [1 −1 1 −1 −1 1 −1 1] | {18, 26, 34, 42} |
| [1 1 −1 −1 −1 −1 1 1] | {21, 29, 37, 45} |
| [1 −1 −1 1 −1 1 1 −1] | {22, 30, 38, 46} |

A method in which a CSI-RS pattern according to Method M145 and a CSI-RS pattern according to Method M147 coexist in a single subframe (hereinafter referred to as “Method M148”) is described below.

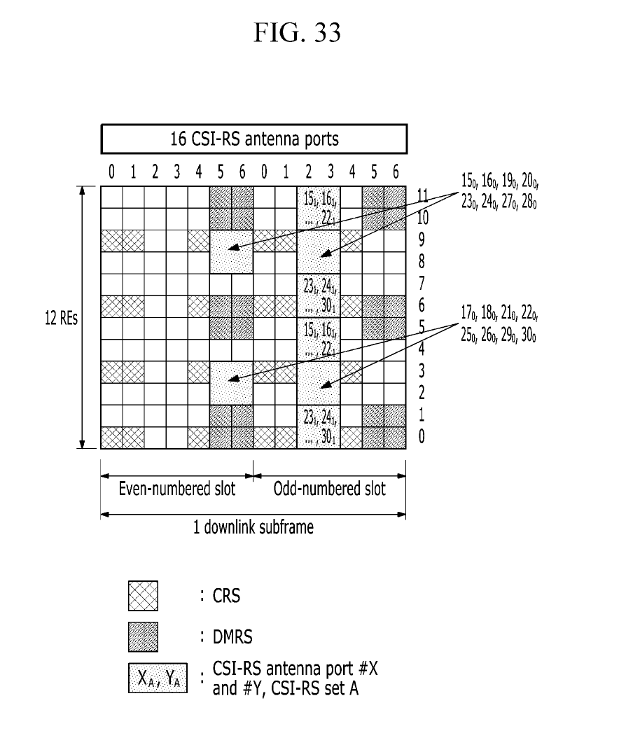

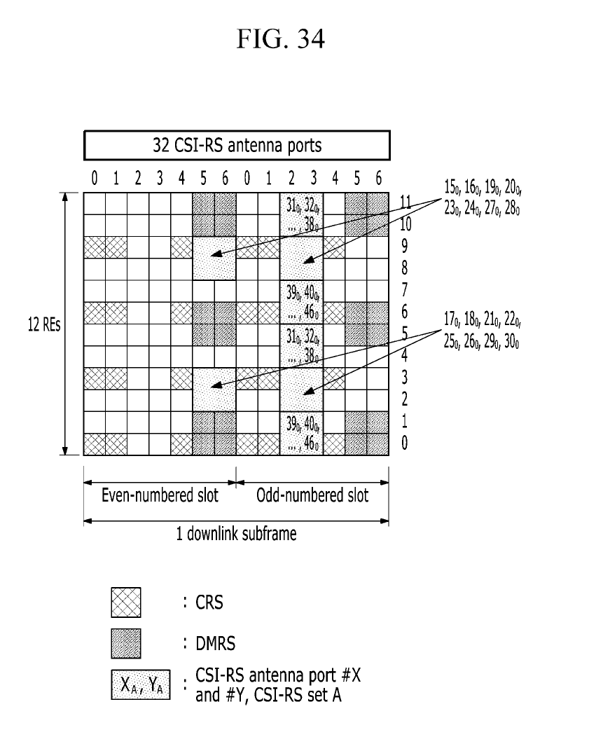

FIGS. 33 and 34 are exemplary embodiments of Method M148.

FIG. 33 is a diagram showing an embodiment of a resource configuration for 16 CSI-RS antenna ports according to Method M148. Specifically, FIG. 33 shows an example in which a CSI-RS pattern according to Method M145 has been applied to a CSI-RS configuration No. 0 and a CSI-RS pattern according to Method M147 has been applied to a CSI-RS configuration No. 1. For example, CSI-RS antenna port Nos. 15, 16, 19, 20, 23, 24, 27, and 28 of 16 CSI-RS antenna ports for a CSI-RS configuration No. 0 are mapped to the RE (9, 5), RE (9, 6), RE (8, 5), and RE (8, 6) of a first time slot and the RE (9, 2), RE (9, 3), RE (8, 2), and RE (8, 3) of a second time slot. That is, the CSI-RS antenna port Nos. 15, 16, 19, 20, 23, 24, 27, and 28 for the CSI-RS configuration No. 0 share 8 REs, and length-8 CDM is applied to the CSI-RS antenna port Nos. 15, 16, 19, 20, 23, 24, 27, and 28 for the CSI-RS configuration No. 0. For another example, CSI-RS antenna port Nos. 15-22 of 16 CSI-RS antenna ports for a CSI-RS configuration No. 1 are mapped to the RE (11, 2), RE (11, 3), RE (10, 2), RE (10, 3), RE (5, 2), RE (5, 3), RE (4, 2), and RE (4, 3) of the second time slot. That is, the CSI-RS antenna port Nos. 15-22 for the CSI-RS configuration No. 1 share 8 REs, and length-8 CDM is applied to the CSI-RS antenna port Nos. 15-22 for the CSI-RS configuration No. 1.

FIG. 34 is a diagram showing an embodiment of a resource configuration for 32 CSI-RS antenna ports according to Method M148. Specifically, in the exemplary embodiment of FIG. 34, both the principles of Method M145 and Method M147 are applied to a CSI-RS pattern for a CSI-RS configuration No. 0.

In the exemplary embodiments of FIGS. 33 and 34, OCC applied to each CSI-RS antenna port may comply with Table 7 above.

The exemplary embodiments of FIGS. 22 to 34 are some examples to which the principles of Method M140 and the detailed methods Methods M141-M148 of Method M140 have been applied. Method M140 and the detailed methods Methods M141-M148 of Method M140 may be implemented in various forms in addition to the exemplary embodiments.

In an FD-MIMO system, in order to support the transmission or a very large number of CSI-RS antenna ports or to avoid inter-cell CSI-RS interference, a method Method M200 of extending a CSI-RS resource pool within a single PRB pair may be required. A method of extending a CSI-RS resource pool and a method of configuring CSI-RS resources corresponding to the method are described below.

A method of adding REs, corresponding to the OFDM symbol Nos. 2 and 3 of a first time slot, to a CSI-RS resource pool (hereinafter referred to as “Method M210”) is described below.

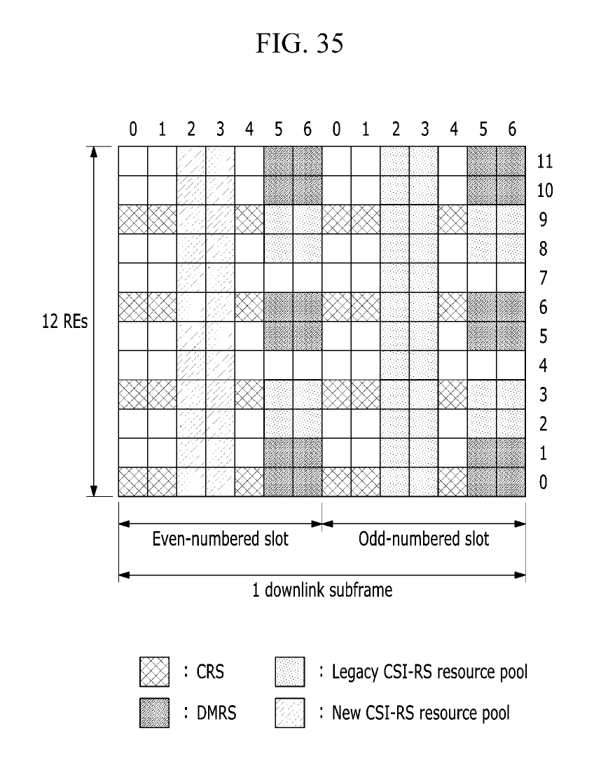

FIG. 35 is a diagram showing an extended CSI-RS resource pool according to Method M210.

Since a total number of REs corresponding to the OFDM symbol Nos. 2 and 3 of a first time slot is 24, a CSI-RS resource pool includes a total of 64 (=40+24) REs as illustrated in FIG. 35 in accordance with Method M210. Accordingly, more various CSI-RS and zero-power (ZP) CSI-RS resource configurations are possible within a single subframe whose resource region has been further widened, and a CSI-RS configuration for 64 CSI-RS antenna ports is possible within a single subframe. The method of configuring CSI-RS resources according to Method M210 may use the principles of the detailed methods Method M110, Method M111, Method M120, Method M121, Method M130, and Methods M140-M148 of Method M100 in the same or similar manner.

If a CSI-RS resource pool is extended according to Method M210, a legacy terminal is unable to recognize a newly added resource pool (i.e., REs corresponding to the OFDM symbol Nos. 2 and 3 of a first time slot) as CSI-RS resources. Accordingly, if a CSI-RS is transmitted in the newly added resource pool, the legacy terminal is unable to perform PDSCH rate matching on the corresponding resources. In this case, a method of bearing some degree of performance degradation in a legacy terminal or a method of scheduling the transmission of a downlink PDSCH to a legacy terminal only in a subframe in which a CSI-RS is not transmitted in a newly added resource pool may be taken into consideration.

A method of extending a CSI-RS pattern using FDM in a CSI-RS resource pool extended according to Method M210 (hereinafter referred to as “Method M211”) is described below.

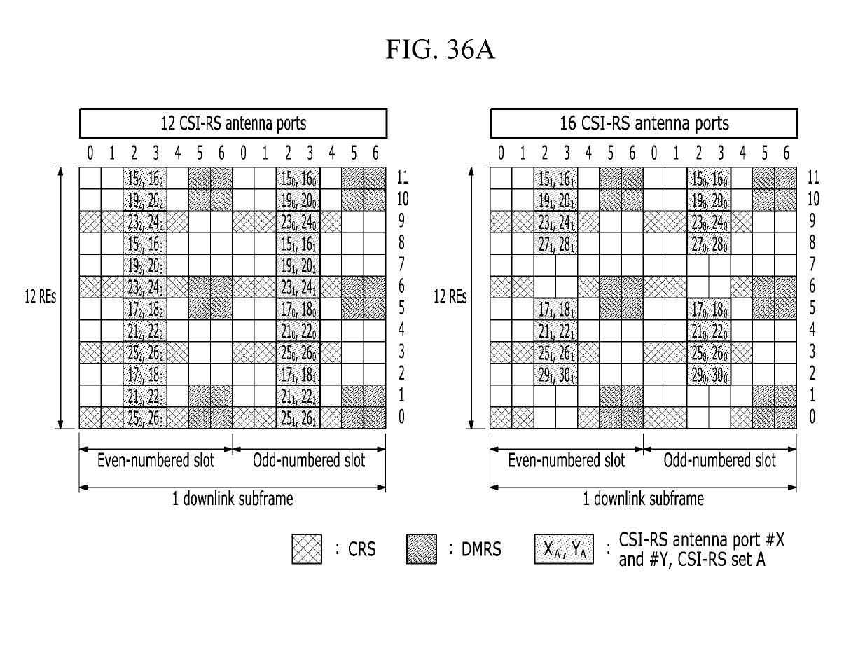

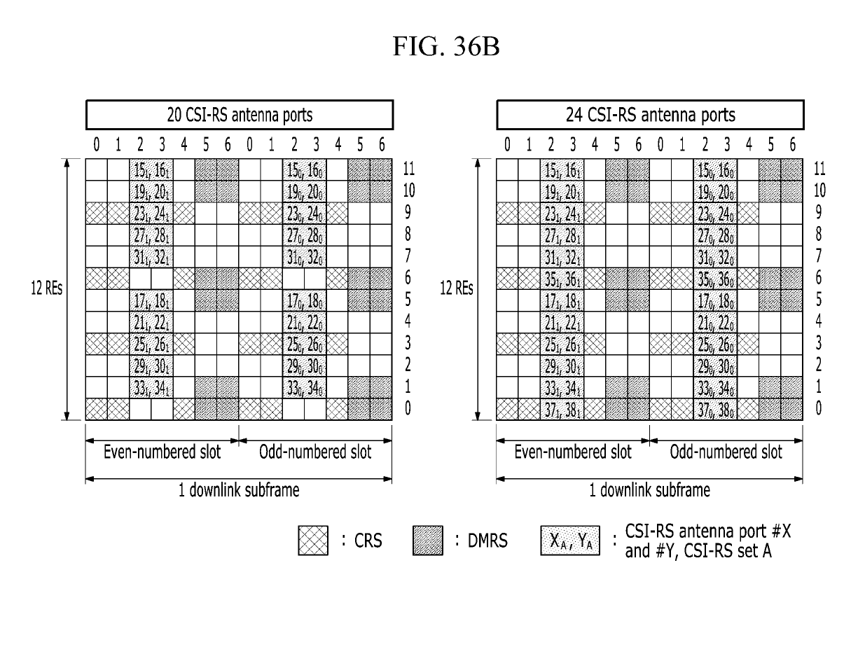

FIGS. 36A and 36B are exemplary embodiments of Method M211. Specifically, FIG. 36A is a diagram showing an exemplary embodiment of a CSI-RS configuration for 12 or 16 CSI-RS antenna ports according to Method M211, and 36B is a diagram showing an exemplary embodiment of a CSI-RS configuration for 20 or 24 CSI-RS antenna ports according to Method M211.

In the exemplary embodiments of FIGS. 36A and 36B, CSI-RS patterns defined in the OFDM symbol Nos. 2 and 3 of the second time slot in the exemplary embodiments of FIGS. 5A and 5B are likewise applied to the OFDM symbol Nos. 2 and 3 of a first time slot. For example, in an exemplary embodiment on the right side of FIG. 36A, CSI-RS antenna port Nos. 15-30 for a CSI-RS configuration No. 0 have been defined in the OFDM symbol Nos. 2 and 3 of a second time slot. CSI-RS antenna port Nos. 15-30 for a CSI-RS configuration No. 1 have been defined in the OFDM symbol Nos. 2 and 3 of a first time slot in the same pattern as that of the CSI-RS configuration No. 0.

Accordingly, in the exemplary embodiments of FIGS. 36A and 36B, CSI-RS RE sets that are two times those in the exemplary embodiments of FIGS. 5A and 5B may be configured in a single subframe. The CSI-RS pattern illustrated in FIG. 5 has been applied to the exemplary embodiments of FIGS. 36A and 36B, but this is only an example. In the CSI-RS resource configuration according to Method M211, other CSI-RS patterns to which the principle of Method M110 has been applied may be used.

A method of extending a CSI-RS pattern using TDM in a CSI-RS resource pool extended according to Method M210 (hereinafter referred to as “Method M212”) is described below.

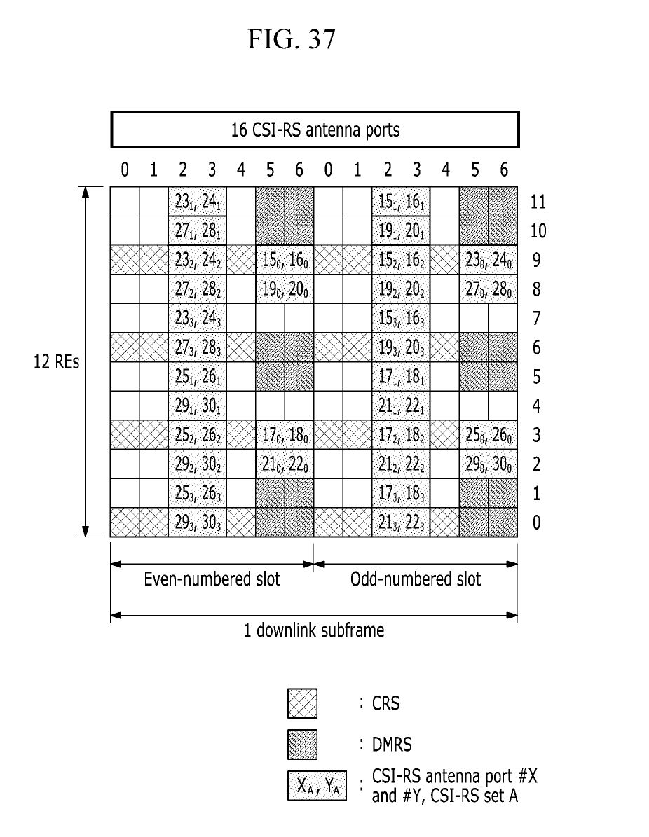

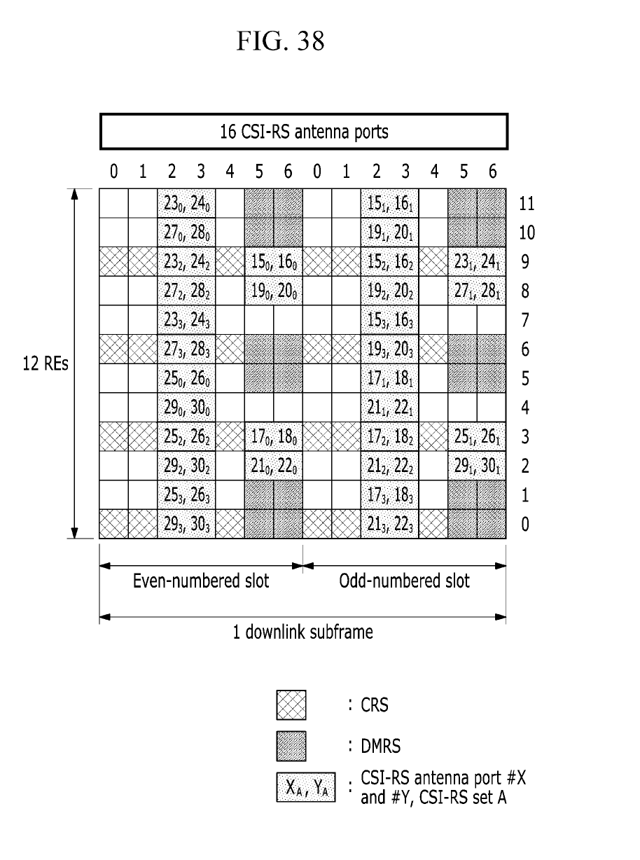

FIGS. 37 and 38 are exemplary embodiments of Method M210. Specifically, FIGS. 37 and 38 are diagrams showing exemplary embodiments of a CSI-RS configuration for 16 CSI-RS antenna ports according to Method M212.

In Method M212, as in Method M211, CSI-RS RE sets that are twice that in the case where an existing CSI-RS resource pool is used may be configured in a single subframe.

In the exemplary embodiment illustrated in FIG. 37, 4 CSI-RS configuration Nos. 0-3 have the same RE set.

In the exemplary embodiment illustrated in FIG. 38, an RE set applied to the CSI-RS configuration Nos. 0 and 1 and the CSI-RS configuration Nos. 2 and 3 are different.

Furthermore, the exemplary embodiments illustrated in FIGS. 37 and 38 partially include an existing CSI-RS pattern for 1, 2, 4, or 8 CSI-RS antenna ports with respect to the same CSI-RS configuration index.

A method of extending a CSI-RS pattern using both FDM and TDM in a CSI-RS resource pool extended according to Method M210 (hereinafter referred to as “Method M213”) is described below.

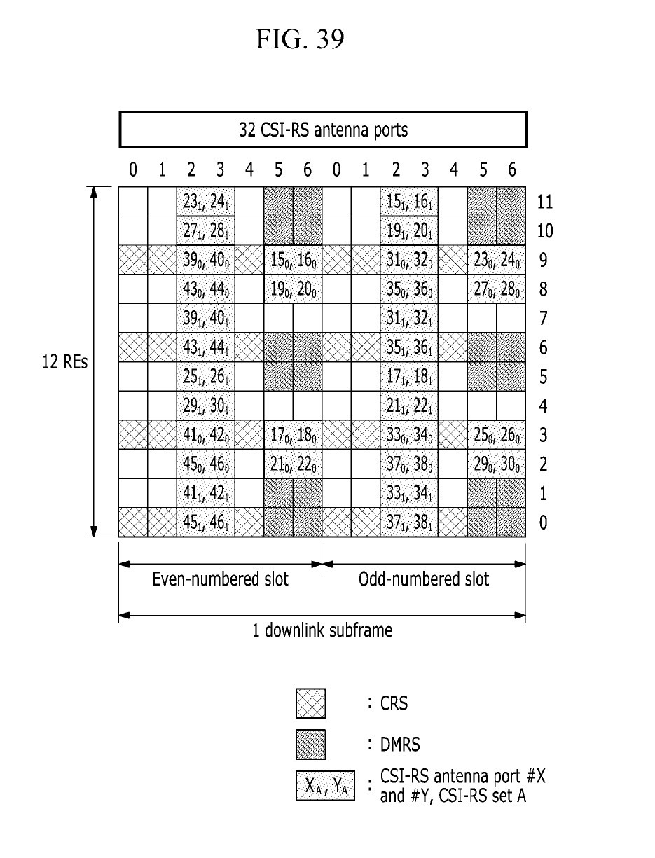

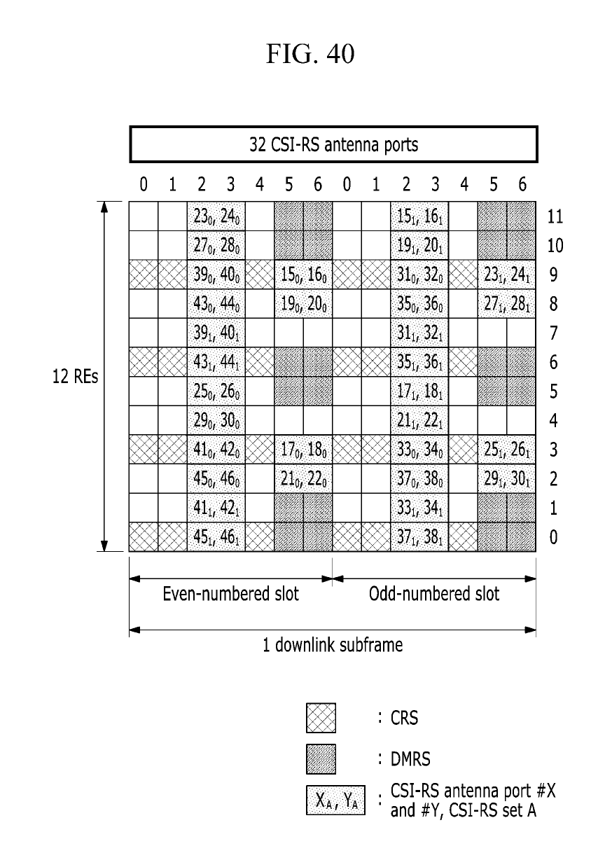

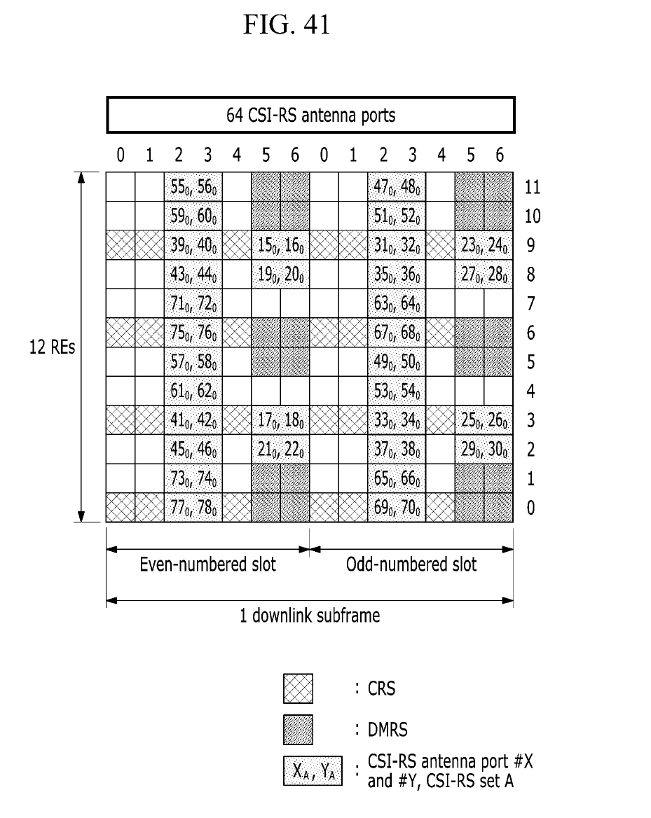

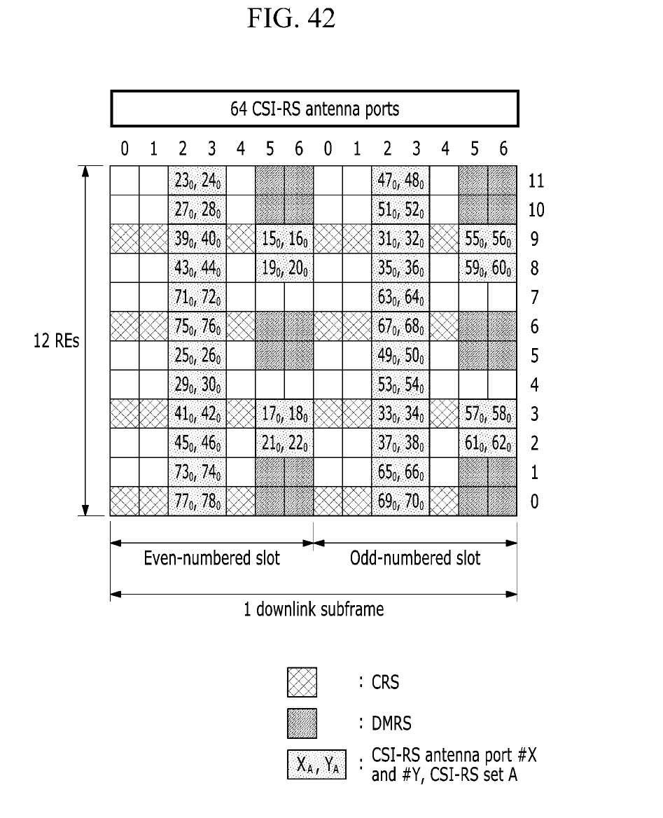

FIGS. 39 to 42 are exemplary embodiments of Method M213. FIGS. 39 and 40 are diagrams showing exemplary embodiments of a CSI-RS configuration for 32 CSI-RS antenna ports according to Method M213. FIGS. 41 and 42 are diagrams showing exemplary embodiments of a CSI-RS configuration for 64 CSI-RS antenna ports according to Method M213.

Specifically, a CSI-RS pattern illustrated in FIG. 39 satisfies a nested structure with the CSI-RS pattern illustrated in FIG. 37. For example, a CSI-RS pattern (CSI-RS antenna port Nos. 15-46) for a CSI-RS configuration No. 0 illustrated in FIG. 39 partially includes the CSI-RS pattern (CSI-RS antenna port Nos. 15-30) for the CSI-RS configuration No. 0 illustrated in FIG. 37.

A CSI-RS pattern illustrated in FIG. 40 satisfies a nested structure with the CSI-RS pattern illustrated in FIG. 38. For example, a CSI-RS pattern (CSI-RS antenna port Nos. 15-46) for a CSI-RS configuration No. 0 illustrated in FIG. 40 partially includes the CSI-RS pattern (CSI-RS antenna port Nos. 15-30) for the CSI-RS configuration No. 0 illustrated in FIG. 38.

A CSI-RS pattern illustrated in FIG. 41 satisfies a nested structure with the CSI-RS pattern illustrated in FIG. 39. For example, a CSI-RS pattern (CSI-RS antenna port Nos. 15-78) for a CSI-RS configuration No. 0 illustrated in FIG. 41 partially includes the CSI-RS pattern (CSI-RS antenna port Nos. 15-46) for the CSI-RS configuration No. 0 illustrated in FIG. 39.

A CSI-RS pattern illustrated in FIG. 42 satisfies a nested structure with the CSI-RS pattern illustrated in FIG. 40. For example, a CSI-RS pattern (CSI-RS antenna port Nos. 15-78) for a CSI-RS configuration No. 0 illustrated in FIG. 42 partially includes the CSI-RS pattern (CSI-RS antenna port Nos. 15-46) for the CSI-RS configuration No. 0 illustrated in FIG. 40.

If the number of CSI-RS antenna ports is 32 or 64, the extension of a CSI-RS pattern using TDM may further worsen a problem in which CSI-RS transmission power is reduced. In particular, if one-to-one mapping is used as an antenna port virtualization method, a method of satisfying full-power utilization may not be present in the exemplary embodiments of FIGS. 41 and 42. Furthermore, there may be a problem in that cell coverage is reduced because DMRS and PDSCH transmission power versus CSI-RS transmission power is too low.

If the CSI-RS configuration of Table 1 is extended up to 16, 32, or 64 CSI-RS antenna ports according to Method M212 and Method M213, extended parts are as listed in Table 8 below.

TABLE 8
Exemplary embodiment of CSI-RS configuration extended
according to Method M212 and Method M213

| | CSI- | | | | | | |
|---|---|---|---|---|---|---|---|
| | RS | 16 | | 32 | | 64 | |
| | config- | | nₛ | | nₛ | | nₛ |
| | uration | (k′,l′) | mod 2 | (k′,l′) | mod 2 | (k′,l′) | mod 2 |
| Frame | 0 | 9 and 5 | 0 | 9 and 5 | 0 | 9 and 5 | 0 |
| structure | 1 | 11,2 | 1 | 11,2 | 1 | | |
| types 1 | 2 | 9 and 2 | 1 | | | | |
| and 2 | 3 | 7 and 2 | 1 | | | | |

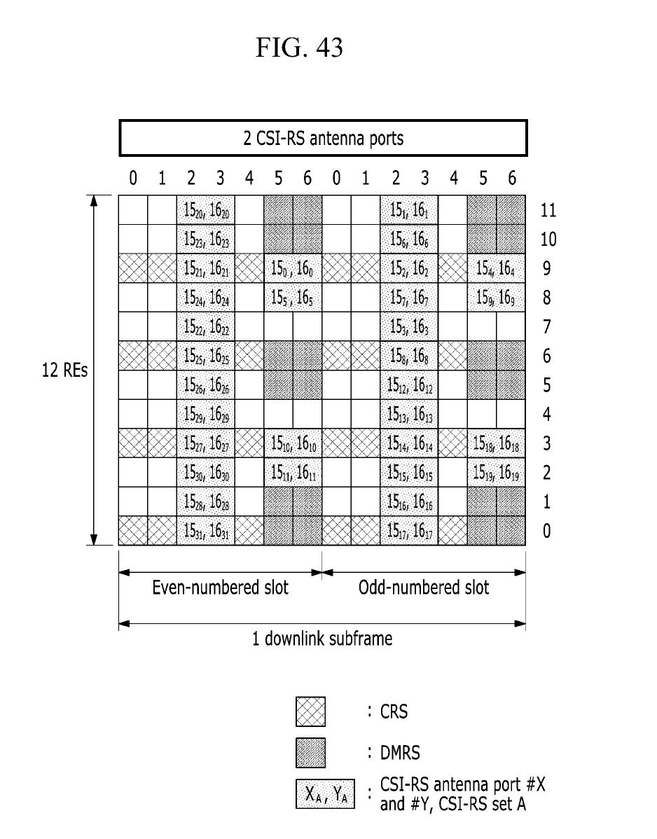

Method M210 may also be used to extend an RE set for 1, 2, 4, or 8 CSI-RS antenna ports in addition to a resource configuration for 12, 16, 20, 24, 32, or 64 CSI-RS antenna ports. That is, a method of configuring resources for 1, 2, 4, or 8 CSI-RS antenna ports using REs corresponding to the OFDM symbol Nos. 2 and 3 of a first time slot may be taken into consideration. FIGS. 43 to 45 are exemplary embodiments of such a method.

FIG. 43 is a diagram showing an embodiment of a resource configuration for 2 CSI-RS antenna ports according to Method M210. Specifically, FIG. 43 shows an example in which the CSI-RS pattern (CSI-RS antenna port Nos. 15 and 16) for the CSI-RS configuration Nos. 0-19 illustrated in FIG. 1 has been identically defined and a CSI-RS pattern (CSI-RS antenna port Nos. 15 and 16) for CSI-RS configuration Nos. 20-31 have been additionally defined in the OFDM symbol Nos. 2 and 3 of a first time slot.

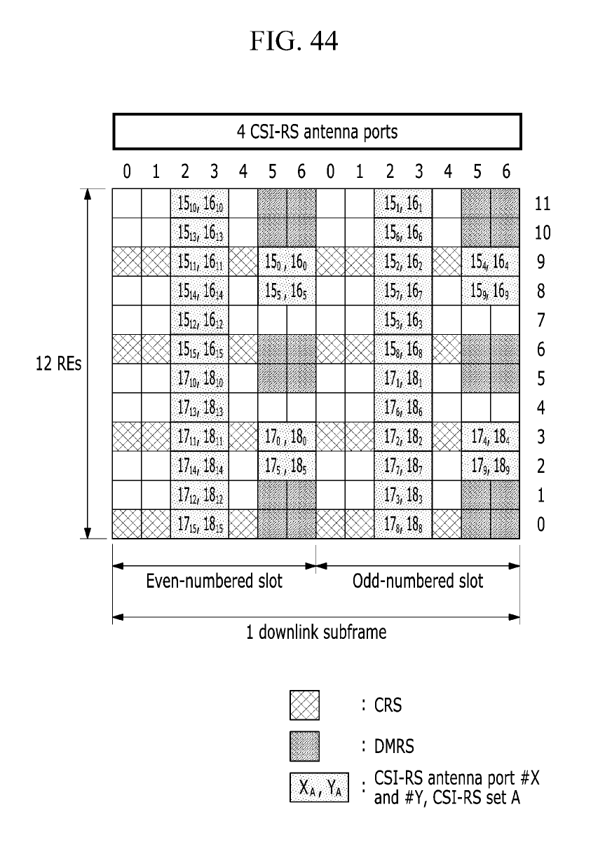

FIG. 44 is a diagram showing an embodiment of a resource configuration for 4 CSI-RS antenna ports according to Method M210. Specifically, FIG. 44 shows an example in which the CSI-RS pattern (CSI-RS antenna port Nos. 15-18) for the CSI-RS configuration Nos. 0-9 illustrated in FIG. 2 has been identically defined and a CSI-RS pattern (CSI-RS antenna port Nos. 15-18) for CSI-RS configuration Nos. 10-15 has been additionally defined in the OFDM symbol Nos. 2 and 3 of a first time slot.

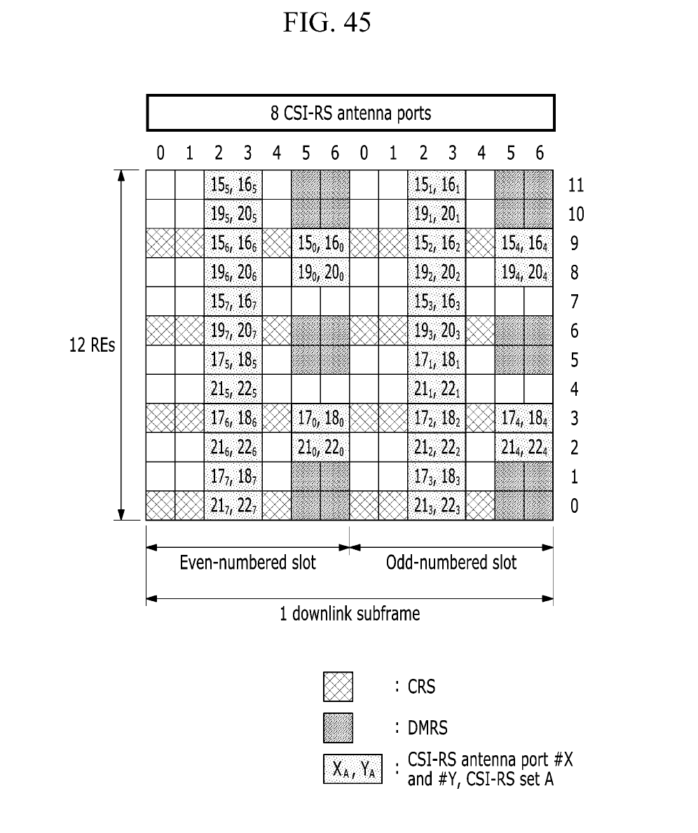

FIG. 45 is a diagram showing an embodiment of a resource configuration for 8 CSI-RS antenna ports according to Method M210. Specifically, FIG. 45 shows an example in which the CSI-RS pattern (the CSI-RS antenna port Nos. 15-22) for the CSI-RS configuration Nos. 0-4 illustrated in FIG. 3 has been identically defined and a CSI-RS pattern (CSI-RS antenna port Nos. 15-22) for CSI-RS configuration Nos. 5-7 has been additionally defined in the OFDM symbol Nos. 2 and 3 of a first time slot.

The exemplary embodiments illustrated in FIGS. 43 to 45 have a characteristic in that a nested structure is established between 1, 2, 4, or 8 CSI-RS antenna ports newly defined in the OFDM symbol Nos. 2 and 3 of the first time slot. RE mapping for a single CSI-RS antenna port is the same as that for two CSI-RS antenna ports. In this case, in RE mapping for a single CSI-RS antenna port, the CSI-RS antenna port Nos. 15 and 16 do not coexist, but only the CSI-RS antenna port No. 15 is present.

Furthermore, the 1, 2, 4, or 8 CSI-RS antenna ports illustrated in FIGS. 43 to 45 have a characteristic in that a nested structure is also established with the 16, 32, or 64 CSI-RS antenna ports illustrated in FIGS. 37 to 42. Nos. 20-31, that is, the CSI-RS configuration indices of an RE set newly added in FIG. 43, are numbers used for convenience sake and are different from 20-31, that is, CSI-RS configuration indices dedicated to TDD of Table 1.

A method of extending a CSI-RS pattern using CDM in a CSI-RS resource pool extended according to Method M210 (hereinafter referred to as “Method M214”) is described below.

The various principles of Method M141 to Method M148 may be applied to Method M214 identically or similarly. Some representative exemplary embodiments of various exemplary embodiments of Method M214 are described below.

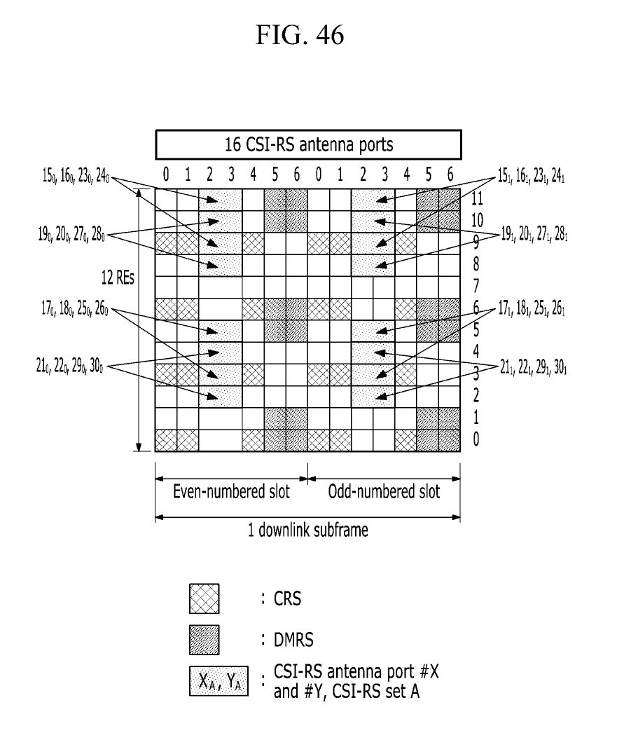

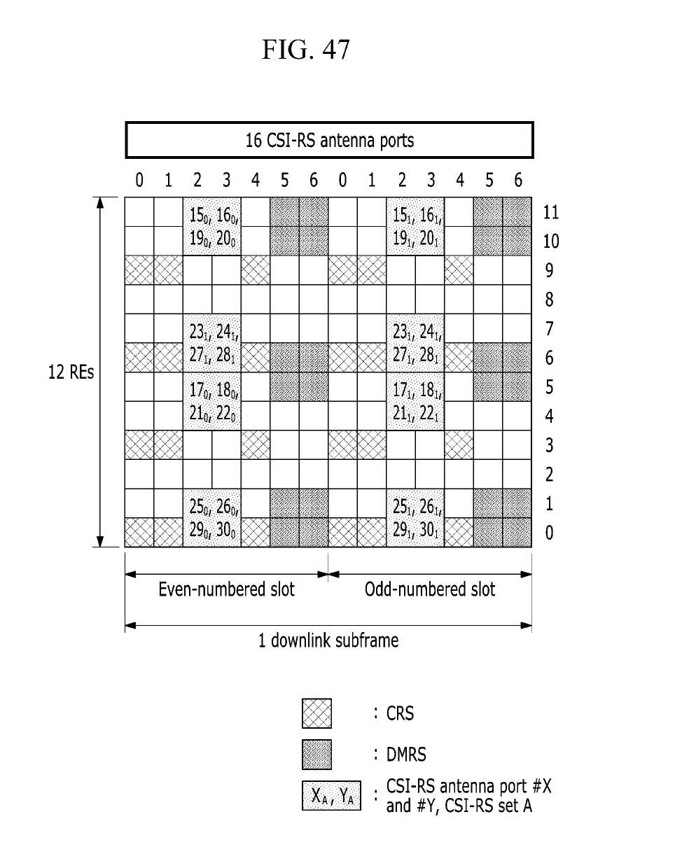

FIGS. 46 and 47 are exemplary embodiments of Method M214. FIGS. 46 and 47 are diagrams showing exemplary embodiments of a CSI-RS configuration for 16 CSI-RS antenna ports according to Method M214. Specifically, a method of extending a CSI-RS pattern in a frequency axis using the length-4 Walsh code is applied to the exemplary embodiments of FIGS. 46 and 47. In the exemplary embodiments of FIGS. 46 and 47, the method of extending a CSI-RS pattern uses the same principle as Method M141. In the exemplary embodiments of FIGS. 46 and 47, OCC applied to each CSI-RS antenna port may comply with Table 4.

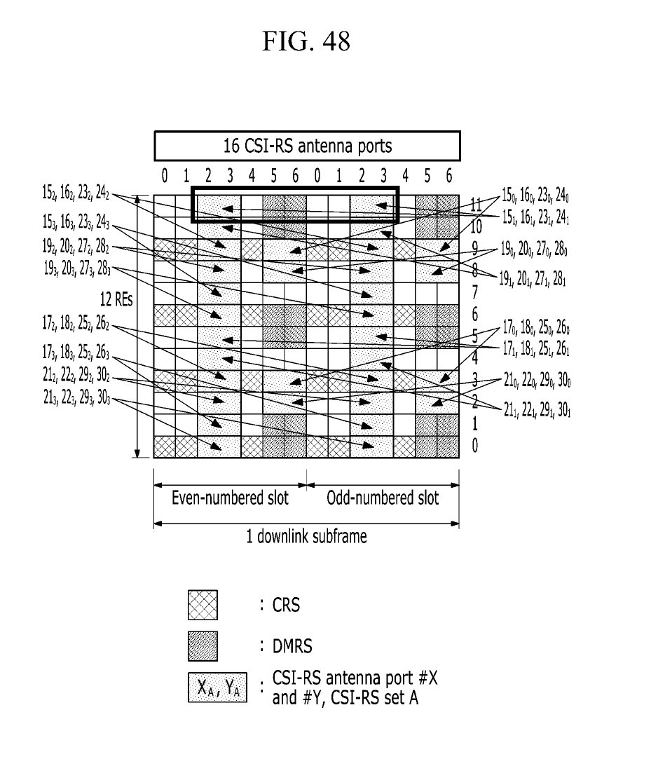

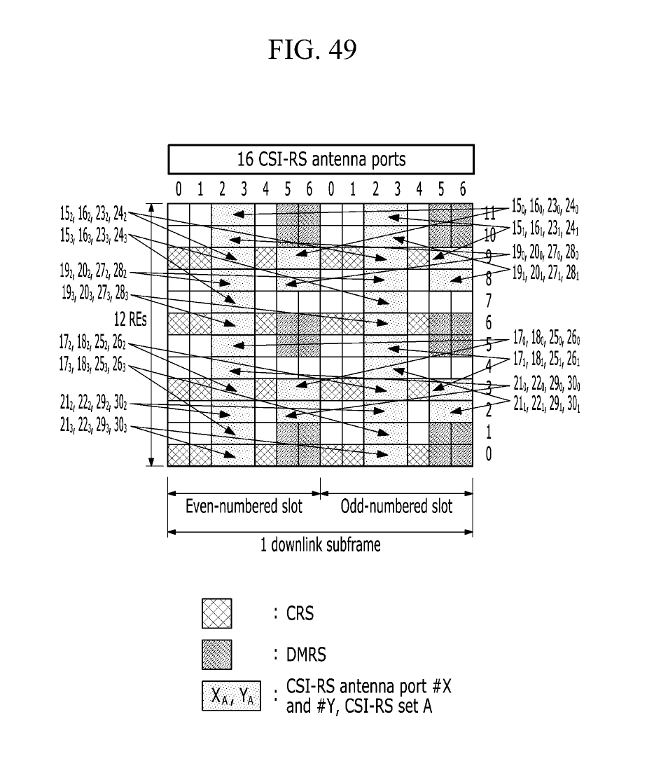

FIGS. 48 and 49 are diagrams showing another exemplary embodiments of a CSI-RS configuration for 16 CSI-RS antenna ports according to Method M214. Specifically, a method of extending a CSI-RS pattern in a time axis using the length-4 Walsh code is applied to the exemplary embodiments of FIGS. 48 and 49. In the exemplary embodiments of FIGS. 48 and 49, the method of extending a CSI-RS pattern uses the same principle as Method M142. Likewise, in the exemplary embodiments of FIGS. 48 and 49, OCC applied to each CSI-RS antenna port may comply with Table 3.

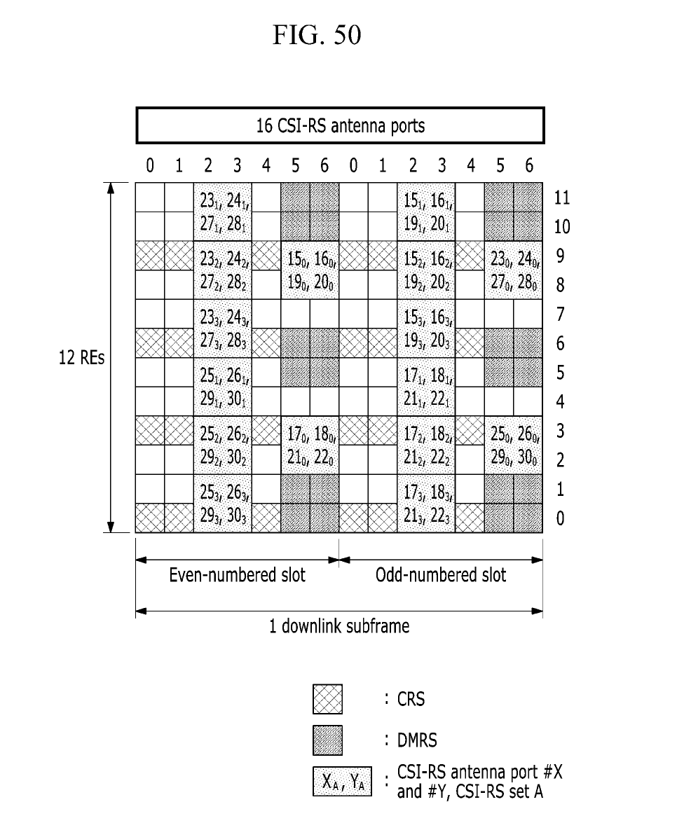

FIG. 50 is a diagram showing yet another embodiment of a resource configuration for 16 CSI-RS antenna ports according to Method M214. Specifically, a method of extending a CSI-RS pattern in a time axis using TDM and replacing some of existing FDM with CDM using the length-4 Walsh code is applied to FIG. 50. That is, in the exemplary embodiment of FIG. 50, the method of extending a CSI-RS uses the same principle as Method M143. In the exemplary embodiment of FIG. 50, likewise, OCC applied to each CSI-RS antenna port may comply with Table 4.

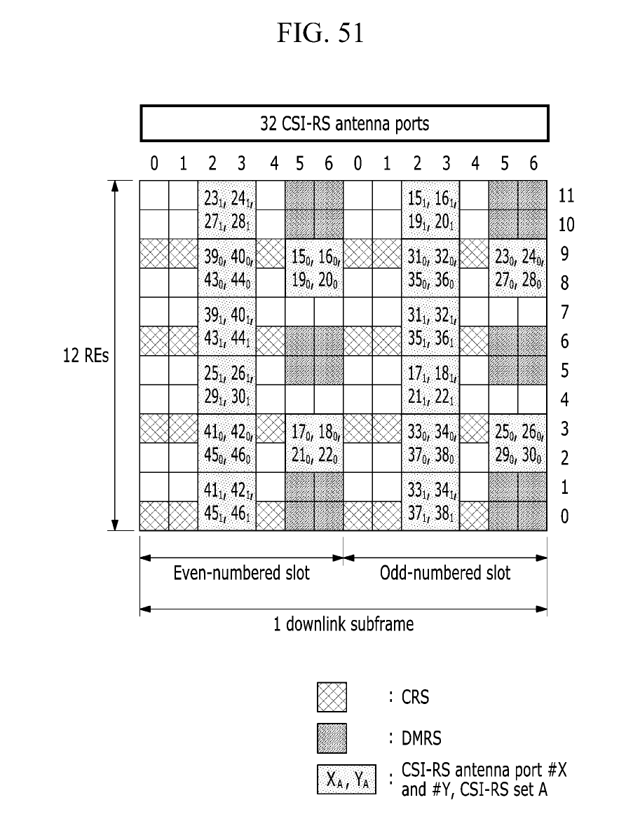

FIG. 51 is a diagram showing an embodiment of a resource configuration for 32 CSI-RS antenna ports according to Method M214. Specifically, a method in which an extended pattern based on CDM and an extended pattern based on both CDM and TDM in a frequency axis coexist in a single subframe is applied to FIG. 51. That is, in the exemplary embodiment of FIG. 51, the method of extending a CSI-RS uses the same principle as Method M144. For example, CDM and TDM are applied to a CSI-RS pattern (CSI-RS antenna port Nos. 15-46) for a CSI-RS configuration No. 0, and CDM is applied to a CSI-RS pattern (CSI-RS antenna port Nos. 15-46) for a CSI-RS configuration No. 1. A method of adding the REs of the OFDM symbol Nos. 1 and 2 of a first time slot to a CSI-RS resource pool (hereinafter referred to as “Method M220”) is described below.

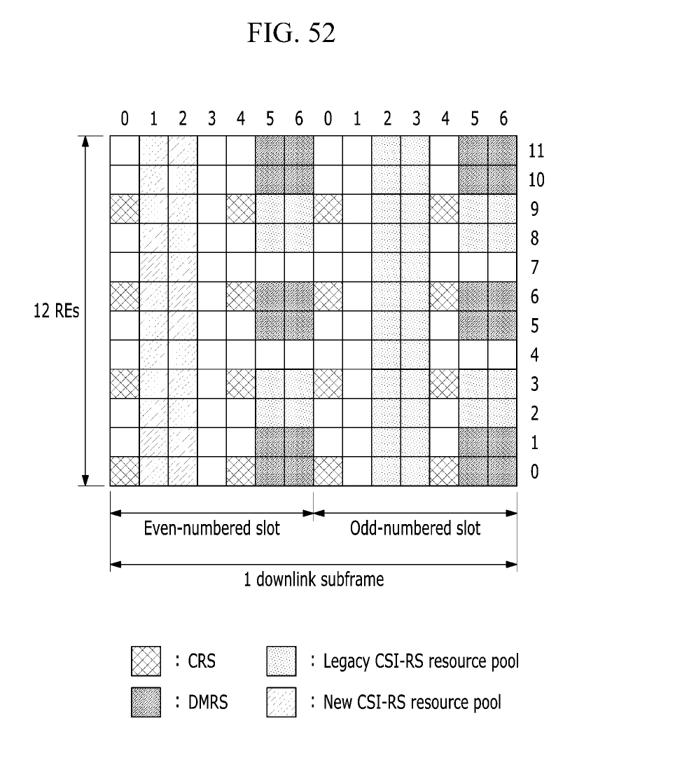

FIG. 52 is a diagram showing a CSI-RS resource pool extended by Method M220.

If 1 or 2 CRS antenna ports transmitted by a base station are configured, a method of adding 24 REs corresponding to the OFDM symbol Nos. 1 and 2 of a first time slot to a CSI-RS resource pool (Method M220) as illustrated in FIG. 52 may be taken into consideration.

The principles of Method M210 or the detailed methods Method M211 to Method M214 of Method M210 may be applied to a detailed method for a CSI-RS resource configuration using a resource pool newly added by Method M220 (i.e., the 24 REs corresponding to the OFDM symbol Nos. 1 and 2 of the first time slot). That is, in Method M210 or the detailed methods Method M211 to Method M214 of Method M210, the principle applied to the OFDM symbol Nos. 2 and 3 of the first time slot may be identically applied to the OFDM symbol Nos. 1 and 2 of the first time slot.

A method of supporting all of CSI-RS resource configuration methods to which length-2 CDM is applied (hereinafter referred to as a “length-2 CDM resource configuration method”) and CSI-RS resource configuration methods to which length-4 or length-8 CDM (hereinafter referred to as a “length-4 CDM resource configuration method”) is applied, from among the methods described so far, and configuring one of a length-2 CDM resource configuration method and a length-4 CDM resource configuration method in a terminal through high layer signaling may be taken into consideration.

In accordance with a current standard, a physical downlink control channel (PDCCH) region may be configured in the OFDM symbol Nos. 0 to 2 of a first time slot in a system whose bandwidth exceeds 10 resource blocks (RB) and may be configured in the OFDM symbol Nos. 0 to 3 of a first time slot in a system whose bandwidth is 10 RBs or less. Accordingly, if Method M210 or Method M220 is used, a CSI-RS resource configuration (or a ZP CSI-RS resource configuration) and a PDCCH region should not be overlapped. This may be solved by setting the value of a control format indicator (CFI) to 1 or 2 in a subframe in which a base station transmits a CSI-RS or ZP CSI-RS according to Method M210 or Method M220 and transmitting the CFI value through a physical control format indicator channel (PCFICH). If a base station has sent an erroneous CFI value or a terminal has received an erroneous CFI value due to a PCFICH decoding error, there is still a possibility that a terminal for which a CSI-RS has been configured in the OFDM symbol No. 1 or 2 of a first time slot may recognize that a PDCCH region and CSI-RS resources are overlapped in the corresponding subframe.

In this case, a method in which the terminal considers that the reception of the PCFICH is erroneous, does not perform PDCCH decoding in the corresponding subframe, and normally performs CSI-RS-based CSI measurement, may be taken into consideration. That is, for example, if Method M210 is used, the terminal may not expect that a CFI value is 3 or more if a system bandwidth exceeds 10 RBs and a CFI value is 2 or more if a system bandwidth is 10 RBs or less in a subframe in which a ZP CSI-RS or non-ZP (NZP) CSI-RS has been configured in the OFDM symbol Nos. 2 and 3 of the first time slot. Alternatively, since there is a high probability that an actual CFI value is 1 or 2, the terminal may normally perform CSI-RS-based CSI measurement, may assume that a CFI value is 1 or 2, and may attempt PDCCH decoding. In this case, a corresponding operation may be defined in a standard with respect to the PDCCH decoding of the terminal, or the terminal may perform blind decoding as a terminal implementation issue.

In order to be aware of PDSCH RE mapping information or perform PDSCH rate matching in receiving a PDSCH, a terminal needs to be aware of the location of an OFDM symbol (hereinafter referred to as a “PDSCH starting symbol”) at which PDSCH transmission is started. In accordance with a current LTE standard, a PDSCH starting symbol may be defined by a serving cell in which a PDSCH has been scheduled and the CFI value of a subframe or may be indicated by RRC signaling. Specifically, cases indicated by RRC signaling are as follows. If a terminal has been configured to monitor an enhanced PDCCH (EPDCCH) in a subframe in which a PDSCH is received, a PDSCH starting symbol is indicated by “epdcch-StartSymbol-r11” if a PDSCH is based on an EPDCCH in the same serving cell or if the PDSCH is based on a semi-persistent scheduling (SPS) PDSCH. Alternatively, if a PDSCH is subject to cross-carrier scheduling by another serving cell, a PDSCH starting symbol is determined (or indicated) by “pdsch-Start-r10.”

Furthermore, if a PDSCH is indicated by downlink control information (DCI) format 2D (if transmission mode is 10), a PDSCH starting symbol is indicated by “pdsch-Start-r11” defined in a parameter set indicated by a “PDSCH RE Mapping and Quasi-Co-Location.”

In general, the listed RRC parameters (e.g., epdcch-StartSymbol-r11, pdsch-Start-r10, and pdsch-Start-r11) need to be set based on a maximum value of a CFI to be transmitted by a base station. For example, a case where a base station sets a CFI value for a subframe configured so that a CSI-RS is transmitted in a resource pool (24 REs corresponding to the OFDM symbol Nos. 2 and 3 of a first time slot) extended by Method M210 to 2 and sets a CFI value for a subframe configured so that a CSI-RS is not transmitted in a resource pool extended by Method M210 to 3 is assumed. In this case, if a terminal is able to perform PDSCH rate matching while avoiding collision with a PDCCH region in all subframes, the value of an RRC parameter (e.g., epdcch-StartSymbol-r11, pdsch-Start-r10, or pdsch-Start-r11) needs to be set to 3 or more. For example, if the value of an RRC parameter (e.g., epdcch-StartSymbol-r11, pdsch-Start-r10, or pdsch-Start-r11) is 3, a PDSCH starting symbol is configured in a terminal as the OFDM symbol No. 3 of a first time slot. Accordingly, the terminal is unable to use the OFDM symbol No. 2 of the first time slot in PDSCH RE mapping in a subframe configured so that a CSI-RS is transmitted in a resource pool extended by Method M210. This reduces resource use efficiency.

There is a need for a method in a case where a PDSCH starting symbol is indicated by RRC signaling with respect to a new terminal to which Method M210 or Method M220 is applied when taking such a problem into consideration.

A method (hereinafter referred to as “Method M230”) of determining a set of subframes configured so that a CSI-RS is transmitted in a resource pool extended by Method M210 or Method M220 (hereinafter referred to as a “first subframe”) and a set of subframes not configured so that a CSI-RS is transmitted in a resource pool extended by Method M210 or Method M220 (hereinafter referred to as a “second subframe”) and configuring a PDSCH starting symbol in a terminal using a different RRC parameter for each of a set of first subframes (hereinafter referred to as a “first set”) and a set of second subframes (hereinafter referred to as a “second set”) is described below.

If a base station configures a PDSCH starting symbol in a terminal using different RRC parameters for a first set and a second set, the terminal may differentiate the first set and the second set using one of Method M231, Method M232, and Method M233.

Specifically, Method M231 is a method of notifying, by a base station, a terminal of subframes forming a first set and subframes forming a second set through signaling. Method M232 is a method of notifying, by a base station, a terminal of subframes forming at least one of a first set and a second set. In Method M232, a terminal considers that subframes signaled by a base station are included in one of a first set and a second set and subframes not signaled by the base station are included in the other of the first set and the second set.

In accordance with Method M231 and Method M232, signaling overhead is increased, but two different RRC parameters may also be used for other purposes in addition to the aforementioned use.

In accordance with Method M230, a base station transmits an RRC parameter for configuring the PDSCH starting symbol of a first set and an RRC parameter for configuring the PDSCH starting symbol of a second set to a terminal. In accordance with Method M230, a base station can configure a PDSCH starting symbol for a first set in a terminal using a separate RRC parameter for the first set. Accordingly, the base station can transmit a PDSCH from an OFDM symbol right next to a PDCCH region without wasting resources even in the first set. Method M230 may be independently applied to RRC parameters (e.g., epdcch-StartSymbol-r11, pdsch-Start-r10, and pdsch-Start-r11). A terminal performs PDSCH RE mapping on each of a first set and a second set based on an RRC parameter for the first set and an RRC parameter for the second set.

In relation to Method M230, as the method of determining, by a terminal, a first set and a second set, a terminal may use Method M233 in addition to the method according to additional RRC signaling. Specifically, Method M233 is a method of determining a first set and a second set based on a CSI-RS resource configuration configured in a terminal.

If Method M210 or Method M220 is used, there may be a problem in that PDCCH transmission resources are insufficient. In particular, such a phenomenon may become a greater problem in a system having a small bandwidth (e.g., a system having a bandwidth of 10 RBs or less).

A method of adding REs to a CSI-RS resource pool while maintaining the first three OFDM symbols (the OFDM symbol Nos. 0-2 of a first time slot) in order to secure a PDCCH region (hereinafter referred to as “Method M240”) is described below.

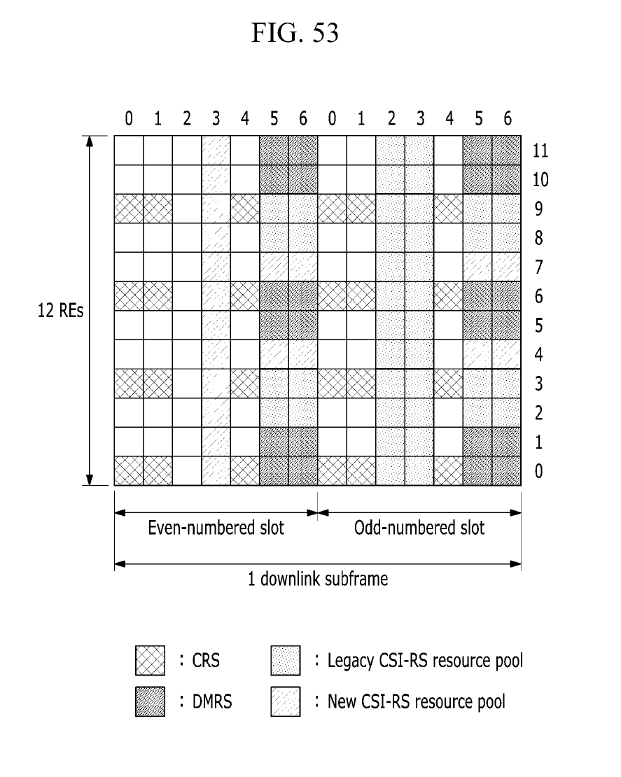

FIG. 53 is a diagram showing a CSI-RS resource pool extended by Method M240.

In Method M240, a CSI-RS configuration for 1, 2, 4, 8, 12, 16, 20, 24, or 32 CSI-RS antenna ports may be defined using the principles of the methods described so far identically or similarly.

If a normal CP is set, the number of REs which may be additionally used to transmit a CSI-RS other than the first three OFDM symbols (the OFDM symbol Nos. 0-2 of the first time slot) is 20 as illustrated in FIG. 53. In accordance with Method M240, although all of the newly added 20 REs are used, it is impossible to configure resources for 64 CSI-RS antenna ports within a single subframe.

REs added to a CSI-RS resource pool according to Method M210, Method M220, or Method M240 need to be used for a ZP CSI-RS resource configuration in addition to an NZP CSI-RS resource configuration. There is a need for a method of configuring, by a base station, a resource pool, added according to Method M210, Method M220, or Method M240, in a terminal as a ZP CSI-RS resource. As one of such methods, a method of increasing the bitmap length of a ZP CSI-RS resource configuration list now set to 16 bits (i.e., the length of a bitmap for ZP CSI-RS predetermined signaling) may be taken into consideration. For example, a method of increasing the bitmap length of a ZP CSI-RS resource configuration list to 19 bits may be taken into consideration. More specifically, for the bitmap of the ZP CSI-RS resource configuration list, a new parameter of 19 bits may be defined, and a new parameter for 3 bits may be additionally defined while maintaining a current parameter of 16 bits.

In all the methods described so far, CDM is basically applied to a CSI-RS pattern except that the number of CSI-RS antenna ports is 1. Accordingly, a single CSI-RS antenna port is transmitted through 2 REs, 4 REs, or 8 REs. If length-2 CDM is used and the number of CSI-RS antenna ports is 2 or more, one RE is used in each CSI-RS antenna port on average because two CSI-RS antenna ports share two REs. If the number of CSI-RS antenna ports is 1, however, resource use efficiency may be degraded.

A method of transmitting one CSI-RS antenna port through only one RE without using CDM may be taken into consideration.

As a method of multiplexing CSI-RS antenna ports, a method of allowing a single CSI-RS antenna port to occupy a single RE except CDM (hereinafter referred to as “Method M300”) is described below.

In accordance with Method M300, if the number of CSI-RS antenna ports is 1, unnecessary CSI-RS transmission overhead is not generated. Specifically, Method M300 may be divided into Method M310 and Method M320 depending on the range of an RE which may be used for a single CSI-RS pattern, that is, a single CSI-RS RE set.

A method of using all REs within a CSI-RS resource pool for a single CSI-RS resource configuration (hereinafter referred to as “Method M310”) is described below.

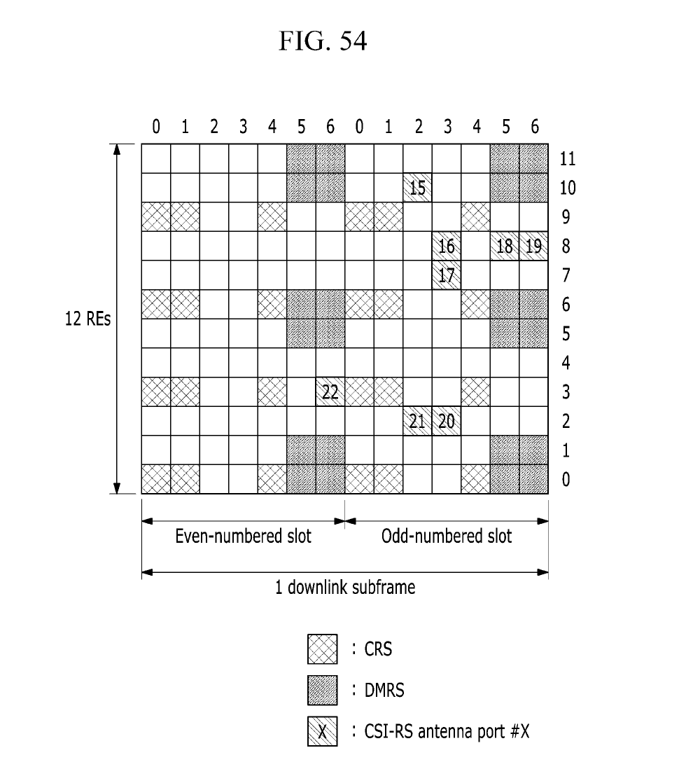

FIG. 54 is one of exemplary embodiments of Method M310. FIG. 54 is a diagram showing an embodiment of a resource configuration for 8 CSI-RS antenna ports according to Method M310. For example, a CSI-RS antenna port No. 15 is mapped to the RE (10, 2) of a second time slot, and a CSI-RS antenna port No. 16 is mapped to the RE (8, 3) of the second time slot. That is, one CSI-RS antenna port is transmitted through only one RE.

In accordance with Method M310, CSI-RS resources may be configured using a specific RE set in the entire region of an existing CSI-RS resource pool (40 REs) or in the entire region of a CSI-RS resource pool extended by Method M210, Method M220, or Method M240.

A method of dividing a CSI-RS resource pool into a plurality of sections and using the REs of one of the plurality of sections for a single CSI-RS resource configuration (hereinafter referred to as “Method M320”) is described below. For example, it is assumed that a CSI-RS resource pool is divided into 5 sections and a CSI-RS pattern for four CSI-RS antenna ports is configured. A base station may select one of the 5 sections and configure CSI-RS antenna port Nos. 15-18 in the four of a plurality of REs included in the selected section. In accordance with Method M320, as in Method M310, one CSI-RS antenna port is transmitted through only one RE.

In Method M310 or Method M320, the existing CSI-RS resource pool (40 REs), a CSI-RS resource pool extended by Method M210, a CSI-RS resource pool extended by Method M220, a CSI-RS resource pool extended by Method M240, a CSI-RS resource pool extended using a plurality of subframes, a CSI-RS resource pool extended using a plurality of PRB pairs adjacent in a frequency axis, or a specific CSI-RS resource pool may be used.

Method M300 or the detailed methods Method M310 and Method M320 of Method M300 may use full transmission power in transmitting each CSI-RS antenna port using a specific antenna virtualization method. Specifically, such an antenna port virtualization method may use a method implemented by linearly combining CSI-RS antenna ports in each of which weight values having constant modulus amplitude have been applied to all TXUs.

A terminal may need to recognize CSI-RS antenna ports, configured through the aforementioned methods, as a two-dimensional array. For example, if 16 CSI-RS antenna ports (e.g., CSI-RS antenna port Nos. 15-30) have been configured in a terminal, an antenna port array may be a one-dimensional array having a length of 16 only in a horizontal axis or may be a two-dimensional rectangular array having a length of 2 in a vertical axis and having a length of 8 in a horizontal axis. Accordingly, a method of signaling, by a base station, information about the two-dimensional array of CSI-RS antenna ports to a terminal may be taken into consideration.

A method (hereinafter referred to as “Method M400”) of notifying, by a base station, a terminal of the number of CSI-RS antenna ports in a horizontal axis (hereinafter referred to as “NH”) and the number of CSI-RS antenna ports in a vertical axis (hereinafter referred to as “NV”) is described below.

In Method M400, if a terminal is already aware of a total number of CSI-RS antenna ports configured in the terminal, a base station may notify the terminal of only NH or NV.

The array structure of CSI-RS antenna ports assumed by a terminal through the signaling of Method M400 includes a structure according to Method M410 and a structure according to Method M420.

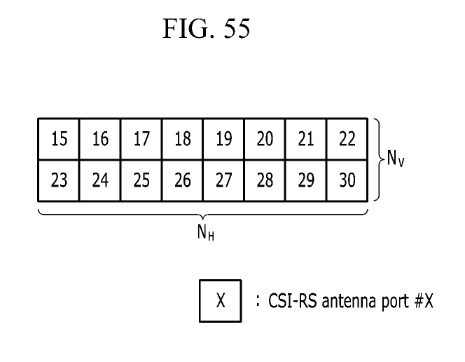

Method M410 is a method of assuming, by a terminal, CSI-RS antenna ports to be a two-dimensional rectangular array, that is, NV×NH. FIG. 55 is an exemplary embodiment of Method M410.

FIG. 55 is a diagram showing an exemplary embodiment of a two-dimensional rectangular array configuration for 16 CSI-RS antenna ports. Specifically, FIG. 55 illustrates an example in which 16 CSI-RS antenna ports (e.g., CSI-RS antenna port Nos. 15-30) are configured in a terminal, NV=2, and NH=8. A method of mapping CSI-RS antenna port numbers on a two-dimensional array is as follows. A method of previously defining the mapping rule of CSI-RS antenna port numbers according to a rule, first mapping CSI-RS antenna port numbers in a horizontal axis, and then mapping CSI-RS antenna port numbers in a vertical axis as illustrated in FIG. 55 may be taken into consideration. Alternatively, a method of mapping CSI-RS antenna port numbers in order opposite order of the above method may be taken into consideration.

In Method M410, a base station may set NV and NH so that the product of NV and NH becomes a total number of CSI-RS antenna ports configured in a terminal.

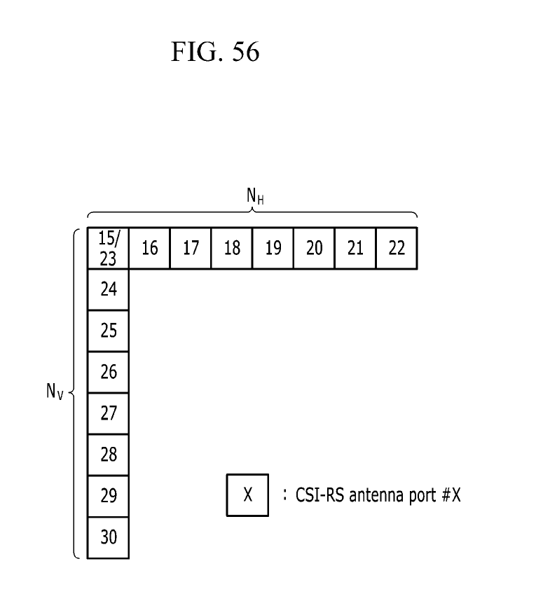

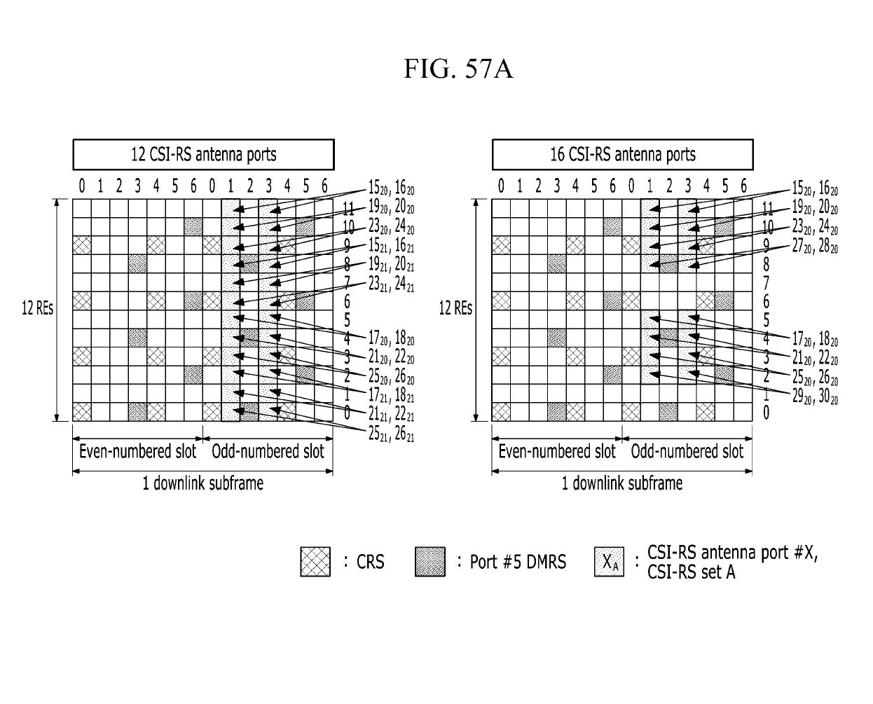

Method M420 is a method of assuming, by a terminal, CSI-RS antenna ports to be a cross array whose length in a vertical axis is NV and whose length in a horizontal axis is NH. FIG. 56 is an exemplary embodiment of Method M420.

FIG. 56 is a diagram showing an exemplary embodiment of a two-dimensional cross array configuration for 16 CSI-RS antenna ports. Specifically, FIG. 56 shows an example in which 16 CSI-RS antenna ports (e.g., CSI-RS antenna port Nos. 15-30) are configured in a terminal, NV=8, and NH=8.

In Method M420, a base station may configure NV and NH so that the sum of NV and NH becomes a total number of CSI-RS antenna ports configured in a terminal.

In Method M420, the location where a CSI-RS antenna port in a vertical axis overlaps with a CSI-RS antenna port in a horizontal axis or corresponding antenna port numbers (i.e., the CSI-RS antenna port Nos. 15 and 23 in FIG. 56) may be fixed, or a base station may variably set the place in a terminal.

2.2. CSI-RS Configuration Applicable to Only TDD if a Normal CP is Set

Likewise, a method of using a CSI-RS resource pool (i.e., 24 REs) defined in an existing standard without a change (hereinafter referred to as “Method M510”) and a method of extending a CSI-RS resource pool (hereinafter referred to as “Method M520”) may be taken into consideration. In this specification, “Port #5 DMRS” indicated in the drawings denotes the DMRS of an antenna port No. 5.

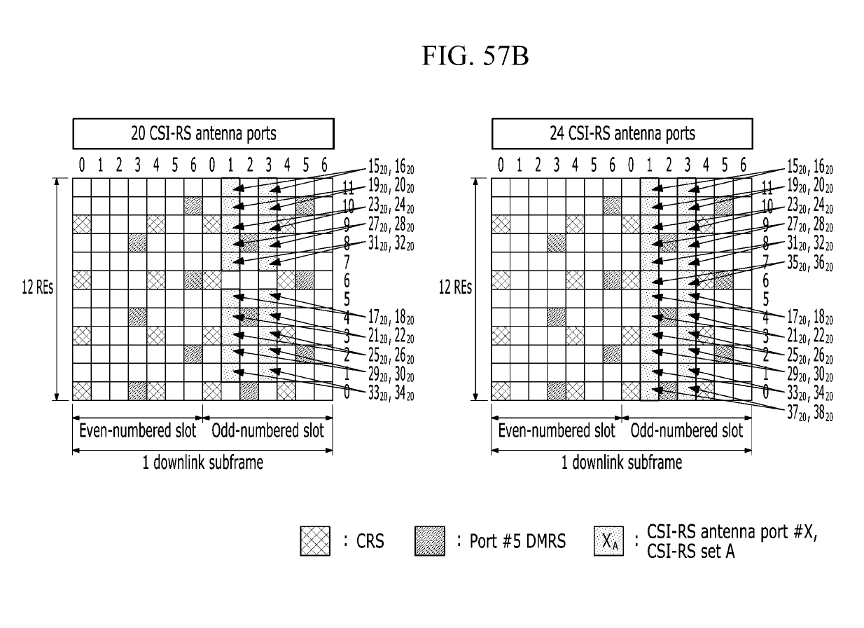

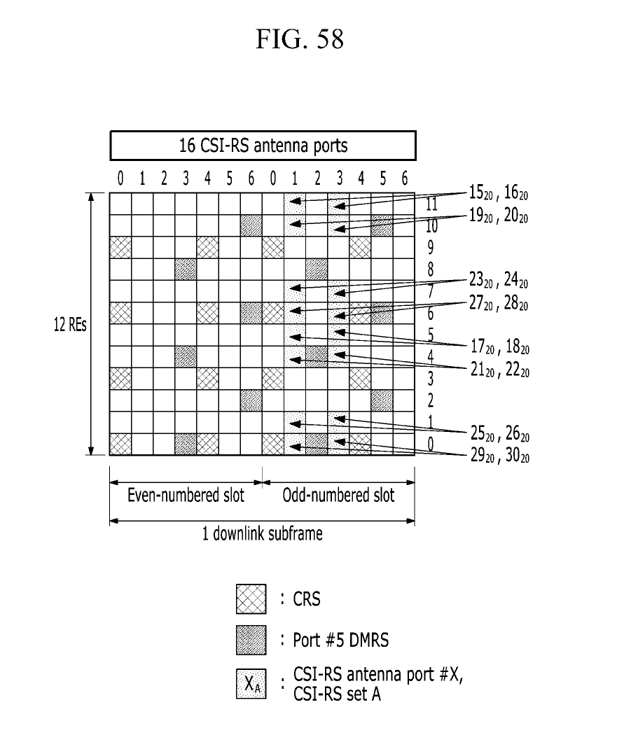

FIGS. 57A, 57B, and 58 are exemplary embodiments of Method M510. In the exemplary embodiments of FIGS. 57A, 57B, and 58, a CSI-RS resource pool includes 24 REs corresponding to the OFDM symbol Nos. 1 and 3 of a second time slot.

FIG. 57A is a diagram showing an exemplary embodiment of a resource configuration for 12 or 16 CSI-RS antenna ports according to Method M510, and FIG. 57B is a diagram showing an exemplary embodiment of a resource configuration for 20 or 24 CSI-RS antenna ports according to Method M510. For example, CSI-RS antenna port Nos. 15 and 16 for a CSI-RS configuration No. 20 are mapped to the RE (11, 1) and RE (11, 3) of a second time slot. Length-2 CDM is applied between the CSI-RS antenna port Nos. 15 and 16 for the CSI-RS configuration No. 20. CSI-RS antenna port Nos. 19 and 20 for the CSI-RS configuration No. 20 are mapped to the RE (10, 1) and RE (10, 3) of the second time slot. Length-2 CDM is applied between the CSI-RS antenna port Nos. 19 and 20 for the CSI-RS configuration No. 20. FDM is applied between the CSI-RS antenna port Nos. 15 and 16 for the CSI-RS configuration No. 20 and the CSI-RS antenna port Nos. 19 and 20 for the CSI-RS configuration No. 20.

FIG. 58 is a diagram showing another embodiment of a resource configuration for 16 CSI-RS antenna ports according to Method M510. For example, CSI-RS antenna port Nos. 23 and 24 for a CSI-RS configuration No. 20 are mapped to the RE (7, 1) and RE (7, 3) of a second time slot. Length-2 CDM is applied between the CSI-RS antenna port Nos. 23 and 24 for the CSI-RS configuration No. 20. CSI-RS antenna port Nos. 27 and 28 for the CSI-RS configuration No. 20 is mapped to the RE (6, 1) and RE (6, 3) of the second time slot. Length-2 CDM is applied between the CSI-RS antenna port Nos. 27 and 28 for the CSI-RS configuration No. 20. FDM is applied between the CSI-RS antenna port Nos. 23 and 24 for the CSI-RS configuration No. 20 and the CSI-RS antenna port Nos. 27 and 28 for the CSI-RS configuration No. 20.

Method M520 is described below.

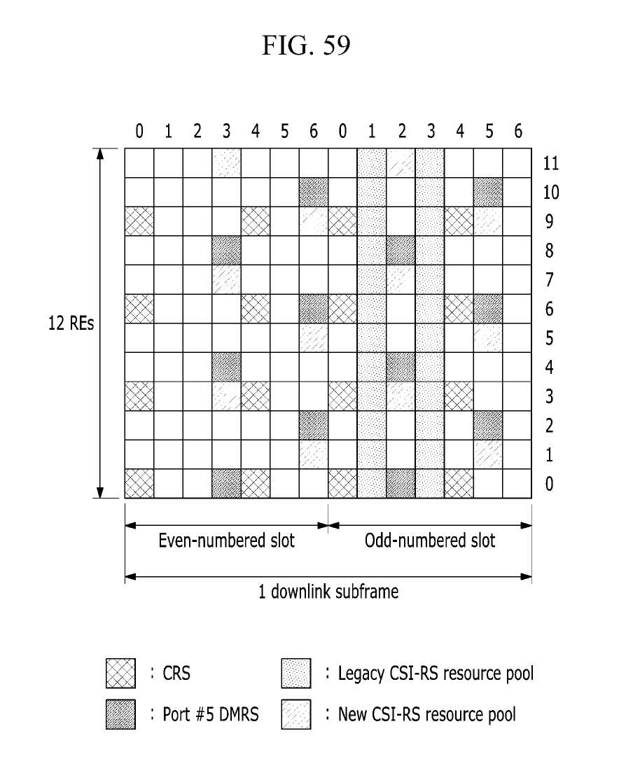

If a normal CP is set, the DMRS of an antenna port No. 5 is not mapped to three REs in each of OFDM symbol (e.g., the OFDM symbol Nos. 3 and 6 of a first time slot and the OFDM symbol Nos. 2 and 5 of a second time slot) in which the DMRS of the antenna port No. 5 is transmitted. For example, the DMRS of the antenna port No. 5 is not mapped to the RE (11, 3), RE (7, 3), and RE (3, 3) of the first time slot. That is, the DMRS of the antenna port No. 5 is not mapped to the RE (11, 3), RE (7, 3), RE (3, 3), RE (9, 6), RE (5, 6), and RE (1, 6) of the first time slot and the RE (11, 2), RE (7, 2), RE (3, 2), RE (9, 5), RE (5, 5), and RE (1, 5) of the second time slot. A method of adding such 12 REs to a CSI-RS resource pool (hereinafter referred to as “Method M521”) may be taken into consideration. FIG. 59 is an exemplary embodiment of Method M521.

FIG. 59 is a diagram showing a CSI-RS resource pool extended by Method M521. In accordance with Method M521, a total of 36 (=24+12) REs may be used for a CSI-RS configuration within a single PRB pair. A method of configuring CSI-RS resources according to Method M521 may use the principles of the aforementioned methods identically or similarly, and thus a detailed description thereof is omitted.

Method M522 and Method M523 may be taken into consideration as other detailed methods of Method M520.

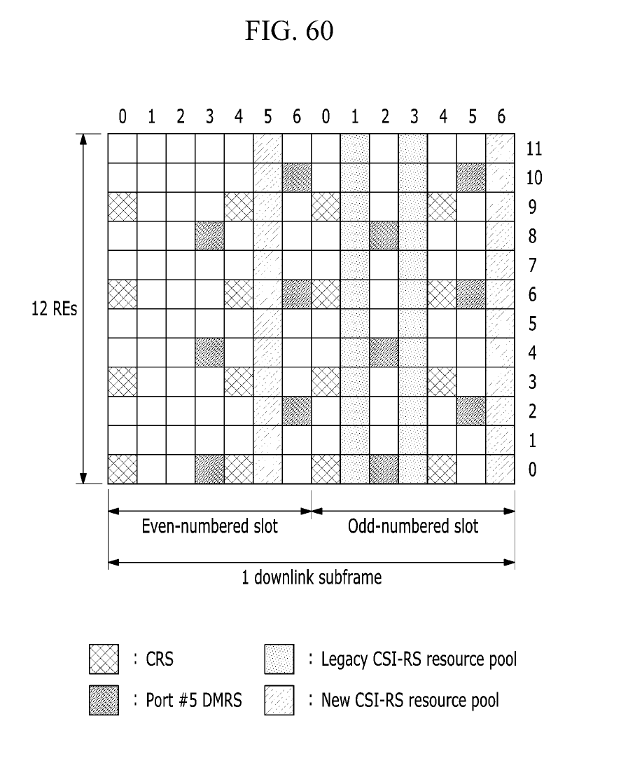

Method M522 is a method of adding 12 REs, corresponding to the OFDM symbol No. 5 of a first time slot, and 12 REs, corresponding to the OFDM symbol No. 6 of a second time slot, to a CSI-RS resource pool. FIG. 60 is an exemplary embodiment of Method M522. FIG. 60 is a diagram showing a CSI-RS resource pool extended by Method M522.

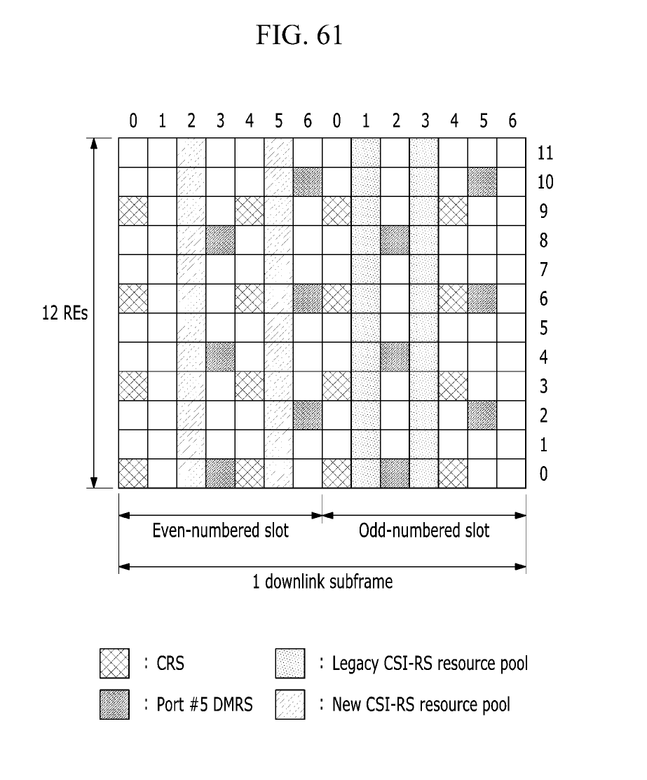

Method M523 is a method of adding 24 REs, corresponding to the OFDM symbol Nos. 2 and 5 of a first time slot, to a CSI-RS resource pool. FIG. 61 is an exemplary embodiment of Method M523. FIG. 61 is a diagram showing a CSI-RS resource pool extended by Method M523.

In Method M522 and Method M523, a total of 48 (=24+24) CSI-RS antenna ports may be configured in a single subframe.

In Method M523, a CSI-RS resource pool includes the OFDM symbol No. 2 of a first time slot. Accordingly, Method M523 may use Method M230 identically or similarly in order to efficiently use PDSCH transmission resources while avoiding a collision against a PDCCH region. That is, a method of determining a set of subframes (hereinafter referred to as “third subframes”) configured so that a CSI-RS is transmitted in a resource pool extended by Method M523 and a set of subframes (hereinafter referred to as “fourth subframes”) configured so that a CSI-RS is not transmitted in a resource pool extended by Method M523 and configuring a PDSCH starting symbol in a terminal using two different RRC parameters for a set of third subframes and a set of the fourth subframes may be taken into consideration.

If a CSI-RS pattern is defined in a resource pool newly added by Method M522 and Method M523, to use length-2 CDM in a frequency axis within the same OFDM symbol instead of existing length-2 CDM in a time axis is more advantageous for channel estimation performance.

2.3. CSI-RS Configuration Applicable to Both FDD and TDD if an Extended CP is Set

If an extended CP is set, a first time slot or a second time slot includes 6 OFDM symbols (Nos. 0 to 5) in a time axis and 12 subcarriers (Nos. 0 to 11) in a frequency axis. That is, if an extended CP is set, the first time slot or the second time slot includes 72=6×12 REs.

If an extended CP is set, an existing CSI-RS resource pool includes a total of 32 REs. Accordingly, if a CSI-RS resource pool is not extended, a CSI-RS configuration for a total of 32 CSI-RS antenna ports within a single subframe may be defined.

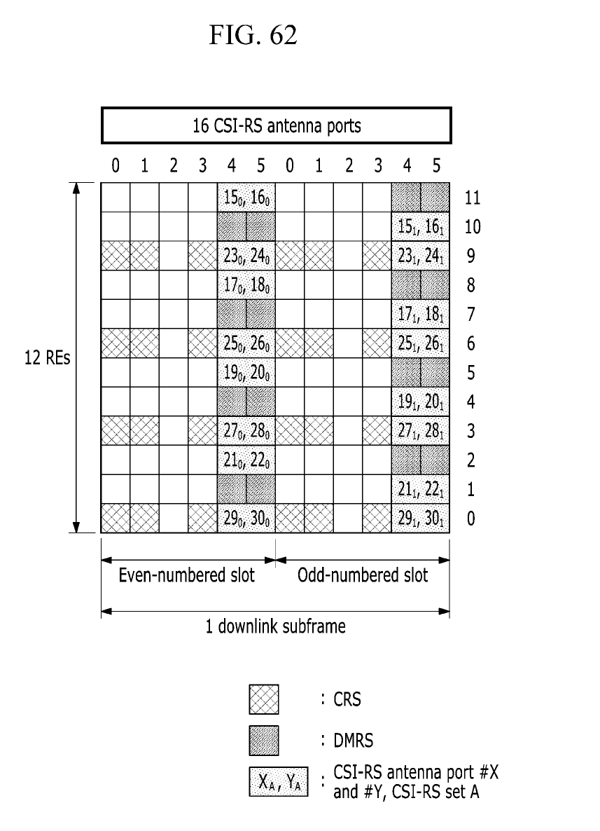

If an extended CP is set, a CSI-RS resource configuration method (hereinafter referred to as a “first extension CP resource configuration method”) applicable to both FDD and TDD may use the principles of the methods of configuring CSI-RS resources for the aforementioned cases where a normal CP is set identically or similarly. Accordingly, a further detailed description thereof is omitted. FIGS. 62 to 66 are exemplary embodiments of the first extension CP resource configuration method.

FIG. 62 shows an embodiment of a method of extending a CSI-RS pattern in a frequency axis using FDM. Specifically, FIG. 62 is a diagram showing an exemplary embodiment of a CSI-RS configuration for 16 CSI-RS antenna ports if an extended CP is set.

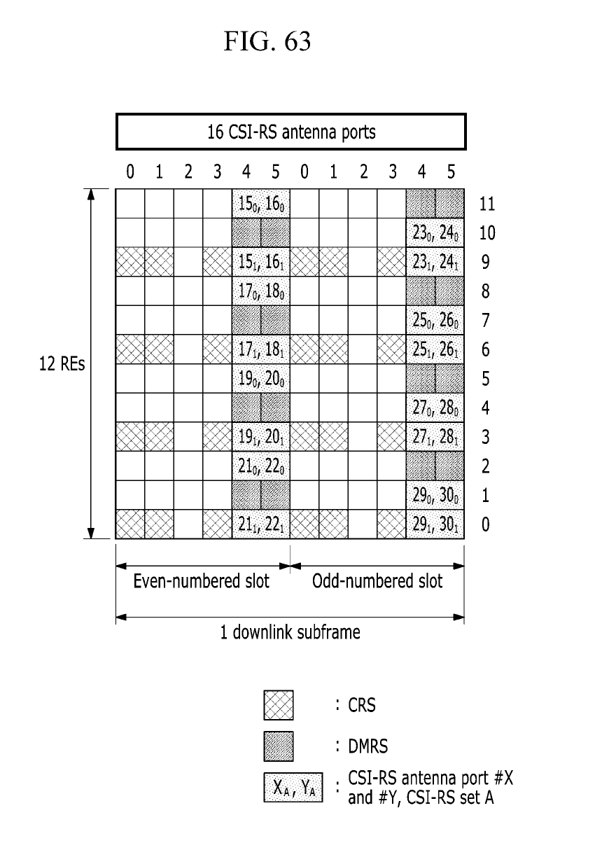

FIG. 63 shows an embodiment of a method of extending a CSI-RS pattern in a time axis using TDM. Specifically, FIG. 63 is a diagram showing another embodiment of a resource configuration for 16 CSI-RS antenna ports if an extended CP is set.

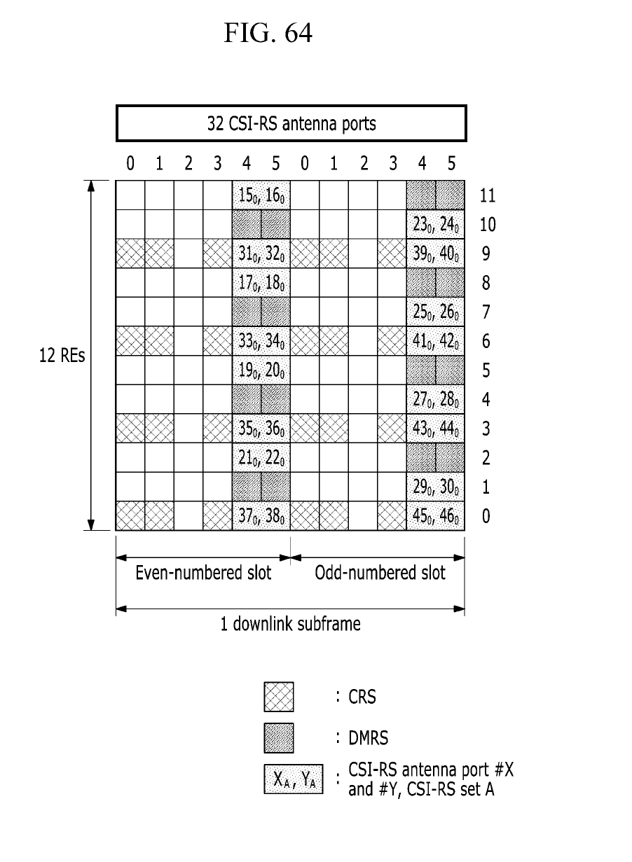

FIG. 64 is a diagram showing an exemplary embodiment of a method of extending a CSI-RS pattern using both FDM and TDM. Specifically, FIG. 64 is a diagram showing an embodiment of a resource configuration for 32 CSI-RS antenna ports if an extended CP is set.

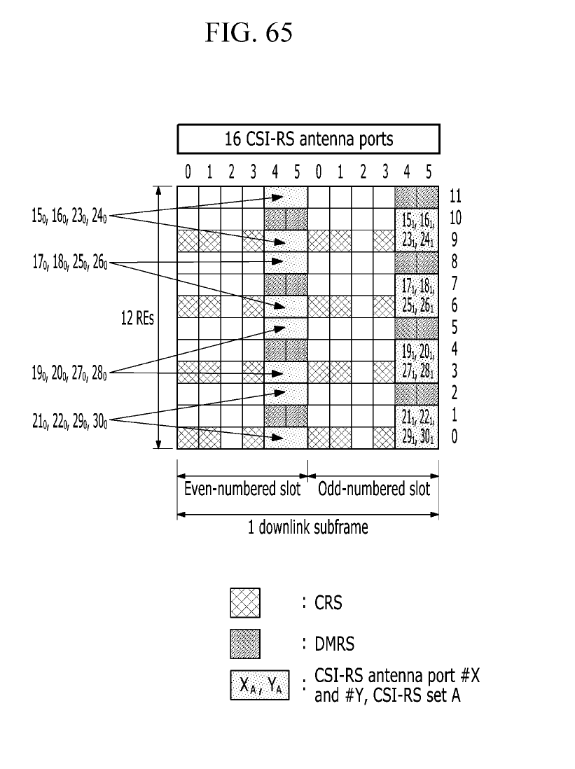

FIG. 65 is an exemplary embodiment of a method of using the length-4 Walsh code-based CDM and extending a CSI-RS pattern in a frequency axis. Specifically, FIG. 65 is a diagram showing another exemplary embodiment of a resource configuration for 16 CSI-RS antenna ports if an extended CP is set.

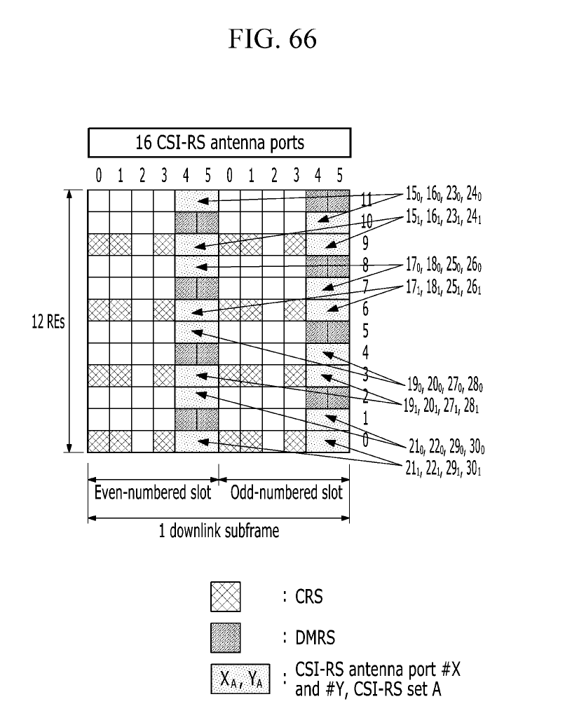

FIG. 66 shows an exemplary embodiment of a method of using length-4 Walsh code-based CDM and extending a CSI-RS pattern in a time axis. Specifically, FIG. 66 is a diagram showing yet another exemplary embodiment of a resource configuration for 16 CSI-RS antenna ports if an extended CP is set.

2.4. CSI-RS Configuration Applicable to Only TDD if an Extended CP is Set

If an extended CP is set, a CSI-RS RE set for CSI-RS configuration Nos. 16-27 has been designed to avoid overlap with resources in which the DMRS of an antenna port No. 5 is transmitted as possible. In this case, a CSI-RS resource pool according to an existing standard includes 24 REs.

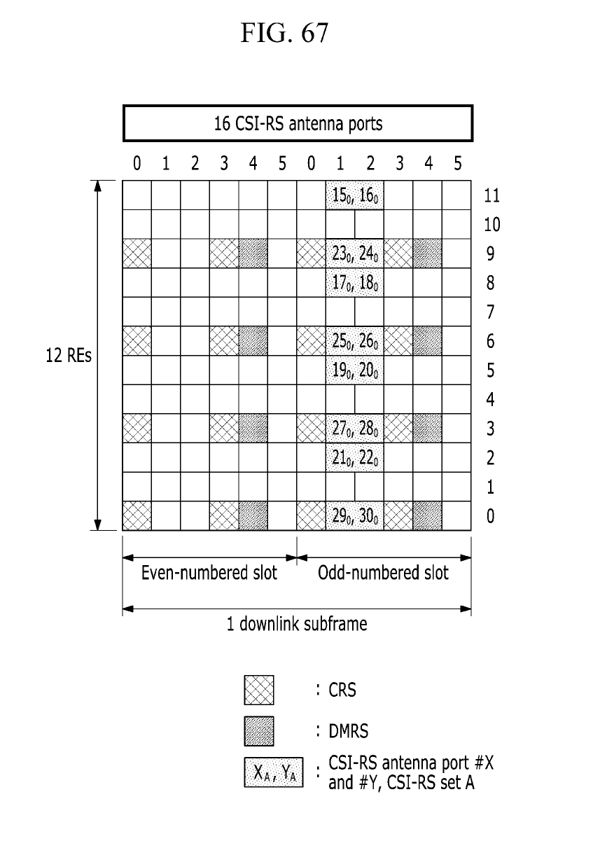

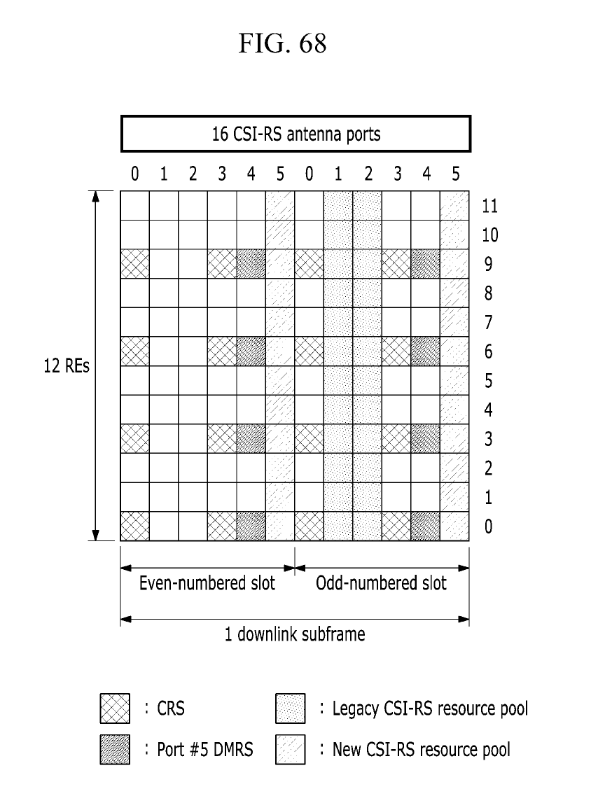

As in the aforementioned methods of configuring CSI-RS resources for a normal CP, if an extended CP is set, a method of using an existing CSI-RS resource pool without a change and a method of extending a CSI-RS resource pool may be taken into consideration as a CSI-RS resource configuration method applicable to only TDD (hereinafter referred to as a “second extension CP resource configuration method”). The second extension CP resource configuration method may use the aforementioned methods of configuring CSI-RS resources for a normal CP or the first extension CP resource configuration method identically or similarly. Accordingly, a detailed description of the second extension CP resource configuration method is omitted. FIGS. 67 and 68 are exemplary embodiments of the second extension CP resource configuration method.

FIG. 67 shows an exemplary embodiment a method of extending a CSI-RS pattern using FDM using an existing CSI-RS resource pool without a change. Specifically, FIG. 67 is a diagram showing still another embodiment of a resource configuration for 16 CSI-RS antenna ports if an extended CP is set.

FIG. 68 is a diagram showing one of methods of extending a CSI-RS resource pool. Specifically, FIG. 68 is a diagram showing an extended CSI-RS resource pool if an extended CP is set. The exemplary embodiment of FIG. 68 shows a method of adding 12 REs, corresponding to the OFDM symbol No. 5 of a first time slot, and 12 REs, corresponding to the OFDM symbol No. 5 of a second time slot, to a CSI-RS resource pool. An existing CSI-RS resource pool includes 24 REs corresponding to the OFDM symbol Nos. 1 and 2 of a second time slot.

If a CSI-RS pattern is defined in the newly added resource pool illustrated in FIG. 68, to use length-2 CDM in a frequency axis within the same OFDM symbol instead of existing length-2 CDM in a time axis is more advantageous for channel estimation performance.

2.5. In the Case of TDD-Special Subframe

In a TDD cell, a single radio frame includes a downlink subframe, a special subframe, and an uplink frame. The special subframe is present between the downlink subframe and the uplink subframe, and includes a downlink pilot time slot (DwPTS), a guard period (GP), and an uplink pilot time slot (UpPTS). The DwPTS is used in cell search, synchronization, or channel estimation. The GP is an interval for removing interference generated in the uplink of a base station attributable to a difference in the multipath delay of terminals. In the UpPTS interval, a physical random access channel (PRACH) or a sounding reference signal (SRS) may be transmitted. In the DwPTS interval, a downlink PDSCH may also be transmitted. In accordance with a current LTE standard, 10 different special subframes may be configured, and the length or duration of DwPTS, GP, and UpPTS intervals according to each configuration complies with Table 9 below.

TABLE 9
Configuration (lengths of DwPTS, GP, and UpPTS) of TDD-special
subframe

| | Normal CP in downlink | | | Extended CP in downlink | | |
|---|---|---|---|---|---|---|
| | | UpPTS | | | UpPTS | |
| Special | | Normal | Extended | | Normal | Extended |
| subframe | | CP in | CP in | | CP in | CP in |
| configuration | DwPTS | uplink | uplink | DwPTS | uplink | uplink |
| 0 | 6592 · Tₛ | 2192 · Tₛ | 2560 · Tₛ | 7680 · Tₛ | 2192 · Tₛ | 2560 · Tₛ |
| 1 | 19760 · Tₛ | | | 20480 · Tₛ | | |
| 2 | 21952 · Tₛ | | | 23040 · Tₛ | | |
| 3 | 24144 · Tₛ | | | 25600 · Tₛ | | |
| 4 | 26336 · Tₛ | | | 7680 · Tₛ | 4384 · Tₛ | 5120 · Tₛ |
| 5 | 6592 · Tₛ | 4384 · Tₛ | 5120 · Tₛ | 20480 · Tₛ | | |
| 6 | 19760 · Tₛ | | | 23040 · Tₛ | | |
| 7 | 21952 · Tₛ | | | 12800 · Tₛ | | |
| 8 | 24144 · Tₛ | | | — | — | — |
| 9 | 13168 · Tₛ | | | — | — | — |

In accordance with a current LTE standard, a CSI-RS is not transmitted in the DwPTS interval of a special subframe. However, in an FD-MIMO system, to transmit a CSI-RS even in a special subframe may assist in distributing CSI-RS transmission overhead into a plurality of subframes. Furthermore, if a base station configures a plurality of CSI-RS resources in a terminal using a plurality of subframes and the terminal aggregates the plurality of CSI-RS resources and performs CSI measurement, a report to include a special subframe in the aggregation of subframes may assist in improving CSI measurement accuracy of the terminal.

Basically, a CSI-RS resource pool and CSI-RS pattern in a downlink subframe may be applied to the transmission of a CSI-RS in a DwPTS interval without a change. A DwPTS interval may include a minimum of 3 OFDM symbols or a maximum of 12 OFDM symbols according to a special subframe configuration (Nos. 0-9). If a CSI-RS resource pool in a downlink subframe is identically applied to the transmission of a CSI-RS in a DwPTS interval, 32 REs may be used as CSI-RS resource pool if the number of OFDM symbols included in a DwPTS is 11 or more. If the number of OFDM symbols included in a DwPTS is 9 or 10, 8 REs may be used as a CSI-RS resource pool. If the number of OFDM symbols included in a DwPTS is 3 or 6, the transmission of a CSI-RS is impossible.

A method of extending a CSI-RS resource pool in order to transmit a CSI-RS in a DwPTS interval may be taken into consideration. Specifically, Method M210 or the detailed methods of Method M210 may be used identically or similarly for a case where the DMRS of the antenna port No. 5 is not transmitted. That is, the remaining 56 REs of a total of 64 REs illustrated in FIG. 35 except 8 REs corresponding to the OFDM symbol Nos. 5 and 6 of a second time slot may be used to transmit a CSI-RS in a DwPTS. In this case, if the number of OFDM symbols included in the DwPTS is 11 or more, the 56 REs may be used as a CSI-RS resource pool. If the number of OFDM symbols included in the DwPTS is 9 or 10, 32 REs may be used as a CSI-RS resource pool. If the number of OFDM symbols included in the DwPTS is 6, 24 REs may be used as a CSI-RS resource pool.

Alternatively, in order to transmit a CSI-RS in a DwPTS interval, Method M220 may be used identically or similarly. That is, a method of additionally using the OFDM symbol Nos. 1 and 2 of a first time slot may be taken into consideration. In accordance with such a method, although the number of OFDM symbols included in the DwPTS is 3, 24 REs may be used as a CSI-RS resource pool. In accordance with such a method, however, only if the number of CRS antenna ports is 1 or 2, the OFDM symbol Nos. 1 and 2 of the first time slot may be used to transmit a CSI-RS.

Alternatively, Method M240 may be used identically or similarly for a case where the DMRS of an antenna port No. 5 is not transmitted.

Alternatively, Method M521, Method M522, or Method M523 may be used identically or similarly for a case where the DMRS of an antenna port No. 5 and a CSI-RS coexist. That is, in the CSI-RS resource pools illustrated in FIGS. 59 to 61, the remaining resource pool other than 8 REs corresponding to the OFDM symbol Nos. 5 and 6 of the second time slot may be used for the CSI-RS resource configuration of a TDD-special subframe.

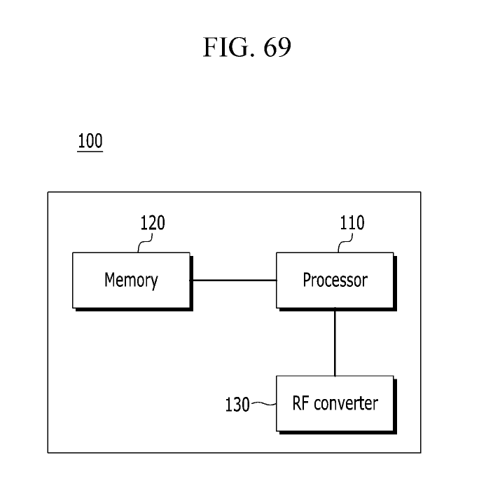

FIG. 69 is a diagram showing the configuration of a base station 100 in accordance with an exemplary embodiment of the present invention.

Specifically, the base station 100 includes a processor 110, memory 120, and an RF converter 130.

The processor 110 may be configured to implement the procedures, functions, and methods described in relation to a base station in this specification.

The memory 120 is connected to the processor 110, and stores various types of information related to the operation of the processor 110.

The RF converter 130 is connected to the processor 110, and transmits or receives a wireless signal. Furthermore, the base station 100 may have a single antenna or multiple antennas.

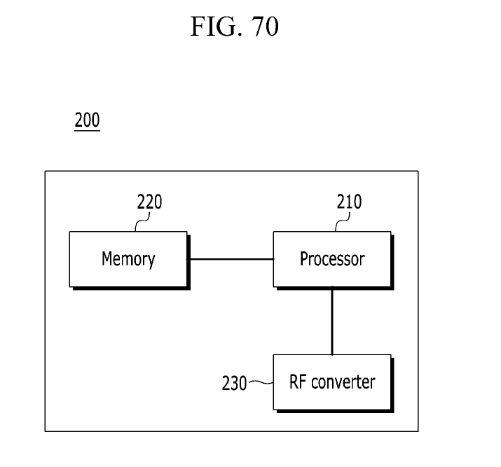

FIG. 70 is a diagram showing the configuration of a terminal 200 in accordance with an exemplary embodiment of the present invention.

Specifically, the terminal 200 includes a processor 210, memory 220, and an RF converter 230.

The processor 210 may be configured to implement the procedures, functions, and methods described in relation to a terminal in this specification.

The memory 220 is connected to the processor 210, and stores various types of information related to the operation of the processor 210.

The RF converter 230 is connected to the processor 210, and transmits or receives a wireless signal. Furthermore, the terminal 200 may have a single antenna or multiple antennas.

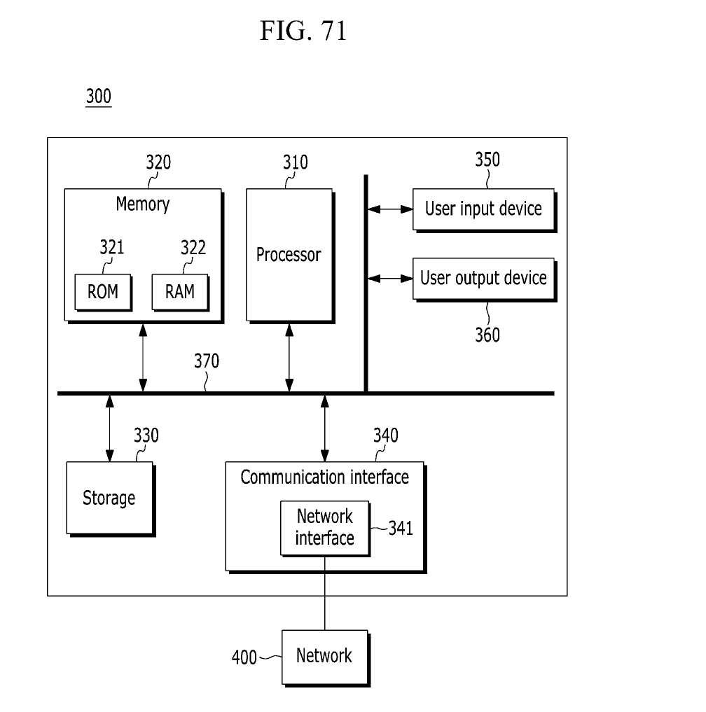

FIG. 71 is a diagram showing a computer system 300 in accordance with an exemplary embodiment of the present invention.

An exemplary embodiment of the present invention may be implemented in a computer system (e.g., a computer-readable medium). As illustrated in FIG. 71, the computer system 300 may include at least one processor 310, memory 320, and storage 330. The computer system 300 may further include a communication interface 340. The communication interface 340 may include a network interface 341 connected to a network 400. The computer system 300 may further include a user input device 350 and a user output device 360. The elements 310-360 may communicate with each other through a bus 370.

The processor 310 may be a central processing unit (CPU) or semiconductor device for executing processing instructions stored in the memory 320 or storage 330. The memory 320 and the storage 330 may include a variety of types of volatile or nonvolatile storage media. For example, the memory 320 may include read-only memory 321 and random access memory 322.

Accordingly, an exemplary embodiment of the present invention may be implemented as a non-transitory computer-readable medium with a computer-implemented method or computer executable instructions stored therein.

In an exemplary embodiment of the present invention, if computer-executable instructions are executed by the processor 310, they may perform a method at least one aspect of the present invention.

In accordance with an exemplary embodiment of the present invention, a base station can configure a larger number of CSI-RS antenna ports (e.g., 12, 16, 24, 32, or 64) than 8 in a terminal while minimizing channel estimation performance degradation of the terminal by extending a CSI-RS resource configuration.

Furthermore, in accordance with an exemplary embodiment of the present invention, a CSI-RS RE set for a case where the number of CSI-RS antenna ports is 1, 2, 4, or 8 can be additionally defined.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of transmitting a channel state information reference signal (CSI-RS) by a base station, comprising:
including a plurality of first resource elements (REs) corresponding to at least two of a second orthogonal frequency division multiplexing (OFDM) symbol, a third OFDM symbol, and a fourth OFDM symbol of a first time slot in a first CSI-RS resource pool configured in a first subframe comprising the first time slot and a second time slot subsequent to the first time slot; and
transmitting the CSI-RS using at least one of REs included in the first CSI-RS resource pool.

2. The method of claim 1, further comprising:
setting information about an OFDM symbol which belongs to OFDM symbols of the first time slot and at which a transmission of a physical downlink shared control channel (PDSCH) is started in a first parameter for a first set to which the first subframe belongs;
setting information about an OFDM symbol which belongs to OFDM symbols of a third time slot of the third time slot and a fourth time slot subsequent to the third time slot included in a second subframe and at which a transmission of a PDSCH is started in a second parameter for a second set to which the second subframe belongs; and
transmitting the first parameter and the second parameter to a terminal,
wherein the first subframe is configured so that the CSI-RS is transmitted through at least one of the first REs.

3. The method of claim 1, further comprising transmitting a bitmap of 19 bits for configuring the first REs as resources for a zero power (ZP) CSI-RS to a terminal.

4. The method of claim 1, wherein
including the first REs in the first CSI-RS resource pool comprises including 24 first REs corresponding to the third OFDM symbol and fourth OFDM symbol of the first time slot in the first CSI-RS resource pool, and
transmitting the CSI-RS comprises mapping CSI-RS antenna ports of greater than 8 to the REs included in the first CSI-RS resource pool.

5. The method of claim 4, wherein mapping the CSI-RS antenna ports comprises:
mapping 16 CSI-RS antenna ports to 16 REs of 24 REs which correspond to the third OFDM symbol and the fourth OFDM symbol of the second time slot and which are included in the first CSI-RS resource pool; and
multiplexing the 16 CSI-RS antenna ports using frequency division multiplexing (FDM) and code division multiplexing (CDM).

6. The method of claim 4, wherein mapping the CSI-RS antenna ports comprises:
mapping 16 CSI-RS antenna ports to 16 REs of the 24 first REs; and
multiplexing the 16 CSI-RS antenna ports using FDM and CDM.

7. The method of claim 4, wherein mapping the CSI-RS antenna ports comprises:
mapping 16 CSI-RS antenna ports to 8 REs which correspond to a sixth OFDM symbol and a seventh OFDM symbol of the first time slot and which are included in the first CSI-RS resource pool and 8 REs which correspond to a sixth OFDM symbol and a seventh OFDM symbol of the second time slot and which are included in the first CSI-RS resource pool; and
multiplexing the 16 CSI-RS antenna ports using time division multiplexing (TDM) and CDM.

8. The method of claim 4, wherein mapping the CSI-RS antenna ports comprises:
mapping 8 CSI-RS antenna ports of the 16 CSI-RS antenna ports to 8 REs of 24 REs which correspond to the third OFDM symbol and the fourth OFDM symbol of the second time slot and which are included in the first CSI-RS resource pool;
mapping remaining 8 CSI-RS antenna ports of the 16 CSI-RS antenna ports to 8 REs of the 24 first REs; and
multiplexing the 16 CSI-RS antenna ports using TDM and CDM.

9. The method of claim 4, wherein mapping the CSI-RS antenna ports comprises:
mapping 32 CSI-RS antenna ports to 8 REs which correspond to a sixth OFDM symbol and a seventh OFDM symbol of the first time slot and which are included in the first CSI-RS resource pool, 8 REs which correspond to a sixth OFDM symbol and a seventh OFDM symbol of the second time slot and which are included in the first CSI-RS resource pool, 8 REs of 24 REs which correspond to a third OFDM symbol and a fourth OFDM symbol of the second time slot and which are included in the first CSI-RS resource pool, and 8 REs of the 24 first REs; and
multiplexing the 32 CSI-RS antenna ports using FDM, TDM, and CDM.

10. The method of claim 4, wherein mapping the CSI-RS antenna ports comprises:
mapping 32 CSI-RS antenna ports to 16 REs of 24 REs which correspond to a third OFDM symbol and a fourth OFDM symbol of the second time slot and which are included in the first CSI-RS resource pool and 16 REs of the 24 first REs; and
multiplexing the 32 CSI-RS antenna ports using FDM, TDM, and CDM.

11. A method of transmitting a channel state information reference signal (CSI-RS) by a base station, comprising:
setting a number of CSI-RS antenna ports for transmitting the CSI-RS to a value greater than 8;
mapping the CSI-RS antenna ports to resource elements (RE) included in a CSI-RS resource pool of a subframe; and
multiplexing the CSI-RS antenna ports using frequency division multiplexing (FDM) and code division multiplexing (CDM).

12. The method of claim 11, wherein:
the subframe comprises a first time slot and a second time slot subsequent to the first time slot;
setting the number of CSI-RS antenna ports comprises setting the number of CSI-RS antenna ports to one of 12, 16, 20, and 24; and
mapping the CSI-RS antenna ports comprises mapping the set number of CSI-RS antenna ports to REs which belong to 24 first REs corresponding to a third orthogonal frequency division multiplexing (OFDM) symbol and a fourth OFDM symbol of the second time slot and included in the CSI-RS resource pool and which are equal to the number of CSI-RS antenna ports.

13. The method of claim 12, wherein mapping the set number of CSI-RS antenna ports comprises mapping the 16 CSI-RS antenna ports to two REs which belong to the 24 first REs and which correspond to a twelfth subcarrier of the subframe, two REs which belong to the 24 first REs and which correspond to an eleventh subcarrier of the subframe, two REs which belong to the 24 first REs and which correspond to a tenth subcarrier of the subframe, two REs which belong to the 24 first REs and which correspond to a ninth subcarrier of the subframe, two REs which belong to the 24 first REs and which correspond to a sixth subcarrier of the subframe, two REs which belong to the 24 first REs and which correspond to a fifth subcarrier of the subframe, two REs which belong to the 24 first REs and which correspond to a fourth subcarrier of the subframe, and two REs which belong to the 24 first REs and which correspond to a third subcarrier of the subframe when the number of CSI-RS antenna ports is 16.

14. The method of claim 12, wherein mapping the set number of CSI-RS antenna ports comprises mapping the 16 CSI-RS antenna ports to two REs which belong to the 24 first REs and which correspond to a twelfth subcarrier of the subframe, two REs which belong to the 24 first REs and which correspond to an eleventh subcarrier of the subframe, two REs which belong to the 24 first REs and which correspond to an eighth subcarrier of the subframe, two REs which belong to the 24 first REs and which correspond to a seventh subcarrier of the subframe, two REs which belong to the 24 first REs and which correspond to a sixth subcarrier of the subframe, two REs which belong to the 24 first REs and which correspond to a fifth subcarrier of the subframe, two REs which belong to the 24 first REs and which correspond to a second subcarrier of the subframe, and two REs which belong to the 24 first REs and which correspond to a first subcarrier of the subframe when the number of CSI-RS antenna ports is 16.

15. A method of transmitting a channel state information reference signal (CSI-RS) by a base station, comprising:
setting a number of first CSI-RS antenna ports for transmitting the CSI-RS to a value greater than 8;
mapping the CSI-RS antenna ports to resource elements (RE) included in a CSI-RS resource pool of a subframe; and
multiplexing the first CSI-RS antenna ports using time division multiplexing (TDM) and code division multiplexing (CDM),
wherein the subframe comprises a first time slot and a second time slot subsequent to the first time slot.

16. The method of claim 15, further comprising:
configuring a first energy per resource element (EPRE) for a demodulation reference signal (DMRS) in an orthogonal frequency division multiplexing (OFDM) symbol which belongs to OFDM symbols of the subframe and at which the CSI-RS is transmitted;
configuring a second EPRE for a DMRS in an OFDM symbol which belongs to the OFDM symbols of the subframe and at which the CSI-RS is not transmitted; and
transmitting a ratio of the first EPRE and the second EPRE to a terminal.

17. The method of claim 15, wherein
setting the number of first CSI-RS antenna ports comprises setting the number of first CSI-RS antenna ports to 16, and
mapping the first CSI-RS antenna ports comprises:
mapping 8 antenna ports of the 16 first CSI-RS antenna ports to 8 REs of 24 REs which correspond to a third OFDM symbol and a fourth OFDM symbol of the second time slot and which are included in the CSI-RS resource pool; and
mapping remaining 8 antenna ports of the 16 first CSI-RS antenna ports to 8 REs which correspond to a sixth OFDM symbol and a seventh OFDM symbol of the second time slot and which are included in the CSI-RS resource pool.

18. The method of claim 15, wherein
setting the number of first CSI-RS antenna ports comprises setting the number of first CSI-RS antenna ports to 16, and
mapping the first CSI-RS antenna ports comprises:
mapping 8 antenna ports of the 16 first CSI-RS antenna ports to 8 REs which correspond to a sixth OFDM symbol and a seventh OFDM symbol of the first time slot and which are included in the CSI-RS resource pool; and
mapping remaining 8 antenna ports of the 16 first CSI-RS antenna ports to 8 REs of 24 REs which correspond to a third OFDM symbol and a fourth OFDM symbol of the second time slot and which are included in the CSI-RS resource pool.

19. The method of claim 15, further comprising:
setting a number of second CSI-RS antenna ports for transmitting the CSI-RS to a value equal to the number of first CSI-RS antenna ports;
mapping the second CSI-RS antenna ports to the REs included in the CSI-RS resource pool; and
multiplexing the second CSI-RS antenna ports using frequency division multiplexing (FDM) and CDM.

20. The method of claim 15, wherein multiplexing the first CSI-RS antenna ports comprises:
multiplexing some of the first CSI-RS antenna ports using TDM and CDM; and
multiplexing a remainder of the first CSI-RS antenna ports using frequency division multiplexing (FDM) and CDM.
